(19) United States
(12) Patent Application Publication
(10) Pub. No.: US 2006/0029870 A1
(43) Pub. Date: Feb. 9, 2006

(54) Electrophotographic photoreceptor, image forming apparatus, and process cartridge

(75) Inventors: Katsumi Nukada, Kanagawa (JP); Masahiro Iwasaki, Kanagawa (JP); Kenji Yao, Kanagawa (JP); Ryo Sekiguchi, Kanagawa (JP); Wataru Yamada, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/065,048

(22) Filed: Feb. 25, 2005

(30) Foreign Application Priority Data
Aug. 6, 2004 (JP) 2004-231503
Dec. 20, 2004 (JP) 2004-368281

(51) Int. Cl. G03G 5/04; G03G 5/14

(52) U.S. Cl. 430/56; 430/58.05; 430/66; 399/159

(57) ABSTRACT

An electrophotographic photoreceptor of the present invention comprises a conductive support and a photosensitive layer. The photosensitive layer on the farthest side from the conductive support, includes a phenol derivative-containing layer which contains a phenol derivative having a methylol group and a charge transport material having at least one selected from the group consisting of a hydroxyl group, a carboxyl group, an alkoxysilyl group, an epoxy group, a thiol group and an amino group. An infrared absorption spectrum of the phenol derivative-containing layer satisfies the conditions represented by the following formula (1):
(P₂/P₁)≦0.2 (1)
P₁ is an absorbance of a maximum absorption peak in a range of 1560 cm⁻¹ to 1640 cm⁻¹, and P₂ is an absorbance of a maximum absorption peak in a range of 1645 cm⁻¹ to 1700 cm⁻¹.

### BACKGROUND OF THE INVENTION

1. Field of the Invention

The present invention relates to an electrophotographic photoreceptor, an image forming apparatus and a process cartridge.

2. Description of the Related Art

A so-called xerography image forming apparatus comprises an electrophotographic photoreceptor (hereinafter, also referred to as a ‘photoreceptor’ in some cases), a charging unit, an exposure unit, a developing unit and a transfer unit, for performing image formation by the electrophotography process using the same.

In recent years, xerography image forming apparatuses have a much higher processing speed and longer product lifetime due to the development of each member and system. Accordingly, there is an increasing need to provide a high-speed response and high reliability in each sub system. In particular, there is more immediate need to provide such a high-speed response and high reliability in the photoreceptor used for writing images and in a cleaning member for cleaning the photoreceptor. Further, the photoreceptor and the cleaning member receive a significant amount of stress by sliding with each other, compared to other members. For this reason, dents and abrasion occur at the photoreceptor, which leads to have image defects.

In order to suppress the dents and abrasion, the electrophotographic photoreceptor uses resin having a high mechanical strength to obtain a long product lifetime. For example, in JP-A-2002-82469 and JP-A-2003-186234, a protective layer may be provided, in which the layer comprises a phenol resin and a charge transport material having a hydroxyl group.

However, according to the electrophotographic photoreceptor disclosed in JP-A-2002-82469 and JP-A-2003-186234, it is not sufficient to suppress the dents and abrasion in the surface of the photoreceptor to enhance the mechanical strength. Hence, a high image quality cannot be obtained.

### SUMMARY OF THE INVENTION

The present invention has been made in view of the above circumstances and provides an electrophotographic photoreceptor capable of realizing a high image quality, and an image forming apparatus and a process cartridge using the same.

According to a first aspect of the present invention, an electrophotographic photoreceptor includes a conductive support and a photosensitive layer formed on the conductive support. The photosensitive layer-on the farthest side from the conductive support, includes a phenol derivative-containing layer comprising a phenol derivative having a methylol group and a charge transport material having at least one selected from the group consisting of a hydroxyl group, a carboxyl group, an alkoxysilyl group, an epoxy group, a thiol group and an amino group. An infrared absorption spectrum of the phenol derivative-containing layer satisfies the conditions represented by the following formula (1):
(P₂/P₁)≦0.2 (1)
wherein P₁ is an absorbance of a maximum absorption peak in a range of 1560 cm⁻¹ to 1640 cm⁻¹, and P₂ is an absorbance of the maximum absorption peak in a range of 1645 cm⁻¹ to 1700 cm⁻¹.

The electrophotographic photoreceptor according to the first aspect of the present invention comprises a phenol derivative-containing layer comprising a phenol derivative having a methylol group and the specific charge transport material, and the infrared absorption spectrum thereof satisfies the conditions represented by the above formula (1), so that excellent electrical properties and a high image quality can be realized.

Here, although conventional electrophotographic photoreceptors, which comprise a protective layer containing a phenol derivative having a methylol group and a charge transport material having a hydroxyl group, have excellent abrasion resistance, a high image quality could not be achieved.

The present inventors have conducted extensive studies to achieve high image quality and have found that the conventional protective layer with the absorption spectrum in the specific region, is not sufficient to achieve a good image quality in terms of the infrared absorption spectrum. From the result of the studies, the present inventors have further found that, with respect to the infrared absorption spectrum of the protective layer described above, an absorbance of the maximum absorption peak in a range of 1560 cm⁻¹ to 1640 cm⁻¹ and an absorbance of the maximum absorption peak in a range of 1645 cm⁻¹ to 1700 cm⁻¹ satisfy the relationship shown in the above formula (1), and therefore a high image quality can be obtained. Thus, the present invention has been completed.

Further, the reasons that the above effects are obtained by the present invention are not readily clear, but the present inventors have assumed the following description.

That is, while using a phenol derivative having a methylol group to form a film, a moiety of a methylol group of a phenol derivative is made of an oxide such as a formyl group. The oxide such as a formyl group serves as a carrier trap for disturbing the charge transport of the photoreceptor, so that it deteriorates electrical properties of the photoreceptor. Here, the maximum absorption peak (P₁) of the infrared absorption spectrum in a range of 1560 cm⁻¹ to 1640 cm⁻¹ corresponds to an aromatic C—C stretching vibration of a phenol derivative. In addition, it will be appreciated that the maximum absorption peak (P₂) in a range of 1645 cm⁻¹ to 1700 cm⁻¹ is derived from the oxide such as a formyl group.

Finally, it should be noted that the photoreceptor having a small absorbance ratio (P₂/P₁) has a small amount of an oxide such as a formyl group in the photoreceptor so that it has an excellent carrier-transportability. Therefore, according to the electrophotographic photoreceptor of the first aspect of the present invention, a predetermined material is used and the absorbance ratio (P₂/P₁) is set to 0.2 or less, so that excellent electrical properties and a high image quality can be obtained. In addition, the electrophotographic photoreceptor of the first aspect of the present invention has an excellent mechanical strength as well as excellent electrical properties, and thus a high image quality can be achieved.

According to a second aspect of the invention, the electrophotographic photoreceptor includes a conductive support and a photosensitive layer formed on the conductive support. A photosensitive layer on the farthest side from the conductive support, includes a phenol derivative-containing layer containing a phenol derivative having a methylol group and a charge transport material having a plurality of epoxy groups.

The electrophotographic photoreceptor comprises a phenol derivative-containing layer comprising a phenol derivative having a methylol group and the specific charge transport material, so that the excellent electrical properties and the high image quality can be obtained.

Here, typically, in the image forming apparatus along with the electrophotography process, an electric discharge product such as NOₓ and an ozone gas is produced. An electric discharge product adheres to the surface of the photosensitive layer and penetrates into the photosensitive layer. Therefore, the electric discharge product penetrated into the photosensitive layer chemically deteriorates constituent materials of the photosensitive layer, so that electrical properties of the photoreceptor is deteriorated. In addition, the deterioration of electrical properties leads to deterioration of the image quality, such as white out and concentration unevenness.

The conventional electrophotographic photoreceptor comprising the protective layer containing a phenol derivative having a methylol group and the charge transport material having a hydroxyl group has excellent abrasion resistance, so that the abrasion of the surface of the photosensitive layer in the electrophotography process is reduced. For this reason, typically, the electric discharge product removed by the sliding friction of the cleaning member is not removed, and the electric discharge product remains on the surface of the photosensitive layer and near the photosensitive layer so that electrical properties is deteriorated.

In the electrophotography photosensitive layer of the present invention, a phenol derivative-containing layer containing a phenol derivative having a methylol group and the charge transport material having a plurality of epoxy groups, the plurality of epoxy groups provides a thick cross linked structure along with a phenol derivative. For this reason, it is considered that, in a phenol derivative described above, a physical gap into which the electric discharge product is input is reduced. Therefore, the layer containing a phenol derivative described above prevents the discharging material from penetrating into the photosensitive layer from the surface thereof, so that the electrophotographic photoreceptor according to the second aspect of the present invention has obtained the excellent electrical properties as well as mechanical strength. With this, it is appreciated that the high image quality can be achieved.

In addition, an electrophotographic photoreceptor according to a third aspect of the present invention comprises a conductive support and a photosensitive layer formed on the conductive support, wherein the photosensitive layer has a phenol derivative-containing layer on the farthest side from from the conductive support, includes a phenol derivative-containing layer containing a phenol derivative which has a fragment pattern belonging to a compound represented by the following formula (A) in pyrolysis-gas chromatography/mass spectrometry, and wherein an infrared absorption spectrum of a phenol derivative-containing layer satisfies the conditions represented by the following formula (1).

In the formula (A), n represents an integer of 1 to 3,
(P₂/P₁)≦0.2 (1)
wherein P₁ is an absorbance of the maximum absorption peak in a range of 1560 cm⁻¹ to 1640 cm⁻¹ and P₂ is an absorbance of the maximum absorption peak in a range of 1645 cm⁻¹ to 1700 cm^{-1.}

In the electrophotographic photoreceptor according to the third aspect of the present invention, as in the electrophotographic photoreceptors according to the first and second aspects, excellent electrical properties and high image quality can be realized.

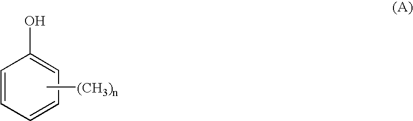

In addition, pyrolysis-gas chromatography/mass spectrometry, for example, can be performed as described below. First, a phenol derivative-containing layer is removed from the electrophotographic photoreceptor, and using the pyrolysis device (e.g., PY-2010D from Frontier Lab Ltd.) to heat for one minute at 600° C. Using a device for gas chromatography/mass spectrometry (e.g., HP6890/HP5973 from Hewlett Packard Ltd.), a capillary column (e.g., HP-5MS: 5% —Diphenyl 95%—Demethylpolysioxane copolymer, a film thickness of 0.25 μm, an inner diameter of 0.25 mm, and a length of 30 m, from Hewlett Packard Ltd.), a carrier gas (He, a flow rate: 1 ml/min), the gas produced by the pyrolysis described above is measured by increasing a temperature from 50° C. to 200° C. at an increasing rate of 10° C./min and keeping the temperature at 200° C. for 5 minutes. Structure identification from the obtained spectrum can be readily performed with a spectrum database.

In addition, an image forming apparatus of the present invention comprises the electrophotographic photoreceptor of the invention, a charging unit for charging the electrophotographic photoreceptor, an exposure unit for exposing the charged electrophotographic photoreceptor to form an electrostatic latent image, a developing unit for developing the electrostatic latent image to form a toner image, and a transfer unit for transferring the toner image to arecording medium.

In addition, a process cartridge of the present invention comprises the electrophotographic photoreceptor of the invention, and at least one unit selected from the group consisting of a charging unit for charging the electrophotographic photoreceptor, an exposure unit for exposing the charged electrophotographic photoreceptor to form an electrostatic latent image and a cleaning unit for cleaning the electrophotographic photoreceptor.

The image forming apparatus and the process cartridge of the present invention comprise the electrophotographic photoreceptor of the present invention, so that good image quality thereof can be provided for a long time.

According to the present invention, the electrophotographic photoreceptor with which excellent electrical properties and high image quality can be realized, the image forming apparatus and the process cartridge with which good image quality can be obtained for a long time can be provided.

### BRIEF DESCRIPTION OF THE DRAWINGS

FIG. 1 is a schematic cross sectional view showing an electrophotographic photoreceptor according to an embodiment of the present invention.

FIG. 2 is a schematic cross sectional view showing an electrophotographic photoreceptor according to another embodiment of the present invention.

FIG. 3 is a schematic cross sectional view showing an electrophotographic photoreceptor according to another embodiment of the present invention.

FIG. 4 is a schematic cross sectional view showing an electrophotographic photoreceptor according to another embodiment of the present invention.

FIG. 5 is a schematic cross sectional view showing an electrophotographic photoreceptor according to another embodiment of the present invention.

FIG. 6 is a schematic diagram showing an image forming apparatus according to an embodiment of the present invention.

FIG. 7 is a schematic diagram showing an image forming apparatus according to another embodiment of the present invention.

FIG. 8 is a schematic diagram showing an image forming apparatus according to another embodiment of the present invention.

FIG. 9 is a schematic diagram showing an image forming apparatus according to another embodiment of the present invention.

FIG. 10 is an infrared absorption spectrum of a protective layer of the electrophotographic photoreceptor according to Examples 1-1.

FIG. 11 is an infrared absorption spectrum of a protective layer of the electrophotographic photoreceptor according to Example 1-2.

FIG. 12 is an infrared absorption spectrum of a protective layer of the electrophotographic photoreceptor according to Comparative Example 1-2.

FIG. 13 is a gas chromatogram of a gas produced by pyrolysis of a protective layer of the electrophotographic photoreceptor according to Example 1-1.

FIG. 14 is a mass spectrum corresponding to a peak A of FIG. 13.

FIG. 15 is a mass spectrum corresponding to a peak B of FIG. 13.

FIG. 16 is a mass spectrum corresponding to a peak C of FIG. 13.

FIG. 17 is a mass spectrum corresponding to a peak D of FIG. 13.

FIG. 18 is a mass spectrum corresponding to a peak E of FIG. 13.

FIG. 19 is a mass spectrum corresponding to a peak F of FIG. 13.

### DETAILED DESCRIPTION OF THE PREFFERED EMBODIMETNS

While the invention has been described in detail and with reference to specific embodiments thereof, it will be apparent to one skilled in the art that various changes and modifications can be made therein without departing from the scope thereof.

This application is based on Japanese patent application No. 2004-231503 filed Aug. 6, 2004, and No. 2004-231503 filed Dec. 20, 2004, the entire contents thereof being hereby incorporated by reference.

Hereinafter, preferred embodiments of the present invention will be described in detail. Further, like numbers refer to like elements throughout the drawings, and thus, the repeated description will be omitted.

(Electrophotographic Photoreceptor)

An electrophotographic photoreceptor of the first aspect of the present invention comprises a conductive support and a photosensitive layer formed on the conductive support, wherein the photosensitive layer on the farthest side from the conductive support, includes a phenol derivative-containing layer containing a phenol derivative having a methylol group and a charge transport material having at least one selected from a hydroxyl group, a carboxyl group, an alkoxysilyl group, an epoxy group, a thiol group and an amino group, and wherein an infrared absorption spectrum of a phenol derivative-containing layer satisfies the conditions represented by the following formula (1):
(P₂/P₁)≦0.2 (1)
wherein P₁ is an absorbance of the maximum absorption peak in a range of 1560 cm⁻¹ to 1640 cm⁻¹ and P₂ is an absorbance of the maximum absorption peak in a range of 1645 cm⁻¹ to 1700 cm^{-1.}

In addition, the electrophotographic photoreceptor according to the second aspect of the present invention comprises a conductive support and a photosensitive layer formed on the conductive support, wherein the photosensitive layer on the farthest side from the conductive support, includes a phenol derivative-containing layer containing a phenol derivative having a methylol group and a charge transport material having a plurality of epoxy groups.

In addition, the photosensitive layer constituting the electrophotographic photoreceptor of the present invention may be any one of a single-layer type photosensitive layer containing a charge generation material and the charge transport material in the same layer, or a functionally separated photosensitive layer in which a layer containing the charge generation material (charge generation layer) and a layer containing the charge transport material (charge transport layer) are separately formed. In case of the functionally separated photosensitive layer, an order of stacking the charge generation layer and the charge transport layer may be made such that either one is provided as a top layer. Further, in case of the functionally separated photosensitive layer, it is possible to carry out functional separation such that each layer satisfies each function, and thus further high level function can be realized.

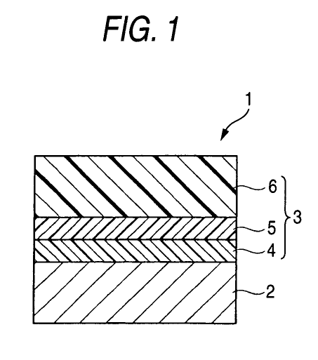

FIG. 1 is a schematic cross sectional view showing an electrophotographic photoreceptor according to an aspect of the present invention. As shown in FIG. 1, the electrophotographic photoreceptor 1 comprises a conductive support 2 and a photosensitive layer 3. The photosensitive layer 3 has a construction such that an subbing layer 4, a charge generation layer 5 and a charge transport layer 6 are stacked on conductive support 2 in this order. In the electrophotographic photoreceptor 1 shown in FIG. 1, the charge transport layer 6 is a phenol derivative-containing layer.

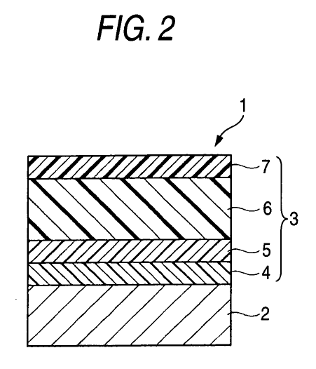

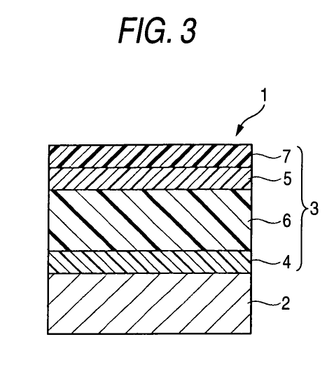

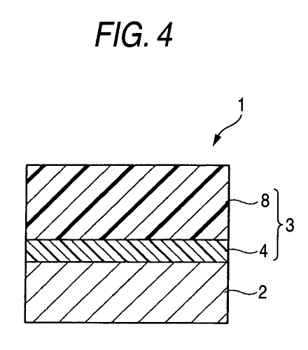

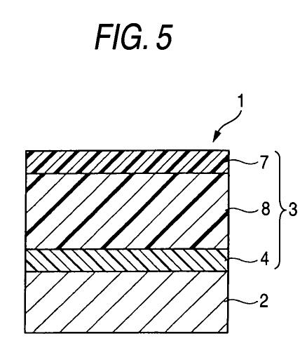

In addition, FIGS. 2 to 5 are schematic cross sectional views showing electrophotographic photoreceptors according to other preferred embodiments of the present invention, respectively. The electrophotographic photoreceptor shown in FIGS. 2 and 3 comprises a photosensitive layer 3 in which it is functionally separated as the charge generation layer 5 and the charge transport layer 6, as in the electrophotographic photoreceptor shown in FIG. 1. Further, in FIGS. 4 and 5, the charge generation layer and the charge transport layer are provided in the same layer (single-layer type photosensitive layer 8).

The electrophotographic photoreceptor 1 shown in FIG. 2 has a construction such that the subbing layer 4, the charge generation layer 5, the charge transport layer 6, and a protective layer 7 are stacked on the conductive support 2 in this order. In addition, the electrophotographic photoreceptor shown in FIG. 3 has a construction such that the subbing layer 4, the charge transport layer 6, the charge generation layer 5, and the protective layer 7 are stacked on the conductive support 2 in this order. For the electrophotographic photoreceptors 1 shown in FIGS. 2 and 3, the protective layer 7 is a phenol derivative-containing layer. The electrophotographic photoreceptor 1 shown in FIG. 4 has a construction such that the subbing layer 4 and the single-layer type photosensitive layer 8 are stacked on the conductive support 2 in this order, and the single-layer type photosensitive layer 8 is a phenol derivative-containing layer. In addition, the electrophotographic photoreceptor 1 shown in FIG. 5 has an arrangement such that the subbing layer 4, the single-layer type photosensitive layer 8, and the protective layer 7 are stacked on the conductive support 2 in this order, and the protective layer 7 is a phenol derivative-containing layer. In addition, for the electrophotographic photoreceptor 1, the subbing layer 4 may not be necessarily provided.

Hereinafter, based on the electrophotographic photoreceptor 1 shown in FIG. 2, each element thereof will be described.

The conductive support 2 may be, for example, a metal plate, a metal drum, and a metal belt having a metal such as aluminum, copper, zinc, stainless, chromium, nickel, molybdenum, vanadium, indium, gold, platinum, or an alloy thereof. In addition, as for the conductive support 2, a paper, a plastic film, and a belt coated, deposited or laminated with a conductive polymer, a conductive compound such as indium oxide, and a metal such as aluminum, palladium, gold, and an alloy thereof can be used.

The surface of the conductive support 2 is preferably roughened so as to have a surface roughness of 0.04 μm to 0.5 μm in terms of a central line average roughness Ra to prevent an interference fringe generated when laser light is applied. When Ra for the surface of the conductive support 2 is less than 0.04 μm, the surface of the conductive support 2 is close to the mirror plane and therefore interference prevention effects tend to be insufficient, whereas when Ra exceeds 0.5 μm, an image quality thereof tends to be insufficient even if a coating film is formed. It is to be noted that when non-interference light is used as a light source, the surface roughing for preventing an interference fringe is not particularly required and the generation of defects caused by the irregularities on the surface of the conductive support 2 can be prevented, showing that the use of non-interference light is suitable for achieving longer life.

As a surface roughing method, wet honing performed by spraying abrasives suspended in water on the conductive support or centerless grinding in which the conductive support is pressed to rotating grinding stone to carry out grinding processing continuously is preferable.

As a surface roughing method, without roughening the surface of the conductive support 2, a method of dispersing conductive or semiconductive particles in a resin, forming a layer onto the surface of the support, and roughening fine particles dispersed in the layer is preferably used.

An anodic oxidation treatment may be performed by running anodic oxidation using the aluminum as the anode in an electrolytic solution, whereby an oxide film can be formed on the surface of aluminum. As the electrolytic solution used at this time, a sulfuric acid solution, oxalic acid solution or the like may be used. However, the porous anodic oxide film as it stands is chemically active and is therefore easily soiled and its resistance is largely fluctuated by environmental variation. It is therefore preferable to treat the oxide film by running a hydration reaction using pressure steam or in a boiled water (salts of metals such as nickel may be added) to cause volumetric expansion and to convert the oxide into a more stable hydrate oxide, thereby carrying out pore-sealing treatment for sealing micropores of the anodic oxide film.

A film thickness of the anodic oxide film is preferably 0.3 to 15 μm. When the thickness is less than 0.3 μm, the barrier characteristics against intrusion is so poor that only insufficient effect is obtained. On the other hand, the film thickness exceeding 15 μm causes a rise of residual potential in repeated use.

In addition, the conduct support 2 may be processed by acid aqueous solution treatment or boehmite treatment. The acid solution treatment is carried out using an acidic processing solution consisting of phosphoric acid, chromic acid and hydrofluoric acid in the following manner. First, the acidic processing solution is adjusted. Each compounding ratio of phosphoric acid, chromic acid and hydrofluoric acid is in a range from 10 to 11% by weight in the case of phosphoric acid, in a range from 3 to 5% by weight in the case of chromic acid and in a range from 0.5 to 2% by weight in the case of hydrofluoric acid. The total concentration of these acids is preferably in a range from 13.5 to 18% by weight. The treating temperature is preferably 42 to 48° C. It is possible to form a thick film at a higher rate by maintaining high treatment temperature. The film thickness of the coating film is preferably 0.3 to 15 μm. When the film thickness is less than 0.3 μm, the barrier characteristics against intrusion is so poor that only insufficient effect is obtained. On the other hand, a film thickness exceeding 15 μm causes a rise of residual potential in repeated use.

The boehmite treatment may be carried out by dipping the anodic oxide film in pure water kept at 90 to 100° C. for 5 to 60 minutes or by bringing the anodic oxide film into contact with 90 to 120° C. heating steam for 5 to 60 minutes. The film thickness of the coating film formed by the boehmite treatment is preferably 0.1 to 5 μm. After the boehmite treatment, anodic oxidation treatment may be carried out using an electrolytic solution having a low coating film solubility, such as adipic acid, boric acid, borates, phosphates, phthalates, maleates, benzoates, tartrates and citrates.

The subbing layer 4 is formed on the conductive supporting layer 2. The subbing layer 4 comprises an organic metal compound and/or a binder resin.

Examples of the organometallic compound include organozirconium compounds such as a zirconium chelate compound, a zirconium alkoxide compound and a zirconium coupling agent, organotitanium compounds such as a titanium chelate compound, a titanium alkoxide compound and a titanate coupling agent, organoaluminum compounds such as an aluminum chelate compound and an aluminum coupling agent, and organometallic compounds such as an antimony alkoxide compound, a germanium alkoxide compound, an indium alkoxide compound, an indium chelate compound, a manganese alkoxide compound, a manganese chelate compound, a tin alkoxide compound, a tin chelate compound, an aluminum silicon alkoxide compound, an aluminum titanium alkoxide compound, and an aluminum zirconium alkoxide compound.

As the organometallic compound, organozirconium compounds, organotitanium compounds and organoaluminum compounds are particularly preferable because good electrophotographic characteristics are exhibited with a low residual potential.

Examples of the binder resin include a known binder resin such as polyvinyl alcohol, polyvinylmethyl ether, poly-N-vinylimidazole, polyethylene oxide, ethyl cellulose, methyl cellulose, an ethylene-acrylic acid copolymer, a polyamide, a polyimide, casein, gelatin, polyethylene, polyester, a phenol resin, a vinyl chloride-vinyl acetate copolymer, an epoxy resin, polyvinylpyrrolidone, polyvinyl pyridine, polyurethane, polyglutamic acid and polyacrylic acid. When these are used in combination of two or more, mixing ratio thereof may be suitably determined as required.

Further, a silane coupling agent may be contained in the subbing layer. Examples of the silane coupling agent include vinyltrichlorosilane, vinyltrimethoxysilane, vinyltriethoxysilane, vinyltris-2-methoxyethoxysilane, vinyltriacetoxysilane, γ-glycidoxypropyltrimethoxysilane, γ-methacryloxypropyltrimethoxysilane, γ-aminopropyltriethoxysilane, γ-chloropropyltrimethoxysilane, γ-2-aminoethylaminopropyltrimethoxysilane, γ-mercapropropyltrimethoxysilane, γ-ureidopropyltriethoxysilane and β-3,4-epoxycyclohexyltrimethoxysilane.

In addition, an electron-transferable pigment can be also used by mixing/dispersing in the subbing layer from the viewpoint of a low residual potential and environmental stability. Examples of the electron-transferable pigment include organic pigments such as perylene pigments, bisbenzimidazoleperylene pigments, polycyclic quinone pigments, indigo pigments and quinacridone pigments; organic pigments such as bisazo pigments and phthalocyanine pigments having electron-attractive substituents such as a cyano group, a nitro group, a nitroso group and a halogen atom; and inorganic pigments such as zinc oxide and titanium oxide as described in JP-A-47-30330.

Among these pigments, perylene pigments, bisbenzimidazoleperylene pigments and polycyclic quinone pigments have high electron-transferability and are therefore preferably used.

The surfaces of these pigments are preferably treated with a coupling agent, a binder resin and like to control the dispersibility and the charge transport property thereof.

The electron-transferable pigments are used in an amount of preferably 95% by weight or less and more preferably 90% by weight or less based on the solid component of the subbing layer 4 because the strength of the intermediate layer 21 is lowered, causing defects of the coating film if the amount is excessive.

Fine particles of various organic compounds or inorganic compounds can be incorporated into the subbing layer 17 for the purposes of improving electrical properties, improving light-scattering properties, etc. Especially effective are white pigments such as titanium oxide, zinc oxide, zinc flower, zinc sulfide, white lead, and lithopone, inorganic pigments for use as extenders, such as alumina, calcium carbonate, and barium sulfate, polytetrafluoroethylene resin particles, benzoguanamine resin particles, styrene resin particles, and the like.

Such fine particles added have a particle diameter of preferably 0.01 to 2 am. Although the fine particles are added as required, the amount thereof is preferably 10 to 90% by weight, more preferably 30 to 80% by weight, based on the total amount of the solid content of the subbing layer 4.

The subbing layer 4 is formed with an subbing layer coating solution containing the respective constituent materials. Any organic solvent for an subbing layer coating solution may be used so long as it dissolves an organometallic compound and a binder resin and gelation or agglomeration does not occur when the electron-transferable pigment is mixed and/or dispersed.

Examples of the organic solvent include ordinary organic solvents such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene. These can be used either singly or in combination of two or more.

As a method of mixing and/or dispersing the respective constituent materials, usual methods using a ball mill, roll mill, sand mill, attritor, vibrating ball mill, colloidal mill, paint shaker, ultrasonic wave and the like are applied. The mixing and dispersing is carried out in an organic solvent.

As a coating method used when forming the subbing layer 4, usual methods such as a blade coating method, a wire bar coating method, a spray coating method, a dip coating method, a bead coating method, an air knife coating method and a curtain coating method may be used.

The drying is usually carried out at temperatures enabling solvents to be vaporized and a film to be formed. Particularly, the conductive support 2 processed by the above acidic solution treatment and boehmite treatment tends to have insufficient ability to conceal defects and therefore, it is preferable to form the subbing layer 4.

The film thickness of the subbing layer 4 is in a range of preferably 0.01 to 30 μm, more preferably 0.05 to 30 μm, even more preferably 0.1 to 30 μm, and particularly preferably 0.2 to 25 μm.

The charge generation layer 5 is formed using a charge generation material and optionally a binder resin.

As the charge generation material, known pigments including azo pigments such as bisazo pigments and trisazo pigments; condensed ring aromatic pigments such as dibromoanthanthrone; organic pigments such as perylene pigments, pyrrolopyrrole pigments and phthalocyanine pigments; and inorganic pigments such as trigonal selenium and zinc oxide can be used. In a case where a light source having exposure wavelength of 380 to 500 nm, the charge generation material is preferably metallic or non-metallic phthalocyanine pigments, trigonal selenium, dibromoanthanthrone. Among them, particularly preferable are hydroxygallium phthalocyanine disclosed in JP-A-5-263007 and JP-A-5-279591; chlorogallium phthalocyanine disclosed in JP-A-5-98181; dichlorotin phthalocyanine disclosed in JP-A-5-140472 and JP-A-5-140473; titanylphthalocyanine disclosed in JP-A-4-189873 and JP-A-5-43813.

The binder resin can be selected from a wide range of insulation resins. Particularly, the binder resin may be selected from organic photoconductive polymer such as poly-N-vinylcarbazole, polyvinylanthracene, polyvinylpyrene, polysilane, etc.

Preferable examples of the binder resin include, though not limited to, insulation resins such as polyvinylbutyral resins, polyarylate resins (e.g., polymerization condensates of bisphenol A and phthalic acid), polycarbonate resins, polyester resins, phenoxy resins, vinyl chloride-vinyl acetate copolymers, polyamide resins, acryl resins, polyacrylamide resins, polyvinylpyridine resins, cellulose resins, urethane resins, epoxy resins, casein, polyvinyl alcohol resins and polyvinylpyrrolidone resins. These binder resins may be either singly or in combinations of two or more.

The charge generation layer 5 is formed using vapor-deposition of the charge generation material or applying coating solution containing the charge generation material and the binder resin to form the charge generation layer. If the charge generation layer 5 is formed using the coating solution, the compounding ratio (weight ratio) of the charge generation material and the binder resin among the solution is preferably in the range of from 10:1 to 1:10.

Dispersion of the respective constituent materials in the coating solution to form the charge generation layer includes conventional processes such as ball mill dispersion, attritor dispersion, and sand mill dispersion. Such dispersion process needs a condition to retain crystalline property of the pigment even during the dispersion. Further, in the dispersion process, efficient particle size is preferably 0.5 μm or less, more preferably 0.3 μm or less, and particularly 0.15 μm or less.

The solvent used in the dispersion process includes conventional organic solvent, for example, methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. Such solvent can be used singly or in combination of two or more of them.

In order to form the charge generation layer 5 using the coating solution, usual methods such as a blade coating method, a wire bar coating method, a spray coating method, a dip coating method, a bead coating method, an air knife coating method and a curtain coating method can be used.

The film thickness of the charge generation layer 5 is preferably 0.1 to 5 μm and more preferably 0.2 to 2.0 μm.

The charge transport layer 6 comprises the charge transport material and the binder resin, or polymeric charge transport material.

The charge transport material includes an electron-transferable compound, for example, quinone compounds such as p-benzoquinone, chloranil, bromanil or anthraquinone, tetracyaoquino dimethane compounds, fluorenone compounds such as 2,4,7-trinitrofluorenone, xanthone compounds, benzophenone compounds, cyanovinyl compounds, or ethylene compounds; and hole-transferable compounds, for example, triarylamine compound, benzidine compound, arylalkane compounds, aryl-substituted ethylene compounds, stilbene compounds, anthracene compounds, or hydrazone compounds, but is not particularly limited thereto. These charge transport materials can be used singly or in combination of two or more of them.

In addition, preferably used as the charge transport material is a compound represented by the following formula (V-1), (V-2) or (V-3) in view of mobility.

In the formula (V-1), R¹⁴ represents a hydrogen atom or a methyl group, k represents 1 or 2, Ar⁶ and Ar⁷ each independently represents a substituted or unsubstituted aryl group, C₆H₄—C(R¹⁸)═C(R¹⁹)(R²⁰), or —C₆H₄—CH═CH—CH═C(Ar)₂ and represents a substituent amino group substituted by a halogen atom, an alkyl group having 1 to 5 carbon atoms, an alkoxy group having 1 to 5 carbon atoms or an alkyl group having 1 to 3 carbon atoms as the substituent. R¹⁸, R¹⁹ and R²⁰ each independently represents a hydrogen atom, a substituted or unsubstituted alkyl group, or a substituted or unsubstituted aryl group, and Ar represents a substituted or unsubstituted aryl group.

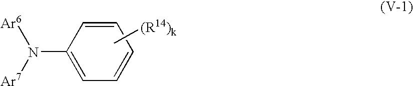

In the formula (V-2), R¹⁵ and R¹⁵ each independently represents a hydrogen atom, a halogen atom, an alkyl group having 1 to 5 carbon atoms, or an alkoxy group having 1 to 5 carbon atoms, R¹⁶, R¹⁶′, R¹⁷ and R¹⁷′ each independently represents a halogen atom, an alkyl group having 1 to 5 carbon atoms, an alkoxy group having 1 to 5 carbon atoms, an amino group substituted by an alkyl group having 1 or 2 carbon atoms, a substituted or unsubstituted aryl group, —C₆H₄—C(R¹⁸)═C(R¹⁹) (R²⁰), or —C₆H₄—CH═CH—CH═C (Ar) 2; R¹⁸, R¹⁹ and R²⁰ each independently represents a hydrogen atom, a substituted or unsubstituted alkyl group, or a substituted or unsubstituted aryl group, and Ar represents a substituted or unsubstituted aryl group. m and n each independently represents integer of 0 to 2.

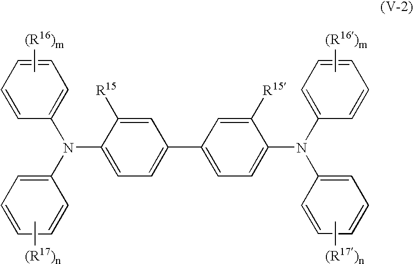

In the formula (V-3), R represnts a hydrogen atom, an alkyl group having 1 to 5 carbon atoms, an alkoxy group having 1 to 5 carbon atoms, a substituted or unsubstituted aryl group, or —CH═CH—CH═C(Ar)₂—Ar represents a substituted or unsubstituted aryl group. R²², R²²′, R²³ and R²³′ each independently represents a hydrogen atom, a halogen atom, an alkyl group having 1 to 5 carbon atoms, an alkoxy group having 1 to 5 carbon atoms, an amino group substituted by alkyl group having 1 or 2 carbon atoms, or a substituted or unsubstituted aryl group.

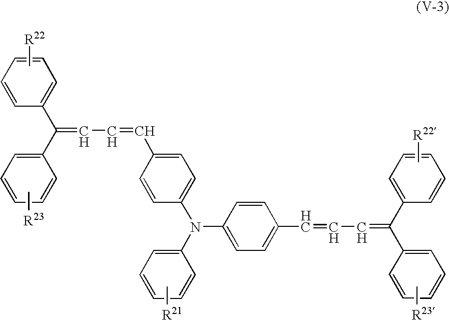

The binder resin used in the charge transport layer 6 includes, for example, a polycarbonate resin, a polyester resin, a methacryl resin, an acryl resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, silicon-alkyd resin, phenol-formaldehyde resin, and a styrene-alkyld resin. These binder resins can be used singly or in combination of two or more of them. The compounding ratio (weight ratio) of the charge transport material and the binder resin is preferably in the range of from 10:1 to 1:5.

As polymeric charge transport material, typically used is conventional material with charge transport property such as poly-N-vinylcarbazole, and polysilane. Particularly preferable is polyester polymeric charge transport material disclosed in JP-A-8-176293 and JP-A-8-208820 because of high charge transport property.

Although the polymeric charge transport material can be only material to form the charge transport layer 6, it is also preferable to admix the material with the binder resin to form a film.

The charge transport layer 6 is formed using the coating solution containing the above constituent material to form the charge transport layer.

The solvent used in the coating solution to form the charge transport layer includes conventional solvent, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; cyclic or linear chain ethers such as tetrahydrofuran, ethyl ether. Such solvent can be used singly or in combination of two or more of them.

The process for coating the coating solution to form the charge transport layer includes usual methods such as a blade coating method, a wire bar coating method, a spray coating method, a dip coating method, a bead coating method, an air knife coating method and a curtain coating method.

The film thickness of the charge transport layer 6 is preferably 5 to 50 μm, and more preferably 10 to 30 μm.

Additives such as an antioxidant, a light stabilizer, and a heat stabilizer may be added to the photosensitive layer 16 (charge-generating layer 13, charge transport layer 14, etc.) for the purpose of preventing the photoreceptor from being deteriorated by the ozone or oxidizing gas which has generated in the image forming apparatus or by light or heat.

Examples of the antioxidant include hindered phenols, hindered amines, p-phenylenediamine, arylalkanes, hydroquinone, spirochroman, spiroindanone and derivatives thereof, organosulfur compounds, and organophosphorus compounds. Examples of the light stabilizer include derivatives of benzophenone, benzotriazole, dithiocarbamate, tetramethylpiperidine, and the like.

Also, at least one electron-receiving material may be compounded in the photosensitive layer 3 for the purpose of improving sensitivity, reducing residual potential, decreasing fatigues during repeated use.

Examples of the electron-receiving material include succinic acid anhydride, maleic acid anhydride, dibromomaleic acid anhydride, phthalic acid anhydride, tetrabromophthalic acid anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthtalic acid. Among these materials, fluorenone types, quinone types and benzene derivatives having an electron-attractive substituent such as Cl, CN and NO₂ are particularly preferable.

With respect of the first electrophotographic photoreceptor according to the present invention, the protective layer 7 comprises a phenol derivative having a methylol group and a charge transport material having at least one selected from the group consisting of a hydroxyl group, a carboxyl group, an alkoxysilyl group, an epoxy group, a thiol group and an amino group, and wherein an infrared absorption spectrum thereof satisfies the conditions represented by the following formula (1):
(P₂/P₁)≦0.2 (1)
wherein P₁ is an absorbance of a maximum absorption peak in a range of 1560 cm⁻¹ to 1640 cm⁻¹ and P₂ is an absorbance of a maximum absorption peak in a range of 1645 cm⁻¹ to 1700 cm^{-1.}

In addition, an absorbance ratio (P₂/P₁) is preferably 0.18 or less and, more preferably 0.17 or less. If the absorbance ratio (P₂/P₁) exceeds 0.2, carrier-transferability is reduced and electrical property of the photoreceptor becomes insufficient to lead deterioration of image quality.

With respect of the second electrophotographic photoreceptor according to the present invention, the protective layer 7 comprises a phenol derivative having a methylol group and a charge transport material having a plurality of epoxy groups. In addition, for the second electrophotographic photoreceptor of the present invention, the protective layer 7 preferably satisfies the condition represented by the above formula (1). Also, the absorbance ratio (P₂/P₁) satisfies the above conditions, and thus the carrier-transferability is improved and the electrical property of the photoreceptor becomes enhancing to result in higher image quality.

Herein, the epoxy group has preferably a monovalent group having an epoxy ring, and contains glycidyl group (—CH₂CH(O)CH₂). More particularly, the epoxy group may one having an alkylene group bonded to a carbon atom in the epoxy ring (CH(O)CH₂), or —CH₂CH₂CH(O)CH₂ or —C₃H₆CH(O), in addition to a glycidyl group. Such alkylene group comprises preferably an alkylene group having 1 to 15 carbon atoms and, more preferably an alkylene group having 1 to 10 carbon atoms.

A phenol derivative mentioned above includes, for example, monomethylol phenols, dimethylol phenols or trimethylol phenols in a monomer form and a mixture thereof, and/or oligomer form or mixture of the monomer and the oligomer. Such phenol derivative having methylol group is obtainable by reacting phenol structure compound including substituted phenols having one hydroxyl group such as resorcin, bisphenol, phenol, cresol, xylenol, p-alkylphenol, and p-phenylphenol; substituted phenols having 2 hydroxyl groups such as catechol, resorcinol, hydroquinone; bisphenols such as bisphenol A and bisphenol Z; or biphenols, with formaldehyde or p-formaldehyde in the presence of acid catalyst or alkali catalyst. Commercially available phenol resin is also employed. It is noted that relative large molecules having structural repeating units in range of about 2 to 20 are defined as the oligomer and others having less units mean the monomer in the present detailed description.

The acid catalyst comprises sulfuric acid, p-toluenesulfonic acid, phosphoric acid, etc. The alkali catalyst comprises hydroxides of alkali metal and alkaline earth metal such as NaOH, KOH, Ca(OH)₂, and Ba(OH)₂, or an amine-based catalyst.

The amine-based catalyst includes ammonia, hexamethylenetetramine, trimethylamine, triethylamine, triethanolamine, etc. but is not particularly limited thereto. In case of using an alkali catalyst, the electrophotographic ability becomes remarkably worse due to remarkably trapping the carrier by the residual catalyst. Thus, it is preferable to neutralize the residue with an acid and/or to contact the residue to an adsorbent such as silica gel or an ion-exchange resin, thereby inactivating or removing the residue.

Alternatively, a phenol derivative having a methylol group is preferably a phenol resin and, more preferably a resol-type phenol resin.

The charge transport material having at least one selected from the group consisting of a hydroxyl group, a carboxyl group, an alkoxysilyl group, an epoxy group, a thiol group and an amino group is preferably the compound represented by the following formula (I), (II), (III) or (IV). The charge transport material having epoxy group preferably has a plurality of epoxy groups. The charge transport material having a plurality of epoxy groups is preferably the compound represented by the following formula (IV).
F—[(X¹)ₘ₁—(R¹)ₘ₂—Y]ₘ₃ (I)
Wherein F represents an organic group derived from a compound having a hole transportability, X¹ represents an oxygen atom or a sulfur atom, R¹ represents an alkylene group (preferably having 1 to 15 carbon atoms, and more preferably 1 to 10 carbon atoms), Y represents a hydroxyl group, a carboxyl group (—COOH), a thiol group (—SH) or an amino group(—NH₂), m1 and m2 independently represents 0 or 1, and m3 represents an integer of 1 to 4.
F—[(X²)ₙ₁—(R²)ₙ₂—(Z)ₙ₃G]ₙ₄ (II)
Wherein F represents an organic group derived from a compound having a hole transportability; X² represents an oxygen atom or a sulfur atom; R² represents an alkylene group (preferably having 1 to 15 carbon atoms, and more preferably 1 to 10 carbon atoms); Z represents an oxygen atom, a sulfur atom, NH or COO; G represents an epoxy group; n1, n2 and n3 each independently represents 0 or 1, and n4 represents an integer of 1 to 4.
F—[D —Si (R³)₍₃₋ₐ₎Qₐ]_{b} (III)
Wherein F represents an organic group derived from a compound having hole-transmission ability, D represents a flexible divalent group, R³ represents a hydrogen atom, a substituted or unsubstituted alkyl group (preferably having 1 to 15 carbon atoms, and more preferably 1 to 10 carbon atoms) or a substituted or unsubstituted aryl group (preferably having 6 to 20 carbon atoms, and more preferably 6 to 15 carbon atoms), Q represents hydrolyzable group, a represents an integer of 1 to 3, and b represents an integer of 1 to 4.

The above flexible divalent group D is particularly divalent group to bind F moiety for providing photo-electric property and substituent silicon group for contributing construction of three-dimensional inorganic glassy network. D shows specified structure of organic group to endow a suitable flexibility to portion of the inorganic glassy network having hardness but weakness, and to enhance mechanical toughness required for film. Such D includes particularly a divalent hydrocarbon group represented by —C_{α}H_{2α}—, —C_{β}H_{2β}—, —C_{γ}H_{2γ-4}— (wherein α represents an integer of 1 to 15, β represents an integer of 2 to 15, γ represents an integer of 3 to 15), —COO—, —S—, —O—, —CH₂—C₆H₄—, —N═CH—, —(C₆H₄)—(C₆H₄)—, and characteristic groups having structural combination thereof, and further groups with constructional atom in the characteristic groups substituted by other substituent. Additionally, the hydrolyzable group Q is preferably an alkoxy group and, more preferably an alkoxy group having 1 to 15 carbon atoms.
F—[(X²)ₙ₁—(R²)ₙ₂—(Z)ₙ₃G]ₙ₄ (IV)
wherein F represents an organic group derived from a compound having a hole transportability; X² represents an oxygen atom or a sulfur atom; R² represents an alkylene group preferably having 1 to 15 carbon atoms, and more preferably 1 to 10 carbon atoms; Z represents an oxygen atom, a sulfur atom, NH or COO; G represents an epoxy group; n1, n2 and n3 each independently represents 0 or 1, and n4 represents an integer of 2 to 4.

The organic group F derived from the compound having hole-transmission ability of the compounds represented by formulae (I) to (IV) is preferably the compound represented by the following formula (VI).

In the formula (VI), Ar¹, Ar², Ar³ and Ar⁴ each independently represents a substituted or unsubstituted aryl group, Ar⁵ represents a substituted or unsubstituted aryl or arylene group, one to four groups selected from the group consisting of Ar¹ to Ar⁴ are bonded to a moiety represented by —[(X¹)ₘ₁—(R¹)ₘ₂—Y], —[(X²)ₙ₁—(R²)ₙ₂—(Z)ₙ₃G] or -[D —Si(R³)₍₃₋ₐ₎Qₐ] in the compounds of the formulae (I) to (IV), respectively.

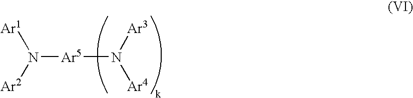

As a substituted or unsubstituted aryl group represented by Ar¹ to Ar⁵ in the formula (VI), specifically preferable is an aryl group represented by the following formulae (VI-1) to (VI-7).

TABLE 1

| | |
|---|---|
| VI-1 | 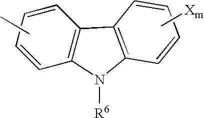 |
| VI-2 | 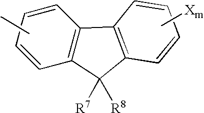 |
| VI-3 | 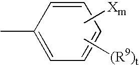 |
| VI-4 | 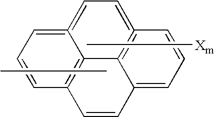 |
| VI-5 | 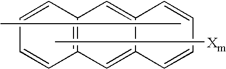 |
| VI-6 | 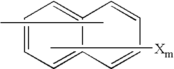 |
| VI-7 | —Ar—Z₃—Ar—X₃ |

Ar in the compound represented by the above formula (VI-7) is preferably an aryl group represented by the following formula (VI-8) or (VI-9).

TABLE 2

| | |
|---|---|
| VI-8 | 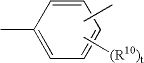 |
| VI-9 | 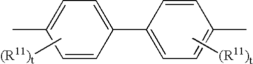 |

In addition, Z of an aryl group represented by the formula (VI-7) is preferably a divalent group represented by the following formula (VI-10) or (VI-17).

TABLE 3

| | |
|---|---|
| VI-10 | —(CH₂)_{g}— |
| VI-11 | —(CH₂CH₂O)ᵣ— |
| VI-12 | 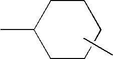 |
| VI-13 | 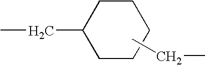 |
| VI-14 | 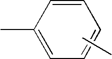 |
| VI-15 | 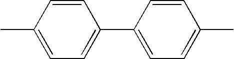 |
| VI-16 | 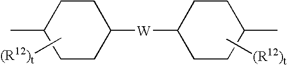 |
| VI-17 | 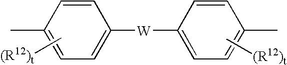 |

In formulae (VI-1) to (VI-17), R⁶ represents a hydrogen atom, an alkyl group having 1 to 4 carbon atoms, an alkoxy group having 1 to 4 carbon atoms, a phenyl group substituted or unsubstituted by them or an aralkyl group having 7 to 10 carbon atoms; R⁷ to R³ each independently represents a hydrogen atom, an alkyl group having 1 to 4 carbon atoms, an alkoxy group having 1 to 4 carbon atoms, a phenyl group substituted or unsubstituted by them or an aralkyl group having 7 to 10 carbon atoms or a halogen atom; m and s each independently represents 0 or 1, q and r each independently represents an integer of 1 to 10, a plurality of t each independently represents an integer of 1 to 3.

X in the formulae (VI-1) to (VI-7) is a moiety represented by —[(X¹)ₘ₁—(R¹)ₘ₂—Y], —[(X²)ₙ₂—(R²)ₙ₂—(Z)ₙ₃G] or -[D-Si(R³)₍₃₋ₐ₎Qₐ] in the compounds of formulae (I) to (IV).

W in the formulae (VI-16) to (VI-17) is a divalent group represented by the formulae (VI-18) to (VI-26). u in the formula (VI-25) represents an integer of 0 to 3.

TABLE 4

| | |
|---|---|
| VI-18 | —CH₂— |
| VI-19 | —C(CH₃)₂— |
| VI-20 | —O— |
| VI-21 | —S— |
| VI-22 | —C(CF₃)₂— |
| VI-23 | —Si(CH₃)₂— |
| VI-24 | 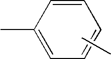 |
| VI-25 | 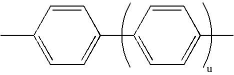 |
| VI-26 | 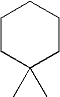 |

As a specific structure of Ar⁵ in the formula (VI), the structure of the above Ar¹ to Ar⁴ is exemplified that m=1 when k=0 while m=0 if k=1.

A compound represented by the formula (I), (II) or (IV) is particularly exemplified by the following compounds (1-1) to (1-36), the following compounds (II-1) to (II-2), the following compounds (VI-1) to (VI-45). Further, in the following Tables, groups with Me or bonds and without a substituent is a methyl group and Et is an ethyl group.

TABLE 5

| | |
|---|---|
| I-1 | 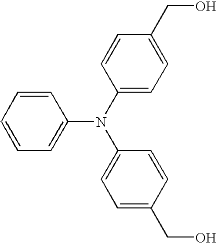 |
| I-2 | 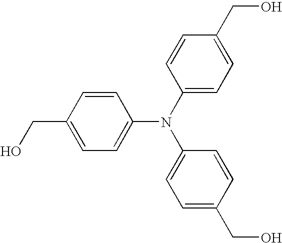 |
| I-3 | 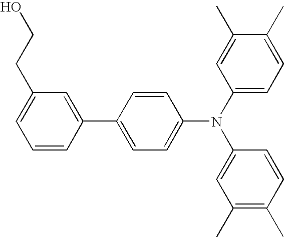 |
| I-4 | 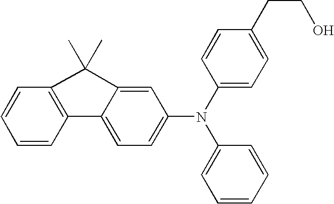 |
| I-5 | 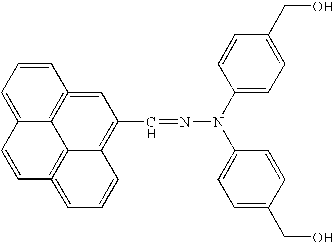 |

TABLE 6

| | |
|---|---|
| I-6 | 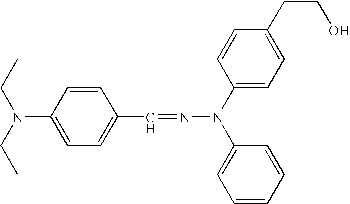 |
| I-7 | 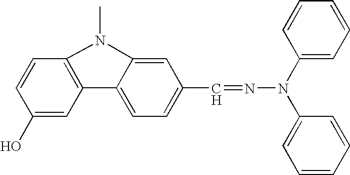 |
| I-8 | 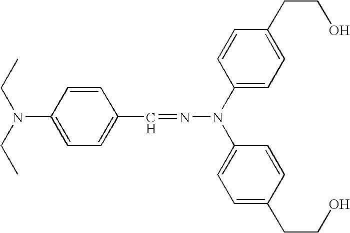 |
| I-9 | 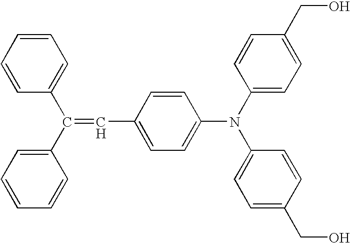 |
| I-10 | 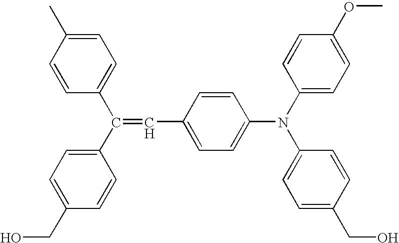 |

TABLE 7

| | |
|---|---|
| I-11 | 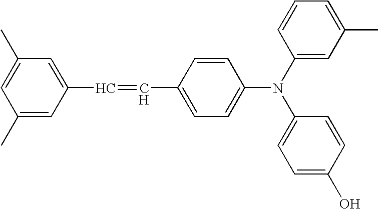 |
| I-12 | 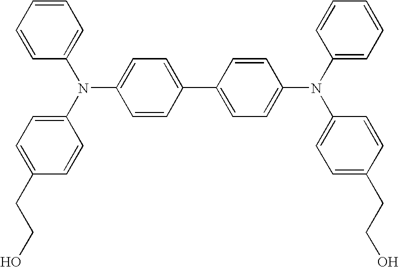 |
| I-13 | 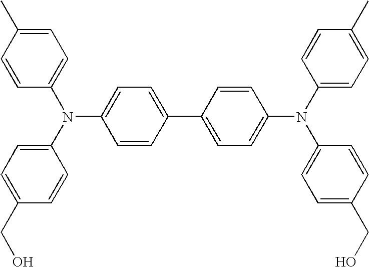 |
| I-14 | 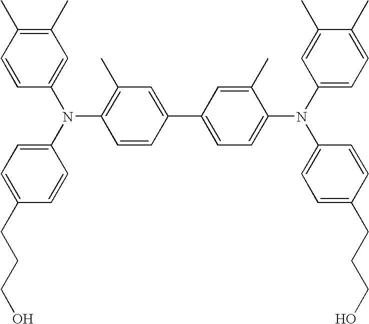 |

TABLE 8

| | |
|---|---|
| I-15 | 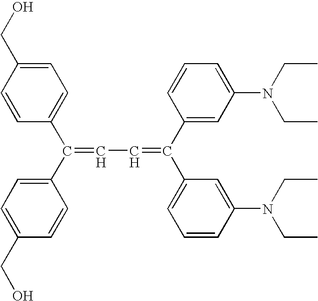 |
| I-16 | 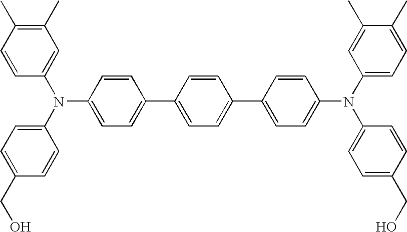 |
| I-17 | 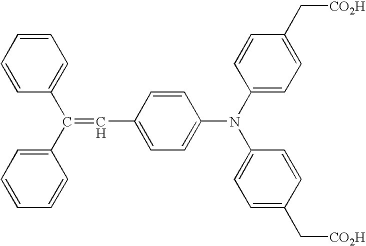 |
| I-18 | 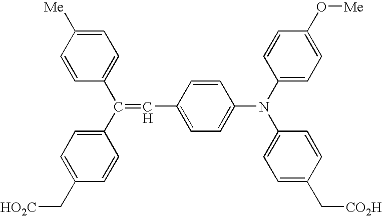 |

TABLE 9

| | |
|---|---|
| I-19 | 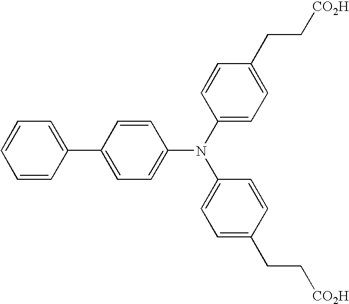 |
| I-20 | 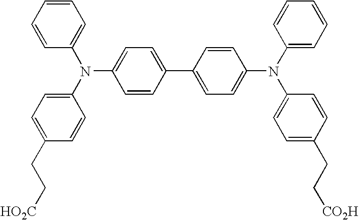 |
| I-21 | 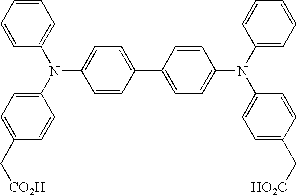 |
| I-22 | 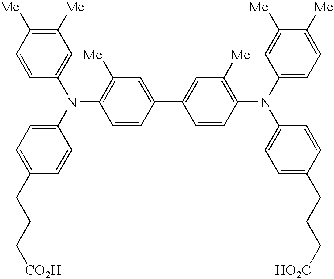 |

TABLE 10

| | |
|---|---|
| I-23 | 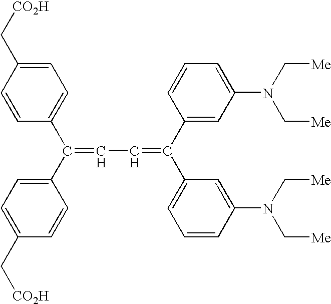 |
| I-24 | 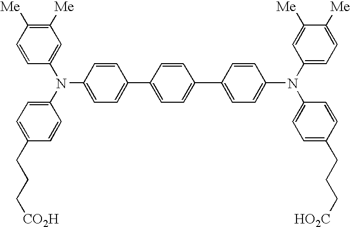 |
| I-25 | 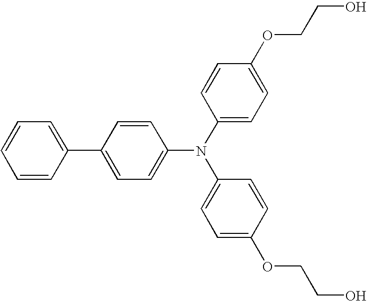 |

TABLE 11

| | |
|---|---|
| I-26 | 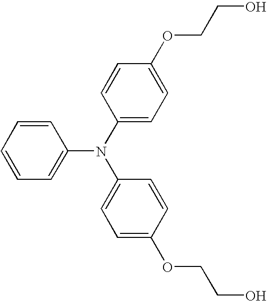 |
| I-27 | 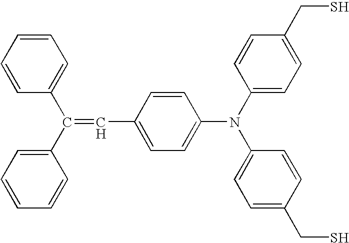 |
| I-28 | 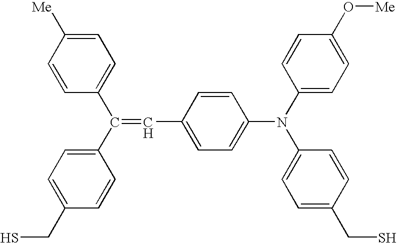 |
| I-29 | 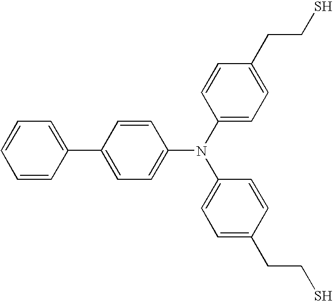 |

TABLE 12

| | |
|---|---|
| I-30 | 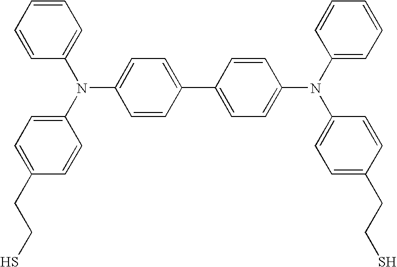 |
| I-31 | 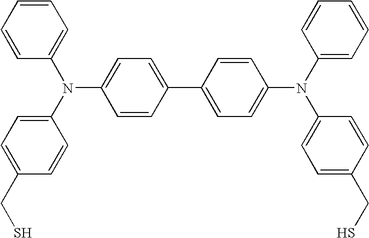 |
| I-32 | 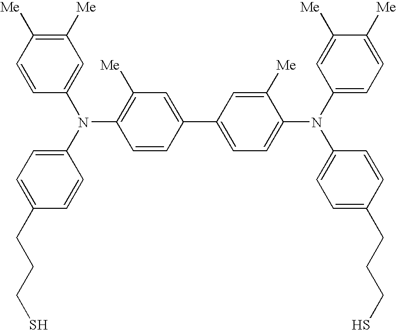 |
| I-33 | 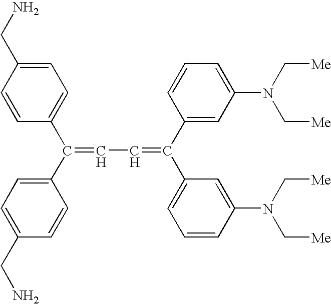 |

TABLE 13

| | |
|---|---|
| I- 34 | 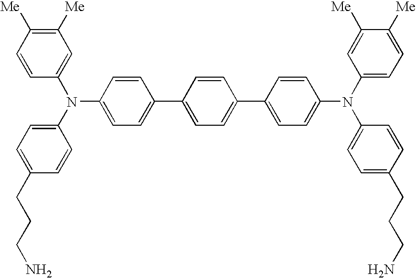 |
| I- 35 | 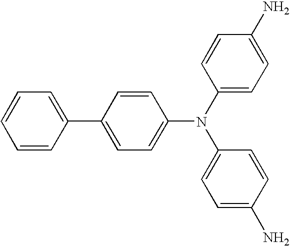 |
| I- 36 | 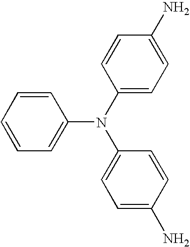 |

TABLE 14

| | |
|---|---|
| H-1 | 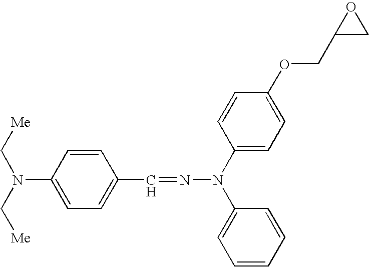 |
| H-2 | 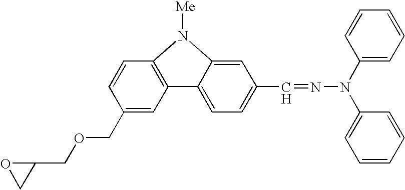 |
| IV-1 | 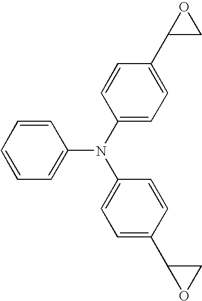 |
| IV-2 | 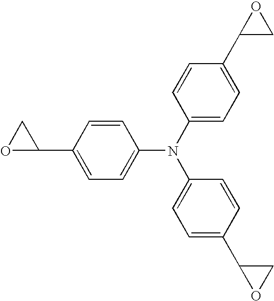 |

TABLE 15

| | |
|---|---|
| IV-3 | 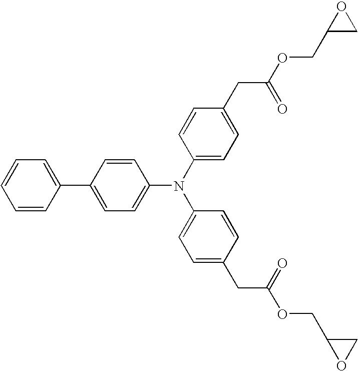 |
| IV-4 | 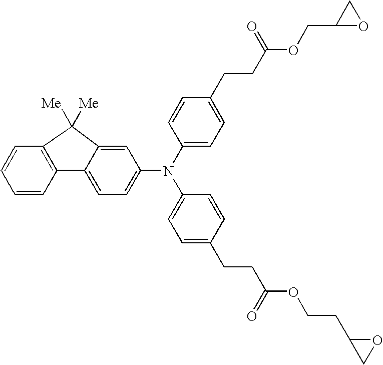 |
| IV-5 | 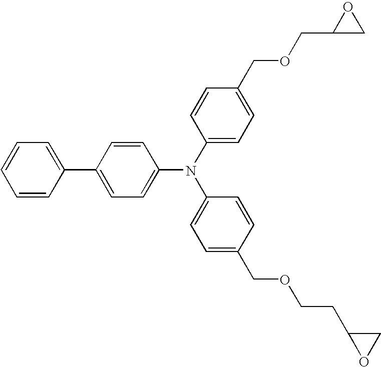 |

TABLE 16

| | |
|---|---|
| IV-6 | 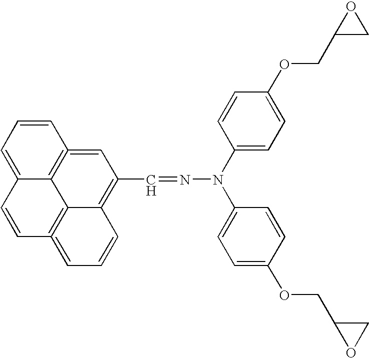 |
| IV-7 | 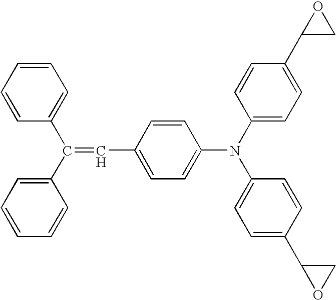 |
| IV-8 | 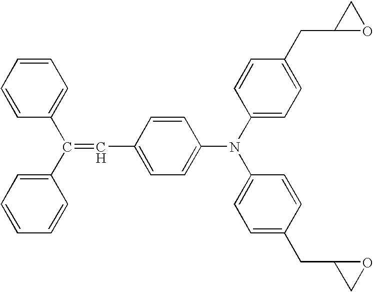 |

TABLE 17

| | |
|---|---|
| IV-9 | 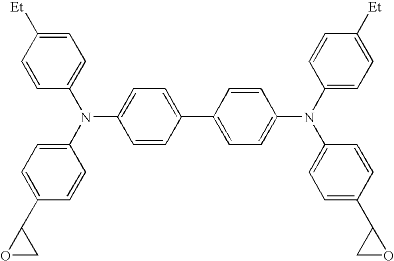 |
| IV-10 | 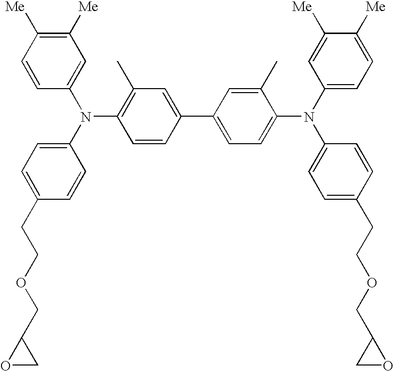 |
| IV-11 | 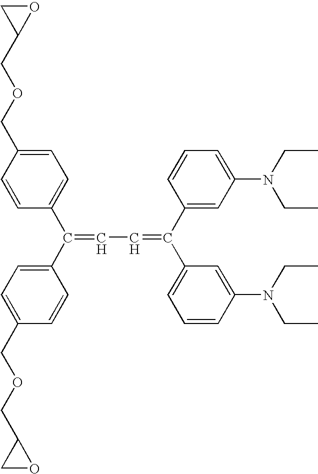 |

TABLE 18

| | |
|---|---|
| IV-12 | 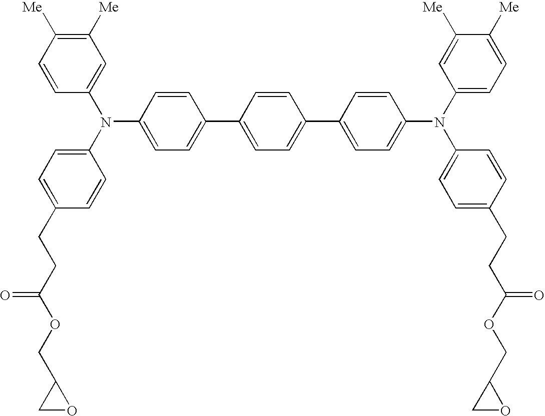 |
| IV-13 | 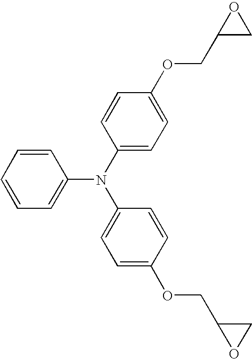 |
| IV-14 | 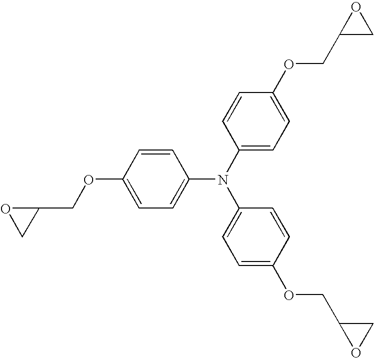 |

TABLE 19

| | |
|---|---|
| IV-15 | 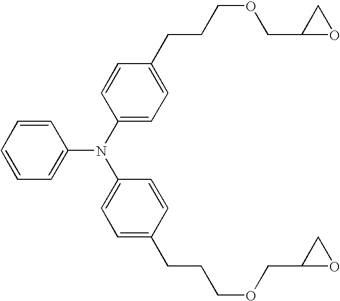 |
| IV-16 | 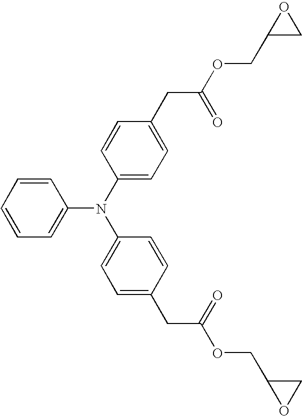 |
| IV-17 | 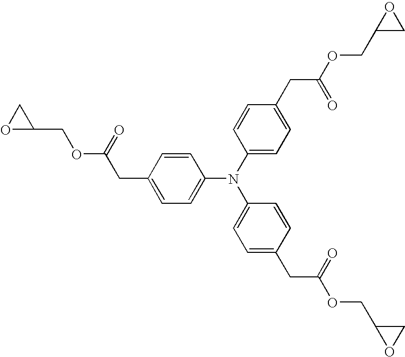 |

TABLE 20

| | |
|---|---|
| IV-18 | 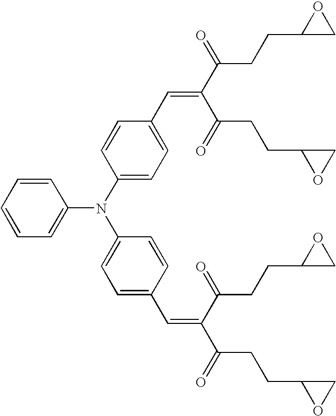 |
| IV-19 | 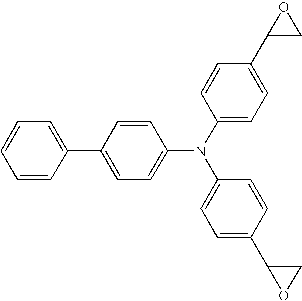 |
| IV-20 | 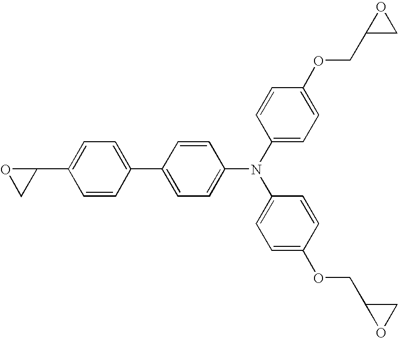 |

TABLE 21

| | |
|---|---|
| IV-21 | 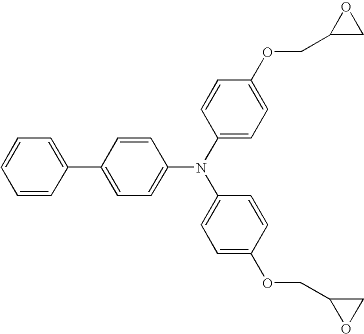 |
| IV-22 | 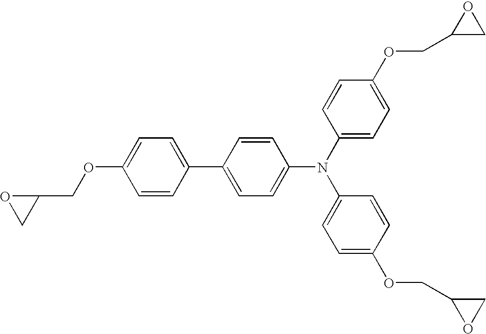 |
| IV-23 | 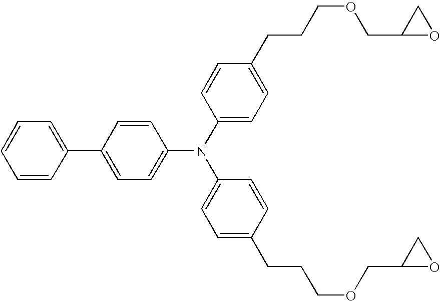 |

TABLE 22

| | |
|---|---|
| IV-24 | 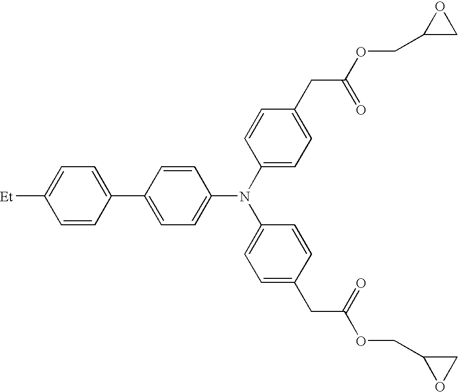 |
| IV-25 | 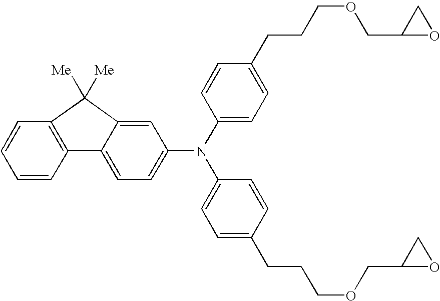 |
| IV-26 | 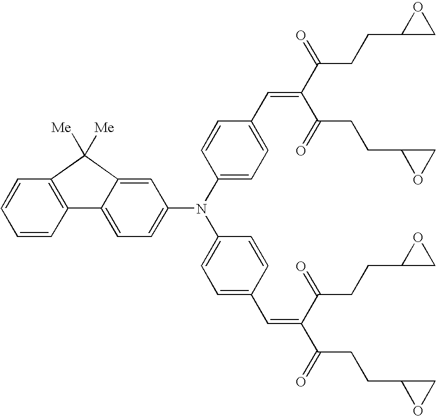 |

TABLE 23

| | |
|---|---|
| IV-27 | 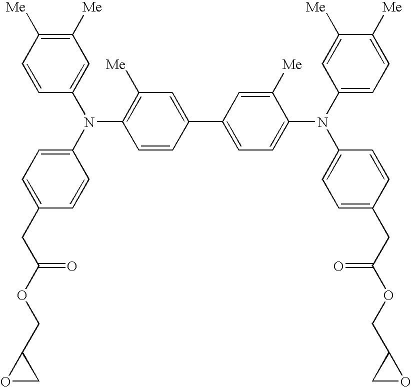 |
| IV-28 | 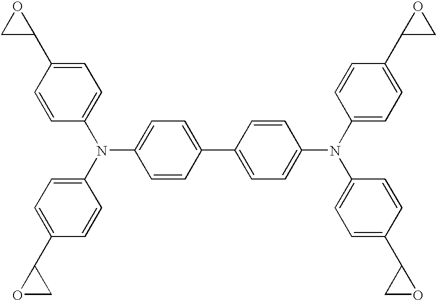 |
| IV-29 | 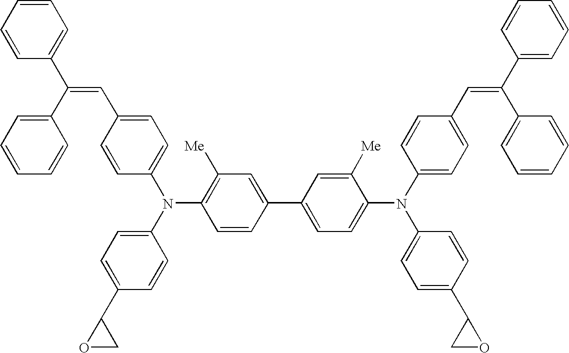 |

TABLE 24

| | |
|---|---|
| IV-30 | 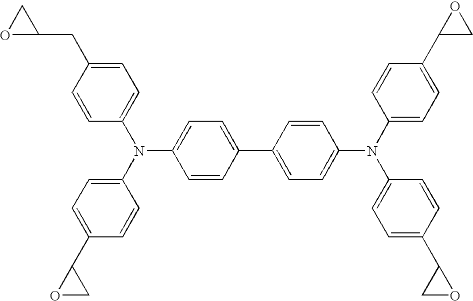 |
| IV-31 | 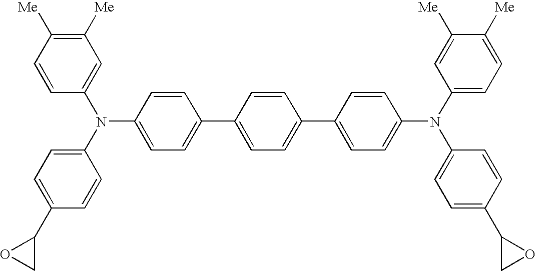 |
| IV-32 | 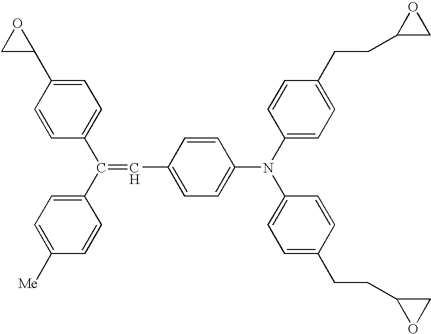 |

TABLE 25

| | |
|---|---|
| IV- 33 | 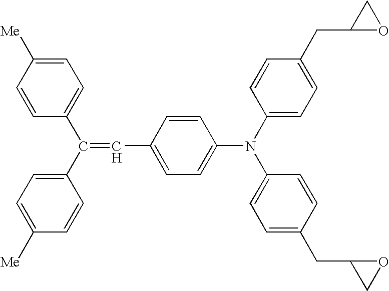 |
| IV- 34 | 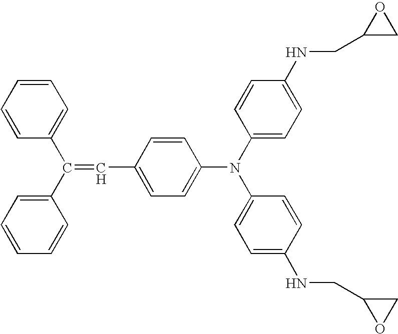 |
| IV- 35 | 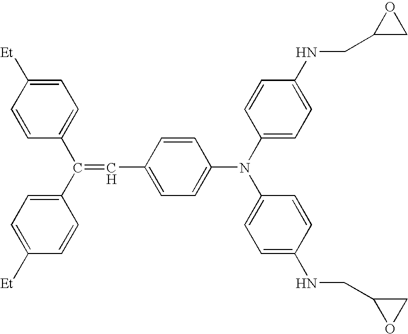 |

TABLE 26

| | |
|---|---|
| IV-36 | 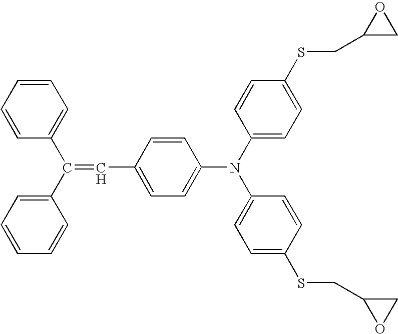 |
| IV-37 | 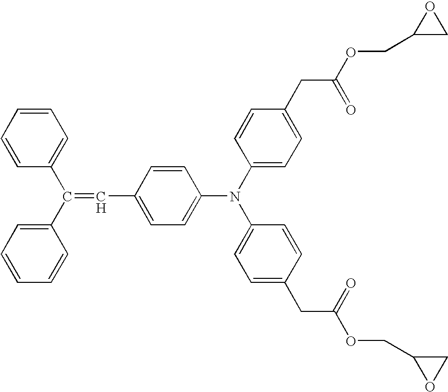 |

TABLE 27

| | |
|---|---|
| IV-38 | 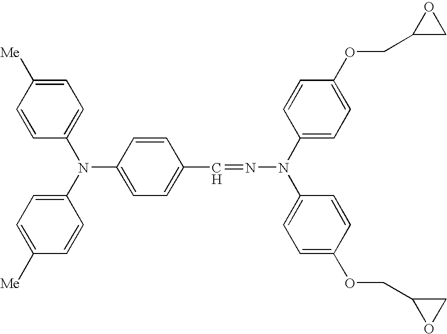 |
| IV-39 | 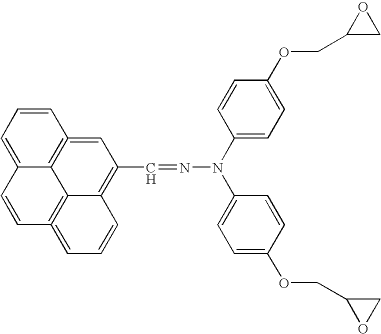 |
| IV-40 | 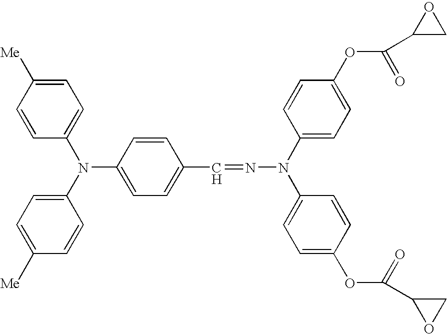 |

TABLE 28

| | |
|---|---|
| IV-41 | 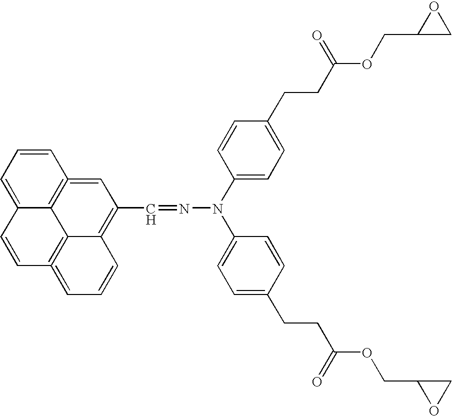 |
| IV-42 | 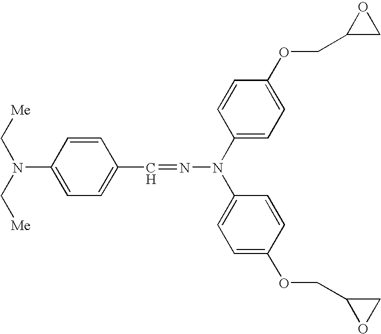 |
| IV-43 | 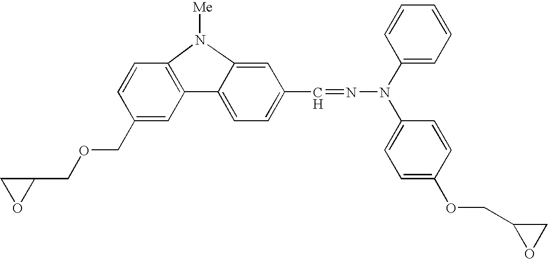 |

TABLE 29

| | |
|---|---|
| IV-44 | 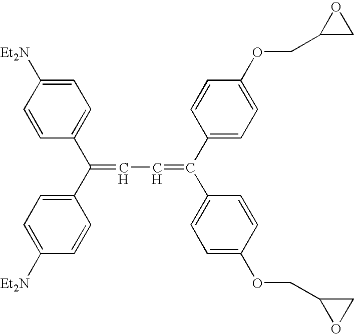 |
| IV-45 | 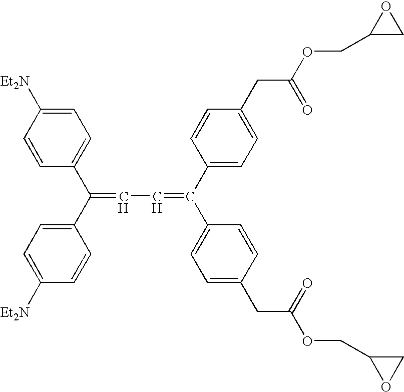 |

Moreover, the compounds represented by the following formula (III) include particularly the compounds represented by the formulae (III-1) to (III-61). The compounds of the formulae (III-1) to (III-61) are obtained by combining Ar¹ to Ar⁵ of the compound of the formula (VI) and k and defining alkoxysilyl group (s) as shown in the following Tables.

| No. | Ar¹ | Ar² | Ar³ | Ar⁴ |
|---|---|---|---|---|
| III-1 | 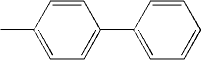 | 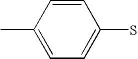 | — | — |
| III-2 | 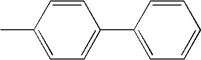 | 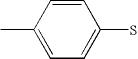 | — | — |
| III-3 | 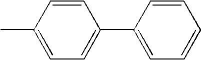 | 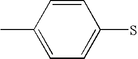 | — | — |
| III-4 | 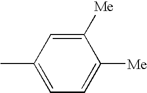 | 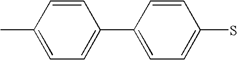 | — | — |
| III-5 | 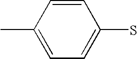 | 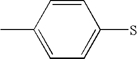 | — | — |
| III-6 | 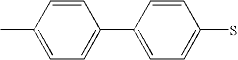 | 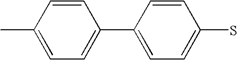 | — | — |
| III-7 | 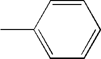 | 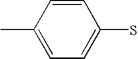 | 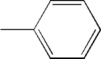 | 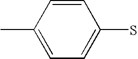 |

| No. | Ar⁵ | k | S |
|---|---|---|---|
| III-1 | 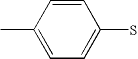 | 0 | —(CH2)2—COO—(CH2)3—Si(OiPr)3 |
| III-2 | 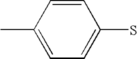 | 0 | —(CH2)2—COO—(CH2)3—Si(OiPr)2Me |
| III-3 | 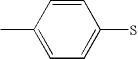 | 0 | —(CH2)2—COO—(CH2)3—Si(OiPr)Me2 |
| III-4 | 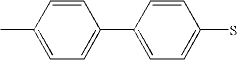 | 0 | —COO—(CH2)3—Si(OiPr)3 |
| III-5 | 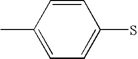 | 0 | —(CH2)2—COO—(CH2)3—Si(OiPr)3 |
| III-6 | 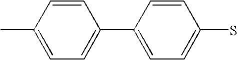 | 0 | —COO—(CH2)3—Si(OiPr)3 |
| III-7 | 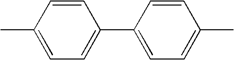 | 1 | —(CH2)4—Si(OEt)3 |

TABLE 31

| No. | Ar¹ | Ar² | Ar³ | Ar⁴ | Ar⁵ | k | S |
|---|---|---|---|---|---|---|---|
| III-8 | 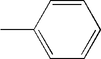 | 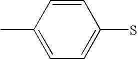 | 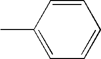 | 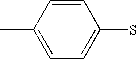 | 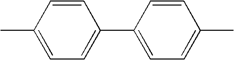 | 1 | —(CH2)4—Si(OiPr)3 |
| III-9 | 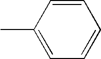 | 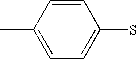 | 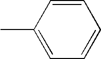 | 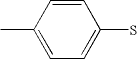 | 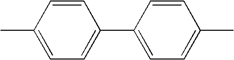 | 1 | —CH═CH—(CH2)2—Si(OiPr)3 |
| III-10 | 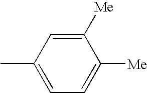 | 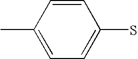 | 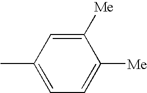 | 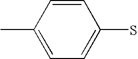 | 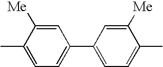 | 1 | —(CH2)4—Si(OMe)3 |
| III-11 | 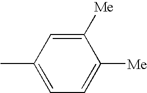 | 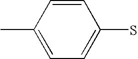 | 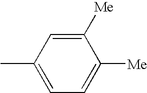 | 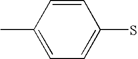 | 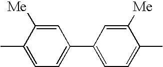 | 1 | —(CH2)4—Si(OiPr)3 |
| III-12 | 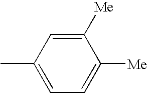 | 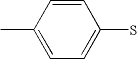 | 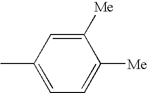 | 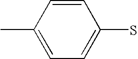 | 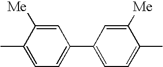 | 1 | —CH═CH—(CH2)2—Si(OiPr)3 |
| III-13 | 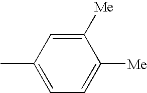 | 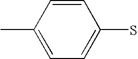 | 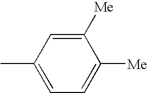 | 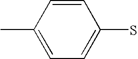 | 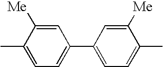 | 1 | —CH═N—(CH2)3—Si(OiPr)3 |
| III-14 | 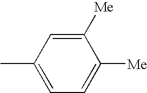 | 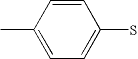 | 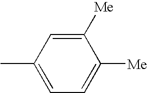 | 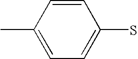 | 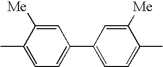 | 1 | —O—(CH2)3—Si(OiPr)3 |

TABLE 32

| | | | | | | | |
|---|---|---|---|---|---|---|---|
| No. | Ar¹ | Ar² | Ar³ | Ar⁴ | Ar⁵ | k | S |

| | | | | | | | |
|---|---|---|---|---|---|---|---|
| III-15 | 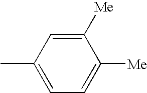 | 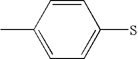 | 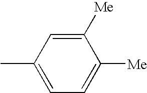 | 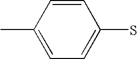 | 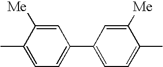 | 1 | —COO—(CH2)3—Si(OiPr)3 |
| III-16 | 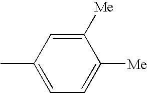 | 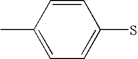 | 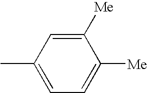 | 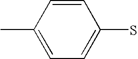 | 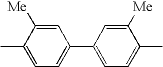 | 1 | —(CH2)2—COO—(CH2)3—Si(OiPr)3 |
| III-17 | 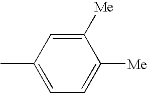 | 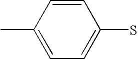 | 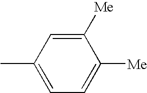 | 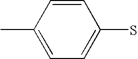 | 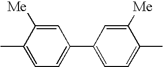 | 1 | —(CH2)2—COO—(CH2)3—Si(OMe)2Me |
| III-18 | 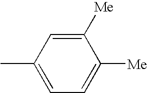 | 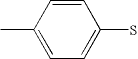 | 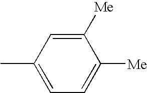 | 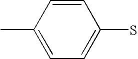 | 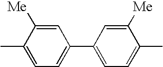 | 1 | —(CH2)2—COO—(CH2)3—Si(OiPr)Me2 |
| III-19 | 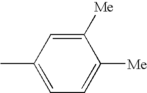 | 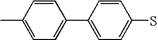 | 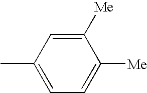 | 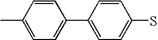 | 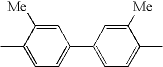 | 1 | —COO—(CH2)3—Si(OiPr)3 |
| III-20 | 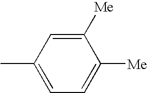 | 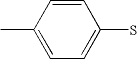 | 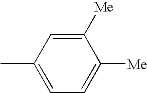 | 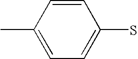 | 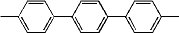 | 1 | —(CH2)4—Si(OiPr)3 |

TABLE 33

| No. | Ar¹ | Ar² | Ar³ | Ar⁴ | Ar⁵ | k | S |
|---|---|---|---|---|---|---|---|
| III-21 | 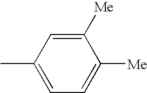 | 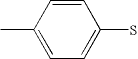 | 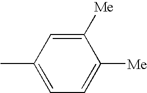 | 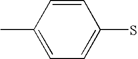 | 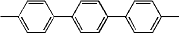 | 1 | —CH═CH—(CH2)2—Si(OiPr)3 |
| III-22 | 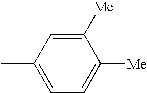 | 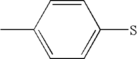 | 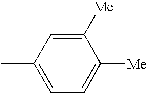 | 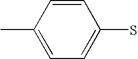 | 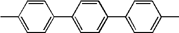 | 1 | —(CH2)2—COO—(CH2)3—Si(OiPr)3 |
| III-23 | 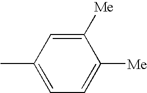 | 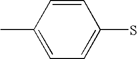 | 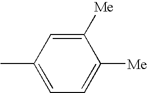 | 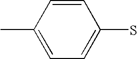 | 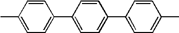 | 1 | —(CH2)2—COO—(CH2)3—Si(OiPr)2Me |
| III-24 | 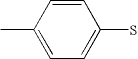 | 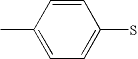 | 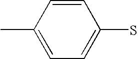 | 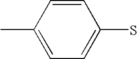 | 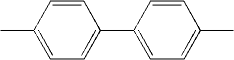 | 1 | —COO—(CH2)3—Si(OiPr)3 |
| III-25 | 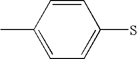 | 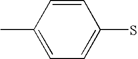 | 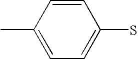 | 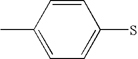 | 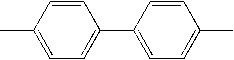 | 1 | —(CH2)2—COO—(CH2)3—Si(OiPr)3 |
| III-26 | 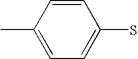 | 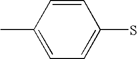 | 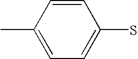 | 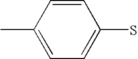 | 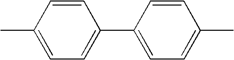 | 1 | —(CH2)2—COO—(CH2)3—Si(OiPr)2Me |
| III-27 | 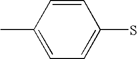 | 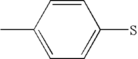 | 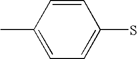 | 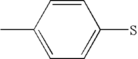 | 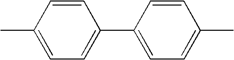 | 1 | —(CH2)2—COO—(CH2)3—Si(OiPr)Me2 |
| III-28 | 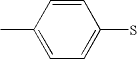 | 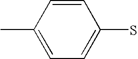 | 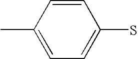 | 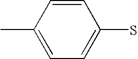 | 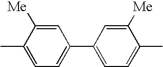 | 1 | —COO—(CH2)3—Si(OiPr)3 |

TABLE 34

| No. | Ar¹ | Ar² | Ar³ | Ar⁴ | Ar⁵ | k | S |
|---|---|---|---|---|---|---|---|
| III-29 | 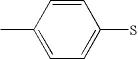 | 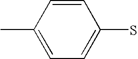 | 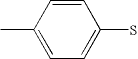 | 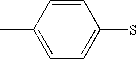 | 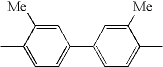 | 1 | —(CH2)2—COO—(CH2)3—Si(OiPr)3 |
| III-30 | 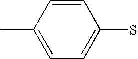 | 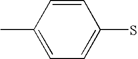 | 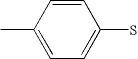 | 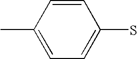 | 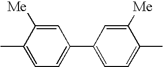 | 1 | —(CH2)2—COO—(CH2)3—Si(OiPr)2Me |
| III-31 | 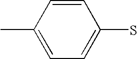 | 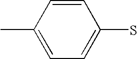 | 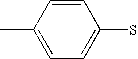 | 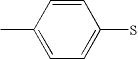 | 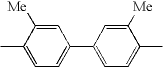 | 1 | —(CH2)2—COO—(CH2)3—Si(OiPr)Me2 |
| III-32 | 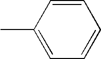 | 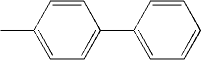 | — | — | 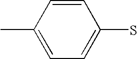 | 0 | —(CH2)4—Si(OiPr)3 |
| III-33 | 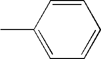 | 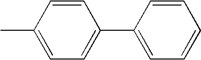 | — | — | 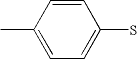 | 0 | —(CH2)4—Si(OEt)3 |
| III-34 | 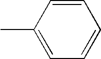 | 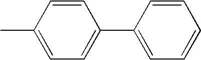 | — | — | 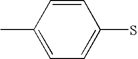 | 0 | —(CH2)4—Si(OMe)3 |
| III-35 | 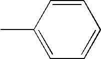 | 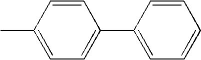 | — | — | 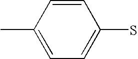 | 0 | —(CH2)4—SiMe(OMe)2 |
| III-36 | 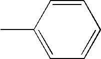 | 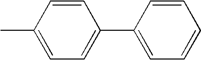 | — | — | 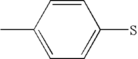 | 0 | —(CH2)4—SiMe(OiPr)2 |

TABLE 35

| No. | Ar¹ | Ar² | Ar³ | Ar⁴ | Ar⁵ | k | S |
|---|---|---|---|---|---|---|---|
| III-37 | 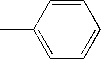 | 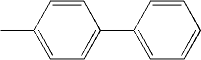 | — | — | 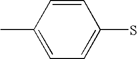 | 0 | —CH═CH—(CH2)2—Si(OiPr)3 |
| III-38 | 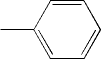 | 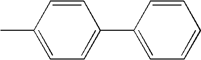 | — | — | 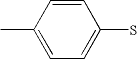 | 0 | —CH═CH—(CH2)2—Si(OiPr)3 |
| III-39 | 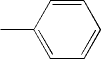 | 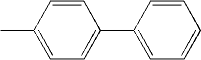 | — | — | 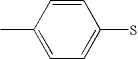 | 0 | —CH═N—(CH2)3—Si(OiMe)3 |
| III-40 | 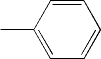 | 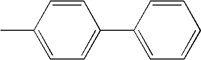 | — | — | 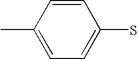 | 0 | —CH═N—(CH2)3—Si(OiPr)3 |
| III-41 | 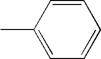 | 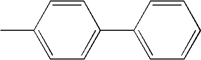 | — | — | 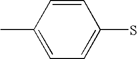 | 0 | —O—(CH2)3—Si(OiPr)3 |
| III-42 | 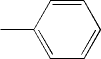 | 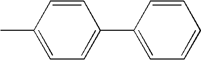 | — | — | 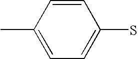 | 0 | —COO—(CH2)3—Si(OiPr)3 |
| III-43 | 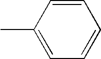 | 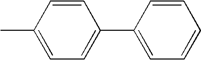 | — | — | 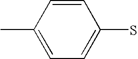 | 0 | —(CH2)2—COO—(CH2)3—Si(OiPr)3 |
| III-44 | 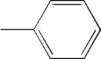 | 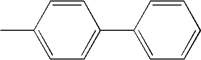 | — | — | 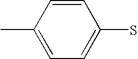 | 0 | —(CH2)2—COO—(CH2)3—Si(OiPr)2Me |

TABLE 36

| No. | Ar¹ | Ar² | Ar³ | Ar⁴ | Ar⁵ | k | S |
|---|---|---|---|---|---|---|---|
| III-45 | 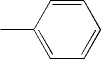 | 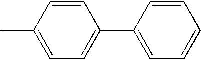 | — | — | 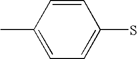 | 0 | —(CH2)2—COO—(CH2)3—Si(OiPr)3 |
| III-46 | 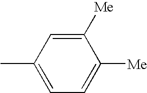 | 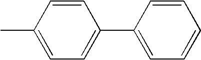 | — | — | 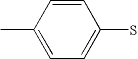 | 0 | —(CH2)4—Si(OMe)3 |
| III-47 | 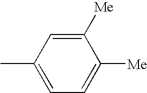 | 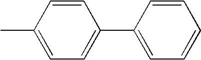 | — | — | 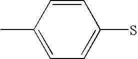 | 0 | —(CH2)2—COO—(CH2)3—Si(OiPr)3 |
| III-48 | 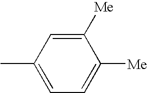 | 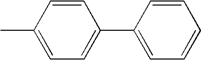 | — | — | 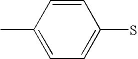 | 0 | —(CH2)2—COO—(CH2)3—Si(OiPr)2 |
| III-49 | 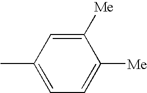 | 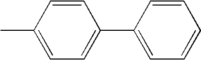 | — | — | 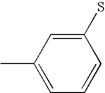 | 0 | —I—(CH2)3—Si(OiPr)3 |
| III-50 | 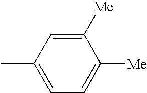 | 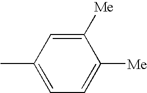 | — | — | 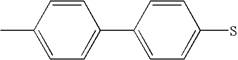 | 0 | —COO—(CH2)3—Si(OiPr)3 |
| III-51 | 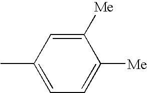 | 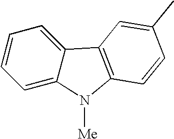 | — | — | 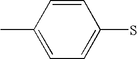 | 0 | —(CH2)4—Si(OiPr)3 |
| III-52 | 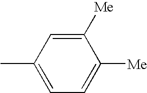 | 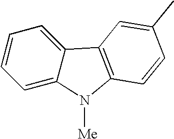 | — | — | 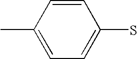 | 0 | —(CH2)2—COO—(CH2)3—Si(OiPr)3 |

TABLE 37

| No. | Ar¹ | Ar² | Ar³ | Ar⁴ | Ar⁵ | k | S |
|---|---|---|---|---|---|---|---|
| III-53 | 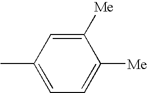 | 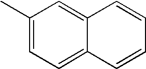 | — | — | 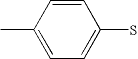 | 0 | —(CH2)4—Si(OiPr)3 |
| III-54 | 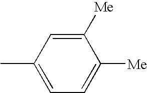 | 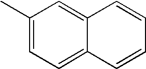 | — | — | 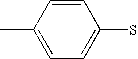 | 0 | —(CH2)2—COO—(CH2)3——Si(OiPr)3 |
| III-55 | 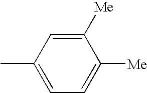 | 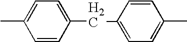 | — | — | 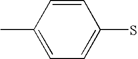 | 0 | —(CH2)4—Si(OiPr)3 |
| III-56 | 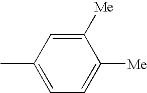 | 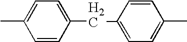 | — | — | 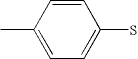 | 0 | —(CH2)2—COO—(CH2)3—Si(OiPr)3 |
| III-57 | 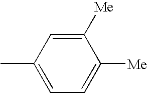 | 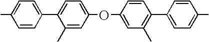 | — | — | 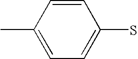 | 0 | —(CH2)4—Si(OiPr)3 |
| III-58 | 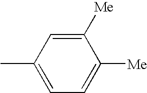 | 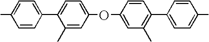 | — | — | 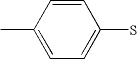 | 0 | —(CH2)2—COO—(CH2)3—Si(OiPr)3 |
| III-59 | 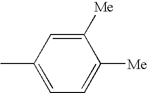 | 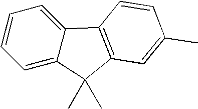 | — | — | 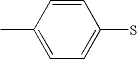 | 0 | —(CH2)2—COO—(CH2)3—Si(OiPr)3 |
| III-60 | 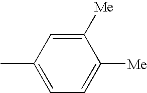 | 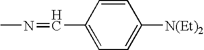 | — | — | 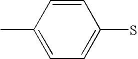 | 0 | —(CH2)2—COO—(CH2)3—Si(OiPr)3 |
| III-61 | 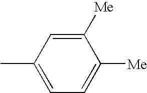 | 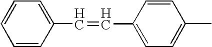 | — | — | 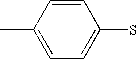 | 0 | —(CH2)2—COO—(CH2)3—SiOiPr)3 |

Conductive particles can be added to the protective layer 7 to lower residual potential. As the conductive particles, metal, metal oxide and carbon black particles are may be employed. Among them, preferable is metal or metal oxide. The metal includes aluminum, zinc, copper, chromium, nickel, silver and stainless steel, or materials vapor-deposited material with such metal on surface of plastic particle. The metal oxide includes zinc oxide, titanium oxide, tin oxide, antimony oxide, indium oxide, bismuth oxide, indium oxide doped with tin, tin oxide doped with antimony or tantalum, and zirconium oxide doped with antimony, etc. Such metal oxide can be used singly or in combination of two or more of them. In case where the metal oxide is used in combination of two or more, it can be simply a mixture thereof or in the form of solid-fusion solution or fusion solution. An average particle diameter of the conductive particle is preferably 0.3 μm or less and, in particular preferably 0.1 μm or less in view of transparency of the protective layer 7.

The protective layer 7 further comprises the compound represented by the following formula (VII-1′) in order to control various physical properties.
Si(R³⁰)_{(4-c)}Q_{c} (VII-1)
Wherein R³⁰ represens a hydrogen atom substituted or unsubstituted aryl group, Q represents a hydrolyzable group and c represents an integer of 1 to 4.

Particular examples of the compound of the formula (VII-1) is a silane coupling agent mentioned below. The silane coupling agent includes tetrafunctional alkoxysilane (c=4) such as tetramethoxysilane and tetraethoxysilane; trifunctional alkoxysilane (c=3) such as methyltrimethoxysilane, methyltriethoxysilane, ethyltrimethoxysilane, methyltrimethyoxyethoxysilane, vinyltrimethoxysilane, vinyltriethoxysilane, phenyltrimethoxysilane, γ-glycidoxypropylmethyldiethoxysilane, γ-glycidoxypropyltrimethoxysilane, γ-aminopropyltriethoxysilane, γ-aminopropyltrimethoxysilane, γ-aminopropylmethyldimethoxysilane, N-β(aminoethyl)γ-aminopropyltriethoxysilane, (tridecafluoro-1,1,2,2-tetrahydroocyl)triethoxysilane, (3,3,3-trifluoropropyl) trimethoxysilane, 3-(heptafluoroisopropoxy) propyltriethoxysilane, 1H, 1H, 2H, 2H-perfluoroalkyltriethoxy silane, 1H, 1H, 2H, 2H-perfluorodecyltriethoxysilane, 1H, 1H, 2H, 2H-perfluorooctyl triethoxysilane; bifunctional alkoxysilane (c=2) such as dimethyldimethoxysilane, diphenyldimethoxysilane, and methylphenyldimethoxysilane; monofunctional alkoxysilane (c=1) such as trimethylmethoxysilane. In order to increase intensity of the film, trifunctional and tetrafunctional alkoxysilanes are preferable while monofunctional or bifunctional alkoxysilanes are preferably used for improving flexibility and film formation ability.

Furthermore, silicon base hard coating agent prepared from the above coupling agent is also useable. Commercially available hard coating agent includes, for example, KP-85, X-40-9740, X-40-2239 (all of them produced by Shin-Etsu Silicone Co, Ltd.) and AY42-440, AY42-441, AY49-208 (all of them produced by Toray Dow Coning Co., Ltd.) In order to increase strength of the protective layer 7, preferably used is the compound represented by the following formula (VII-2) having two or more silicon atoms.
B—(Si(R³¹)_{(3-d)}Q_{d})₂ (VII-2)

Wherein B represents a divalent organic group, R³¹ represents a hydrogen atom, an alkyl group or a substituted or unsubstituted aryl group, Q represents a hydrolyzable group, and a represents an integer of 1 to 3. The compound of the formula (VII-2) is more preferably any one of the compounds represented by the following formulae (VII-2-1) to (VII-2-16).

TABLE 38

| | |
|---|---|
| VII-2-1 | (MeO)₃Si—(CH₂)₂—Si(OMe)₃ |
| VII-2-2 | (MeO)₂MeSi—(CH₂)₂—SiMe(OMe)₂ |
| VII-2-3 | (MeO)₂MeSi—(CH₂)₆—SiMe(OMe)₂ |
| VII-2-4 | (MeO)₃Si—(CH₂)₆—Si(OMe)₃ |
| VII-2-5 | (EtO)₃Si—(CH₂)₆—Si(OEt)₃ |
| VII-2-6 | (MeO)₂MeSi—(CH₂)₁₀—SiMe(OMe)₂ |
| VII-2-7 | (MeO)₃Si—(CH₂)₃—NH—(CH₂)₃—Si(OMe)₃ |
| VII-2-8 | (MeO)₃Si—(CH₂)₃—NH—(CH₂)₂—NH—(CH₂)₃—Si(OMe)₃ |
| VII-2-9 | 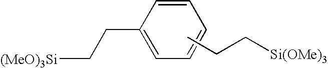 |
| VII-2-10 | 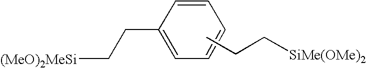 |
| VII-2-11 | 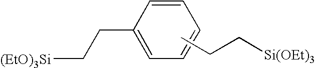 |
| VII-2-12 | 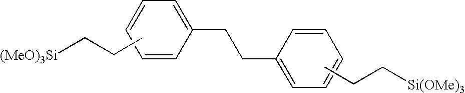 |
| VII-2-13 | 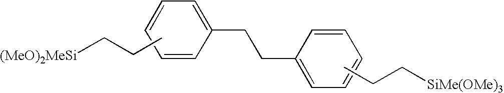 |
| VII-2-14 | 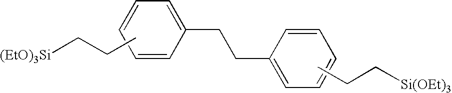 |
| VII-2-15 | (MeO)₃SiC₃H₆—O—CH₂CH[—O—C₃H₆Si(OMe)₃]—CH₂[—O—C₃H₆Si(OMe)₃] |
| VII-2-16 | (MeO)₃SiC₂H₄—SiMe₂—O—SiMe₂—O—SiMe₂—C₂H₄Si(OMe)₃ |

The protective layer 7 may further comprise cyclic compounds containing structural repeat unit represented by the following formula (VII-3) for the purpose of pot-life extension, control of film characteristic, torque reduction, enhancement of surface evenness, etc.

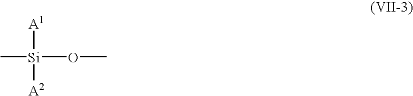

Wherein A¹ and A² of the formula (VII-3) each independently represents a monovalent organic group.

The cyclic compound having the structural repeat unit of the formula (VII-3) includes commercial cyclic siloxane, more particularly, the cyclic siloxane compound including cyclic dimethylcyclosiloxanes such as hexamethylcyclotrisiloxane, octamethylcyclotetrasiloxane, decamethylcyclopentasiloxane, and dodecamethylcyclohexasiloxane; cyclic methylphenylcyclosiloxanes such as 1,3,5-trimethyl-1,3,5-triphenylcyclotrisiloxane, 1,3,5,7-tetramethyl-1,3,5,7-tetraphenylcyclotetrasiloxane, and 1,3,5,7,9-pentamethyl-1,3,5,7,9-pentaphenylcyclopentasilox ane; cyclic phenylcyclosiloxanes such as hexaphenylcyclotrisiloxane; fluorine-containing cyclosiloxanes such as 3-(3,3,3-trifluoropropyl)methylcyclotrisiloxane; hydrosilyl group-containing cyclosiloxanes such as methylhydrosiloxane mixture, pentamethylcyclopentasiloxane, and phenylhydrodyclosiloxane; vinyl group-containing cyclosiloxanes such as pentavinylpentamethylcyclopentasiloxane. Such compound can be used singly or in combination of two or more of them.

Moreover, in order to control contaminant adhesion-resistance, lubrication, hardness of surface of the elecro-photographic photoreceptor, various microfine particles may be added singly or in combination of two or more types thereof.

The microfine, particle is exemplified by silicon containing microfine particle which unit microfine particle including silicon as a constituent element. More particularly, it comprises colloidal silica and microfine silicon particle. The colloidal silica includes commercially available product selected from, for example, acidic or alkali aqueous dispersion or solution dispersed in organic solvent such as alcohol, ketone or ester, and has preferably average particle diameter of 1 to 100 nm and, more preferably 10 to 30 nm. Solid content of the colloidal silica among the protective layer 7 is not particularly limited but is preferably ranged of 0.1 to 50% by weight and, more preferably 0.1 to 30% by weight based on total solid content of the protective layer 7 in view of film formation, electrical properties, and intensity.

The microfine silicon particle used as a silicon atom-containing microfine particle is spherical and has average particle diameter ranged from 1 to 500 nm and, more preferably 10 to 1±0.0 nm. The microfine silicon particle includes commercially available product selected from silicone resin particle, silicone rubber particle and surface-silicon treated silica particle.

The microfine silicon particle is chemically inactivated and has small diameter superior to dispersion in the resin. Since amount of the particle required for expressing sufficient characteristic is lowered, it can improve surface property and condition of the electrophotographic photoreceptor without inhibition of cross-linking reaction. That is, in a condition of the microfine particle evenly distributed among a rigid cross-linked structure, it can continuously retain favorable abrasion-resistance and contaminant adhesion-resistance over long time by enhancing lubrication or water repellency of surface of the electrophotographic photoreceptor. Amount of the microfine silicon particle in the protective layer 7 is preferably in the range of from 0.1 to 30% by weight and, more preferably 0.5 to 10% by weight based on the total amount of the solid content of the protective layer 7.

Other than the above particles, further included are fluorine based microfine particle such as ethylene tetrafluoride, ethylene trifluoride, propylene hexafluoride, vinyl fluoride, and vinylidene fluoride; microfine particles comprising copolymer resin of fluorine resin and monomer having hydroxyl group reported in “p89 in announcement of 8th polymer material forum lecture”; semiconductive metal oxide such as: ZnO—Al₂O₃, SnO₂—Sb₂O₃, In₂O₃—SnO₂, ZnO—TiO₂, MgO—Al₂O₃, FeO—TiO₂, TiO₂, SnO₂, In₂O₃, ZnO, and MgO. In addition, oils such as silicon oil can be added for the same purpose.

The silicon oil includes, for example, silicon oil such as dimethylpolysiloxane, diphenylpolysiloxane, and phenylmethylsiloxane; and reactive silicon oil such as amino-modified polysiloxane, epoxy-modified polysiloxane, carboxyl-modified polysiloxane, carbinol-modified ppolysiloxane, methacryl-modified polysiloxane, mercapto-modified polysiloxane, and phenol-modified polysiloxane. Such silicon oil may be added previously into the coating solution to form the protective layer or be subjected to precipitation treatment under vacuum pressure or compression pressure, after preparation of the photoreceptor.

Further, other additives such as plasticizer, surface modifier, antioxidant, and photodegradation resistant agent can be employed in production of the protective layer. Such additives include, for example, biphenyl, biphenyl chloride, tert-phenyl, dibutyl phthalate, diethyleneglycol phthalate, dioctyl phthalate, triphenyl phosphate, methylnaphthalene, benzophenone, chlorinated paraffin, polypropylene, polystyrene, and/or other fluorine base hydrocarbons. The antioxidant having hindered phenol, hindered amine, thioether or phosphate moiety structure can be incorporated into the protective layer 7, it provides enhancement of potential stability and image quality.

The antioxidant mentioned above includes, for example, the hindered phenols such as “SUMILIZER BHT-R”, “SUMILIZER MDP-S”, “SUMILIZER BBM-S”, “SUMILIZER WX-R”, “SUMILIZER NW”, “SUMILIZER BP-76”, “SUMILIZER BP-101”, “SUMILIZER GA-80”, “SUMILIZER GM”, “SUMILIZER GS” (all produced by SUMITOMO Chemical Co., Ltd.), “IRGANOX 1010”, “IRGANOX 1035”, “IRGANOX 1076”, “IRGANOX 1098”, “IRGANOX 1135”, “IRGANOX 1141”, “IRGANOX 1222”, “IRGANOX 1330”, “IRGANOX 1425WL”, “IRGANOX 1520L”, “IRGANOX 245”, “IRGANbX 259”, “IRGANOX 3114”, “IRGANOX 3790”, “IRGANOX 5057”, “IRGANOX 565” (all produced by Chiba Speciality Chemicals Co., Ltd.), “ADECASTAB AO-20”, “ADECASTAB AO-0.30”, “ADECASTAB AO-40”, “ADECASTAB AO-50”, “ADECASTAB AO-60”, “ADECASTAB AO-70”, “ADECASTAB AO-80”, “ADECASTAB AO-330” (all produced by ASAHI DENKA Co., Ltd.); hindered amines such as “SANOL LS2626”, “SANOL LS765”, “SANOL LS770”, “SANOL LS744”, “TINUBIN 144”, “TINUBIN 622LD”, “MARK LA57”, “MARK LA67”, “MARK LA62”, “MARK LA68”, “MARK LA63”, “SUMILIZER TPS”; thioether based inhibitor such as “SUMILIZER TP-D”; phosphate based inhibitor such as “MARK 112”, “MARK PEP•8”, “MARK PEP•24G”, “MARK PEP•36”, “MARK 329K”, “MARK HP•10”, with the hindered phenol and the hindered amine antioxidants being particularly preferable. The above compounds may be further modified using a substituent such as alkoxysillyl group capable of cross-linking with materials to form a cross-linked film.

In the protective layer 7 may further include insulation resins, for example, polybinyl butyral resin, polyarylate resin (such as copolymer of bisphenol A and phthalic acid), polycarbonate resin, polyester resin, phenoxy resin, vinyl chloride-vinyl acetate copolymer, polyamide resin, acrylic resin, polyacrylamide resin, polyvinyl pyridine resin, cellulose resin, urethane resin, epoxy resin, casein, polyvinyl alcohol resin, polyvinylpyrrolidone resin. Such insulation resin can be added in desirable amount to control adhesiveness of the protective layer to the charge transport layer 6, or to inhibit defects of coating film due to thermal contraction or elasticity.

The protective layer 7 is formed by applying the coating solution containing the above components useful for formation of the protective layer over the charge transport layer 6 then curing the obtained layer assembly.

The production of the above protective layer 7 using the charge transport material described above preferably comprises using a catalyst in preparation of the coating solution to form the protective layer. Such catalyst includes, for example, inorganic acid such as hydrochloric acid, acetic acid, phosphoric acid, and sulfuric acid; organic acid such as formic acid, propionic acid, oxalic acid, p-toluenesulfonic acid, benzoic acid, phthalic acid, and maleic acid; alkali catalyst such as potassium hydroxide, sodium hydroxide, ammonia, and triethylamine; and further, solid catalyst insoluble to this system.

In order to remove the catalyst added in synthesis from a phenol derivative having methylol group, a phenol derivative is dissolved in a proper solvent such as methanol, ethanol, toluene, and ethyl acetate then washed using water, or is preferably subjected to any suitable treatment such as re-precipitation using poor solvent, ion-exchange resin, and/or inorganic solid.

The ion-exchange resin includes, for example, AMBERLITE 15, AMBERLITE 200C, AMBERLITE 15E (all produced by Rohm and Haas Co., Ltd.); Dow X MWC-1-H, Dow X 88, Dow X HCR-WR (all produced by Dow Chemical Co., Ltd.); Lewatit SPC 108, Lewatit SPC 118 (all produced by Bayer Co., Ltd.); DIAION RCP-150h (produced by Mitsubishi Chemical Corporation); Sumika Ion KC-470, DUOLITE C26-C, DUOLITE C-433, DUOLITE C-464 (all produced by Sumitomo Chemical Engineering Co., Ltd.); cation ion-exchange resin such as Nafion H (produced by DuPont Co., Ltd.); and anion ion-exchange resin such as AMBERLITE IRA-400 and AMBERLITE IRA-45 (all produced by Rohm and Hass Co., Ltd.).

The inorganic solid includes, for example, inorganic solid having a surface to which are bonded groups containing a proton acid group such as Zr(O₃PCH₂CH₂SO₃H)₂ and Th(O₃PCH₂CH₂COOH)₂; heteropolyacids such as polyorganosiloxane containing proton acid groups such as polyorganosiloxane having a sulfonic acid group, cobalt tungstic acid and phosphorus molybdic acid; isopolyacids such as niobic acid, tantalic acid, and molybdic acid; metal oxides of mono-element type such as silica gel, alumina, chromia, zirconia, CaO and MgO; composite metal oxides such as silica-alumina, silica-magnesia, silica-zirconia, and zeolite; clay minerals such as acid clay, activated clay, montmorillonite and kaolinite; metal sulfates such as LiSO₄ and MgSO₄; metal phosphates such as zirconium phosphate and lanthanum phosphate; metal nitrates such as LiNO₃ and Mn(NO₃)O₂; inorganic solids having a surface to which are bonded groups containing amino groups, such as a solid obtained by allowing aminopropyltriethoxysilane to react on silica gel; and polyorganosiloxane containing amino groups such as an amino-modified silicone resin.

The coating solution to form the protective layer includes various solvents other than, for example, alcohols such as methanol, ethanol, propanol, and butanol; ketones such as acetone, methyl ethyl ketone; tetrahydrofuran; ethers such as diethylether, dioxane. Alternatively, in order to apply dip coating process typically used in production of the electrophotographic photoreceptor, preferably used are alcohol solvent, ketone solvent or a combination thereof. Boiling point of the used solvent is preferably in the range of from 50 to 150° C. and can be used in optional combination of two or more of them.

With respect of preferable solvents comprising alcohol solvent, ketone solvent or the combination thereof, the charge transport material used in formation of the protective layer 7 is preferably soluble in any of the above solvents.

Amount of the solvent used can be optionally set up as far as no precipitation of components occurred due to the solvent amount too small. More particularly, the solvent amount is preferably in the range of from 0.5 to 30 parts by weight and, more preferably 1 to 20 parts by weight based on total 1 part by weight of solid content in the coating solution to form the protective layer.

The method for coating the protective layer 7 using the coating solution to form the protective layer includes usual methods such as a blade coating method, a wire bar coating method, a spray coating method, a dip coating method, a bead coating method, an air knife coating method and a curtain coating method. In case where desired film thickness is not obtained by only one application of the coating solution, applying the coating solution several times to overlap one over another to produce the protective layer having preferable thickness. During the overlap-coating, it may additionally conduct heating in every time to apply the coating solution and/or after completing the application several times.

After the coating solution is applied over the charge transport layer 6, curing treatment is carried out. Typically, the curing treatment is preferably conducted at higher curing temperature and for longer curing time to accelerate cross-linking reaction of phenol derivate and to increase mechanical strength of the protective layer 7. However, in this case, an absorbance ratio (P₂/P₁) is easy to exceed 0.2 thus making electrical properties noticeably worse. Accordingly, it is preferable to control the curing treatment using the curing temperature, the curing time, the cross-linking atmosphere and the curing catalyst so that the protective layer 7 has IR spectrum satisfying the above condition.

Briefly, in order to ensure IR spectrum of the protective layer 7 to satisfy the conditions of the formula (I), the curing temperature at a curing treatment is preferably in the range of from 100 to 170° C., more preferably 100 to 150° C., and particularly 100 to 140° C. The curing time is preferably in the range of from 30 minutes to 2 hours and, more preferably 30 minutes to 1 hour.

The curing atmosphere for the curing treatment (cross-linking reaction) inorganic solid is preferably inert gas atmosphere such as nitrogen, helium, and argon gas to efficiently reduce the absorbance ratio (P₂/P₁). In case where the cross-linking reaction is conducted under the inert gas atmosphere, it can set up higher curing temperature preferably in the range of from 100 to 160° C. (more preferably 110 to 150° C.), compared to air atmosphere (oxygen containing atmosphere). Also, the curing time can be 30 minutes to 2 hours (more preferably 30 minutes to 1 hour). With respect of the compound of the formula (I), if a moiety represented by (—(X¹)ₘ₁—(R¹)ₘ₂—Y) is —CH₂—OH, it is preferable to perform the curing treatment in the above preferable range of temperature since the portion tends to show electrical properties being highly affected by the curing temperature and is sensitive to oxidation.

In case of forming the protective layer 7 with respect to the second electrophotographic photoreceptor according to the present invention, the curing temperature at a curing treatment is preferably in the range of from 100 to 170° C. and, more preferably 100 to 160° C. in view of sufficient cross-linking reaction. The curing time is preferably in the range of from 30 minutes to 2 hours and, more preferably 30 minutes to 1 hour. When the absorbance ratio (P₂/P₁) is 0.2 or less, the protective layer 7 obtained using the second electrophotographic photoreceptor of the present invention is preferably formed under the above conditions.

With respect of the formation of the protective layer 7 with respect to the second electrophotographic photoreceptor, the curing temperature for the cross-linking reaction under the inert gas atmosphere is set up higher than under the air atmosphere (oxygen containing atmosphere) and, is possibly ranged from 100 to 180° C. (preferably 110 to 160° C.). The curing time can be ranged from 30 minutes to 2 hours (preferably 30 minutes to 1 hour).

With respect of the formation of the protective layer 7 of the second electrophotographic photoreceptor, the coating solution forming the protective layer may be further added with epoxy compound such as polyglycidyl methacrylate, glycidyl bisphenols, and phenolepoxy resin; terephthalic acid; maleic acid; pyromellitic acid; biphenyl tetracarboxylic acid or anhydrides thereof, for the purpose of controlling film characteristics such as hardness, adhesiveness, activity. Amount to be added is preferably 0.05 to 1 parts by weight and, more preferably 0.1 to 0.7 parts by weight based on 1 part by weight of the charge transport material.

In the curing treatment, preferably added is curing catalyst. The curing catalyst includes photo-acid generator, for example, bissulfonyldiazomethanes such as bis(isopropylsulfonyl)diazomethane; bissulfonylmethanes such as methylsufonyl p-toluenesulfonylmethane; sulfonylcarbonyldiazomethanes such as cyclohexylsulfonylcyclohexylcarbonyldiazomethane; sulfonylcarbonyl alkanes such as 2-methyl-2-(4-methylphenylsulfonyl)propiophenone; nitrobenzyl sulfonates such as 2-nitrobenzyl p-toluenesulfonate; alkyl and arylsulfonates (g) such as pyrogallol trismethane sulfonate; benzoin sulfonates such as benzoin tosylate; N-sulfonyloxyimides such as N-(trisfluoromethylsulfonyloxy)phthaimide; pyridones such as (4-fluorobenzenesulfonyloxy)-3,4,6-trimethyl-2-pyridone; sulfonic esters such as 2,2,2-trifluoro-1-trifluoromethyl-1-(3-vinylphenyl)-ethyl-4-chlorobenzenesulfonate; onium salts such as triphenylsulfonium methanesulfonate and diphenyliodium trifluoromethanesulfonate. The curing catalyst may further include compound obtained by neutralization of protonic acid or Lewis acid with Lewis base, compound combination of Lewis acid and trialkyl phosphate, sulfonic esters, phosphoric esters, onium compound, carboxylic anhydride compound.

The compound having protonic acid or Lewis acid neutralized by Lewis base includes, for example, halogenocarboxylates, sulfonates, sulfate monoesters, phosphate mono- and diesters, polyphosphate esters, borate mono- and diester borates; compound neutralized using various amines such as ammonia, monoethyl amine, triethyl amine, pyridine, piperidine, aniline, morpholine, cyclohexyl amine, n-butyl amine, monoethanol amine, diethanol amine, triethanolamine or trialkyl phosphine, triaryl phosphine, trialkyl phosphate, triaryl phosphate; and commercially available products such as NACURE 2500X, 4167, X-47-110, 3525, 5225 (trade name, produced by KING Industries Co., Ltd.) as acid-base blocking catalyst. The compound having Lewis acid neutralized with Lewis base includes, for example, BF₃, FeCl₃, SnCl₄, AlCl₃, and ZnCl₂.

The onium compound includes, for example, triphenylsulfonium methanesulfonate, diphenyliodonium trifluoromethanesulfonate and the like.

The carboxylic anhydride compound includes, for example, acetic anhydride, propionic anhydride, butyric anhydride, isobutyric anhydride, lauryl anhydride, oleic anhydride, stearic anhydride, n-capronic anhydride, n-caprilic anhydride, n-capric anhydride, palmitic anhydride, myristic anhydride, trichloro acetic anhydride, dichloro acetic anhydride, monochloro acetic anhydride, trifluoro acetic anhydride, heptafluorobutyric anhydride.

The Lewis acid includes, for example, metal halides such as boron trifluoride, aluminum trichloride, titanous chloride, titanic chloride, ferrous chloride, ferric chloride, zinc chloride, zinc bromide, stannous chloride, stannic chloride, stannous bromide, and stannic bromide; organometallic compounds such as trialkylboron, trialkylaluminum, aluminum dialkyl halide, aluminum monoalkyl halide, tetraalkyltin; metal chelate compounds such as aluminum diisopropoxyethyl acetoacetate, aluminum tris(ethyl acetoacetate), aluminum tris(acetyl acetonate), titanium diisopropoxy-bis(ethyl acetoacetate), titanium diisopropoxy-bis(acetyl acetonate), zirconium tetrakis(n-propyl acetoacetate), zirconium tetrakis(acetyl acetonate), zirconium tetrakis(ethyl acetoacetate), tin dibutyl-bis(acetyl acetonate), iron tris(acetyl acetonate), rhodium tris(acetyl acetonate), zinc bis(acetyl acetonate), and cobalt tris(acetyl acetonate); metallic soaps such as dibutyltin dilaurate, dioctyltin ester malate, magnesium naphthenate, calcium naphthenate, manganese naphthenate, iron naphthenate, cobalt naphthenate, copper naphthenate, zinc naphthenate, zirconium naphthenate, lead naphthenate, calcium octylate, manganese octylate, iron octylate, cobalt octylate, zinc octylate, zirconium octylate, tin octylate, lead octylate, zinc laurate, magnesium stearate, aluminum stearate, calcium stearate, cobalt stearate, zinc stearate, and lead stearate. Such compounds can be singly or in combination of two or more of them.

The usage of these curing catalysts is not particularly restricted, but corresponding to 100% by weight of the sum of the solid content containing the protective layer formation coating solution, the 0.1 to 20% by weight is preferable, and 0.3 to 10% by weight is more preferable.

In addition, while the protective layer 7 is formed, when the organic metal compound is used as a catalyst, a polydentate ligand is preferably added with regard to pot life and curing efficiency. As the polydentate ligand like this, those described below and the derivative thereof may be used, but the polydentate ligand is not limited hereto.

Specifically, there may be used β-diketone type such as acetylacetone, trifluoroacetylacetone, hexafluoroacetylacetone, and dipivaloyl methyl acetone; acetoacetic acid ester type such as acetoacetic acid methyl and ethyl acetoacetate; bipyridine and a derivative thereof; glycine and a derivative thereof; ethylene diamine and a derivative thereof; 8-oxyquinoline and a derivative thereof; salicylaldehyde and a derivative thereof; catechol and a derivative thereof; bidentate ligand such as 2-oxyazo compound; diethyl triamine and a derivative thereof; tridentate ligand such as nitrilotriacetic acid and a derivative thereof; and hexadentate ligand such as ethylenediaminetetraacetic acid (EDTA) and a derivative thereof. Further, in addition to the organic ligand described above, inorganic ligand pyrophosphoric acid, and triphosphoric acid may also be used. As the polydentate ligand, in particular, bidentate ligand is preferable, and more specifically, bidentate ligand represented by the following formula (VII-4) may be used.

In the following formula (VII-4), R³² and R³³ are each independently an alkyl group, an alkyl fluoride group having 1 to 10 carbon atoms or an alkoxy group having 1 to 10 carbon atoms.

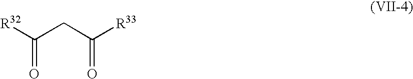

As the polydentate ligand, among those described above, bidentate ligand shown in the above formula (VII-4) is preferably used, and in the above formula (VII-4), in particular, R³² and R³³ are preferably the same. Since R³² and R³³ are the same, ligand force of the ligand is strong near at room temperature, and the protective layer formation coating solution can be further stabilized.

A blending quantity of the polydentate ligand may be optionally determined. However, for 1 mol of usage of the organic metal compound, the blending quantity is preferably 0.01 mol or more, more preferably 0.1 mol or more, and even more preferably 1 mol or more.

At 25° C., an oxygen permeability coefficient of the protective layer 7 is preferably 4×10¹² fm/s·Pa or less, more preferably 3.5×10¹² fm/s·Pa or less, and even more preferably, 3×10¹² fm/s·Pa or less.

Here, the oxygen permeability coefficient indicates how easy it is for an oxygen gas to transmit through, but from another point of view, a substitution characteristic of a physical gap ratio of the layer can be noted. In addition, when a gas type is changed, an absolute value of the transmission ratio is changed, but a relation of being larger and smaller between the examined layers is rarely inversed. Therefore, the oxygen permeability coefficient can be easily appreciated as a measure to represent how easy it is for a general gas to transmit.

Finally, when the oxygen permeability coefficient of the protective layer 7 at 25° C. satisfies the above conditions, it is difficult for the gas to penetrate into the protective layer 7. Therefore, the penetration of electric discharge product produced by the image forming process is suppressed, and the degradation of the compound contained in the protective layer 7 is suppressed. Thus, the high level electrical properties can be kept, and the high image quality and long lifetime can be effective.

In addition, when the protective layer 7 is formed to make an absorbance ratio (P₂/P₁) of an infrared absorption spectrum meet the above condition, it is necessary that a curing temperature is determined to be relatively low under the air atmosphere. For this reason, it is difficult to have a small oxygen permeability coefficient of the protective layer 7 at 25° C., but by allowing the absorbance ratio (P₂/P₁) to satisfy the above conditions and the oxygen permeability coefficient of the protective layer 7 at 25° C. to meet the above condition, the photoreceptor having the improved electrical properties as well as the high image quality can be obtained.

In addition, in case of the electrophotographic photoreceptor according to any one of the first and second aspects of the present invention, it can be determined that the protective layer 7 is a phenol derivative-containing layer described above, by using pyrolysis-gas chromatography/mass spectrometry. In other words, by performing pyrolysis on the protective layer 7, and performing gas chromatography/mass spectrometry on the resultant products, a fragment pattern belonging to a compound represented by the following formula (A) can be obtained.

In the formula (A), n represents an integer of 1 to 3.

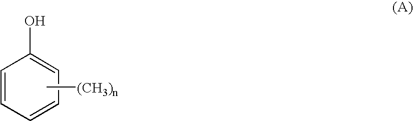

In addition, when the protective layer 7 further contains a siloxane based compound described above, at the time of the above pyrolysis-gas chromatography/mass spectrometry, a fragment pattern belonging to the compound represented by the following formula (B) can be obtained.

In the formula (B), R represents a hydrogen atom, an alkyl group having 1 to 6 carbon atoms, and a substituted or unsubstituted aryl group having 6 to 15 carbon atoms.

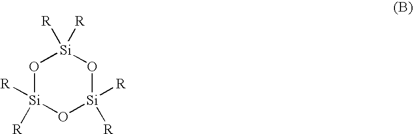

A thickness of the protective layer 7 is preferably 0.5 to 15 μm, more preferably 1 to 10 μm, and even more preferably 1 to 5 μm.

In addition, according to the present embodiment, a phenol derivative-containing layer of the present invention is the protective layer 7, and a phenol derivative-containing layer described above may be, for example, the charge transport layer 6 for the electrophotographic photoreceptor shown in FIG. 1.

In addition, when the single-layer type photoreceptor is formed, the single layer photosensitive layer comprises charge generation material and binder resin. As the charge generation material, a functionally separated photosensitive layer is used in a charge generation layer, and in the same manner, as the binder resin, the functionally separated photosensitive layer may be used in those similar with the binder resin for use in the charge generation layer and the charge transport layer. The layer containing the charge transport layer in the single-layer type photosensitive layer has preferably 10 to 85% by weight as a basis of the total amount of the solid content of the single-layer type photosensitive layer, and more preferably 20 to 50% by weight. The charge transport material and the polymer charge transport material may be added to the single-layer type photosensitive layer to enhance the photoelectric characteristic. The addition amount is preferably 5 to 50% by weight as a basis of the total amount of the solid content of the single layer photosensitive layer. In addition, solvent for use in coating and a coating method may use the respective layers described above and those similar thereto. A thickness of the single-layer type photosensitive layer is preferably 5 to 50 μm, and more preferably, 10 to 40 μm. In addition, the single-layer type photosensitive layer 8 for the electrophotographic photoreceptor 1 shown in FIG. 4 is a phenol derivative-containing layer for the electrophotographic photoreceptor according to the first and second embiments of the present invention, by selecting the element, in the same manner as the protective layer 7 of the electrophotography photosensitive layer 1 shown in FIG. 2, and it is arranged such that an absorbance ratio satisfies the specific conditions.

(Image Forming Apparatus and Process Cartridge)

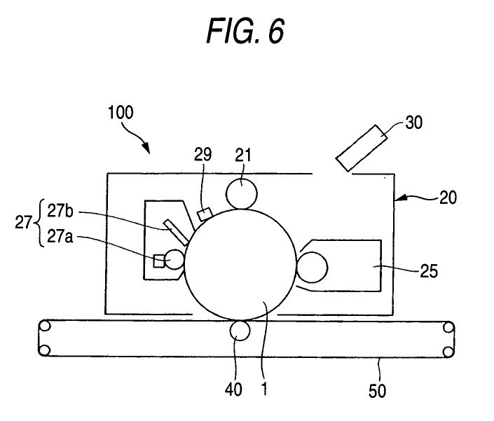

FIG. 6 is a schematic diagram showing an image forming apparatus according to an embodiment of the present invention. The image forming apparatus 100 shown in FIG. 6 comprises a process cartridge 20 including an electrophotographic photoreceptor 1 in the main unit of the image forming apparatus (not shown), an exposure unit 30, a transfer unit 40, and an intermediate transfer body 50. In addition, for the image forming apparatus 100, the exposure unit 30 is arranged to be exposable from an opening of the process cartridge 20 to the electrophotographic photoreceptor 1, and the transfer unit 40 is arranged to face the electrophotographic photoreceptor 1 through the intermediate transfer body 50, and the intermediate transfer body 50 is arranged to be contact with a portion of the electrophotographic photoreceptor 1.

The process cartridge 20 is integrated into a case by combining the electrophotographic photoreceptor 1 with a charging unit 21, a developing unit 25, a cleaning unit 27, and a fiber type member (toothbrush shape) 29 through a rail for attachment. In addition, in the case, the opening is arranged for exposure.

Here, the charging unit 21 is charged in a manner of contacting the electrophotographic photoreceptor 1. In addition, the developing unit 25 develops an electrostatic latent image on the electrophotographic photoreceptor 1 to form a toner image.

Hereinafter, a toner for use in the developing unit 25 will be described. As the toner described above, an average shape coefficient (ML²/A) is preferably 100 to 150, and more preferably, 100 to 140. In addition, for the toner, an average particle diameter is 2 to 12 μm, and more preferably, 3 to 12 μm, and even more preferably, 3 to 9 μm. With the fulfilled conditions of the average shape coefficient and the average particle diameter like this, an image with high-level developing, transferring, and high image quality can be obtained.

When the toner is in a range that satisfies the above conditions for the average shape coefficient and the average particle diameter, a fabrication method is not specifically limited, for example, there may be used a kneading and grinding method of adding the binder resin, a coloring agent and a mold releasing agent, and if needed, an electrical charging control agent to perform kneading, grinding, and classifying; a method of changing a shape of particle obtained the kneading and grinding method with a mechanical colliding force or a heat energy; an emulsion polymerization and agglomeration method of mixing, agglomerating, and fusing between dispersion provided by emulsion polymerizing a polymerizable monomer of the binder resin and dispersion such as the coloring agent, the mold releasing agent, and if needed, the electrical charging control agent to obtain a toner particle; a suspension polymerization method of suspension polymerizing the polymerizable monomer for obtaining the binder resin and the solution such as the coloring agent, the mold releasing agent, and if need, the electrical charging control agent into water solvent; and a melting suspension method of suspending and combining the binder resin and the solution such as the coloring agent, the mold releasing agent, and if needed, a solvent such as the electrical charging control agent into the water solvent.

In addition, there may be used a well-know method such as a method of fabricating a core shell arrangement by using the toner obtained from the above method as a core, to attach, heat, and fuse the agglomerated particle. Further, as a method of fabricating the toner, with respect to a shape control and a roughness distribution, a suspension polymerization method, an emulsion polymerization and agglomeration method, and a melting suspension method are preferably used in the water solvent, and the emulsion polymerization and agglomeration is particularly preferable.

Mother particles of the toner comprise the binder resin, the coloring agent and the mold releasing agent, and if needed, silica and the electrical charging control agent.

The binder resin used for mother particles contained in the toner includes, for example, styrenes such as styrene and chlorostyrene; monoolefins such as ethylene, propylene, butyrene, and isoprene; vinyl esters such as vinyl acetate, vinyl propionate, vinyl acetate, vinyl benzoate, and vinyl butyrate; α-methylene aliphatic monocarboxylates such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers such as vinylmethylether, vinyl ethyl ether, vinyl butyl ether; vinyl ketones such as vinyl methyl ketone, vinyl hexyl ketone, vinyl isoprophenyl ketone in homopolymer and copolymer forms, and polyester resins obtained by copolymerization of dicarboxylates and diols.

In particular, representative binder resins are polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene, and polyester resin. Furthermore, the resins include polyurethane, epoxy resin, silicone resin, polyamide, modified rosin, and paraffin wax.

The coloring agent is representatively exemplified by magnetic component such as magnetite or ferrite, carbon black, aniline blue, Chalcoil Blue, Chromium yellow, ultramarine blue, DuPont oil red, quinoline yellow, methylene blue chloride, phthalocyanine blue, malachite green oxalate, lamp black, rose Bengal, C.I. pigment-red 48:1, C.I. pigment-red 122, C.I. pigment-red 57:1, C.I. pigment-yellow 97, C.I. pigment-yellow 17, C.I. pigment-blue 15:1, C.I. pigment-blue 15:3.

The releasing agent is representatively exemplified by low molecular polyethylene, low molecular polypropylene, Fisher-Tropsch composite wax, montan wax, canubawax, rice wax, and Candela wax.

The anti-static agent includes conventional products and, in particular, azo based metal complex, salicylic metal complex, and/or resin type anti-static agent containing polar group. In case where the toner is prepared using wet-type process, preferably used are water-insoluble materials in view of controlling ionic intensity and reducing water contamination. Also, the toner may be preferably any one among magnetic toner containing magnetic materials and non-magnetic toner without the magnetic materials.

The toner used in the developing unit 25 can be manufactured by admixing the above toner mother particles and the external additives through Henschel mixer or V blender. During preparing the toner crude particles in the wet-type process, the additive can be added.

The toner used in the developing unit 25 can further include solid lubricant such as activated particles which are exemplified by graphite, molybdenum 2-sulfide, talc, fatty acid, metallic salt of fatty acid; low molecular polyolefin such as polypropylene, polyethylene, and polybutene; silicones having softening point at heating; aliphatic amides such as oleic amide, erucic amide, amide ricinolate, and amide stearate; vegetable wax such as carnauba wax, rice wax, candela wax, Japanese wax, montan wax, and hohoba oil; animal wax such as beeswax; mineral, petroleum wax such as montan wax, ozokerite, ceresin, paraffin wax, microcrystalline wax, and Fischer-Tropsch wax; and modifications thereof. Such additives can be singly or in combination of two or more of them. Average particle diameter is preferably in the range of from 0.1 to 10 μm and can be obtained by breaking materials having the above chemical structure. Amount of the above additive is preferably in the range of from 0.05 to 2.0% by weight and, more preferably, 0.1 to 1.5% by weight.

The toner used in the developing unit 25 can further include inorganic microfine particles, organic microfine particles and composite particles thereof obtained by adhering the inorganic microfine particles over the organic microfine particles.

The inorganic microfine particles includes particularly various preferable inorganic oxides, nitrides and/or borides, for example, silica, alumina, titanium dioxide, zirconium oxide, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, and boron nitride.

The inorganic microfine particles can be treated using various coupling agents, for example, titanium coupling agent such as tetrabutyl titanate, tetraocyl titanate, isopropyltriisostearoyl titanate, isopropyltridecylbenzene sulfonyl titanate, bis(dioctylpyrophosphate)oxyacetate titanate; and silane coupling agent such as γ-(2-aminoethyl) aminopropyltrimethoxysilane, γ-(2-aminoethyl)aminopropylmethyldimethoxysilane, γ-methacryloxypropyltrimethoxysilane, N-β-(N-vinylbenzylaminoethyl) γ-aminopropyltrimethoxysilane hydrochlorides, hexamethyldisilazane, methylttimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, and p-methylphenyltrimethoxysilane. In addition, metallic salts of higher fatty acid such as silicon oil, aluminum stearate, and zinc stearate, calcium stearate can be preferably used in hydrophobic treatment of the inorganic microfine particles.

As the organic particles, styrene resin particles, styrene acrylic resin particles, polyester resin particles, urethane resin particlse may be used.

With regard to a diameter of the particle, the average diameter of the particle is preferably 5 nm to 1000 nm, and more preferably, 5 nm to 800 nm even more preferably, 5 nm to 700 nm. When the average diameter of the particle is lower than the lower limit of the above condition, the abrasion problem occurs, on the other hand, when larger than the upper limit, the defects may easily formed on the surface of the electrophotographic photosensitive surface. In addition, a sum of additional amount of the afore-mentioned particles and the slippery particles is preferably 0.6% by weight or more.

For other inorganic oxides added to the toner, it is desirable that a small-sized inorganic oxide having the first diameter of 40 nm or less for the powder fluidity and electrical charging control, and a large-sized inorganic oxide is added for the adhesives reduction and the electrical chagrining control. These inorganic oxide particles may use well-known material, but it is preferable to be used along silica and titanium oxide to perform the fine electrical charging control. In addition, for the small-sized inorganic particles, through surface processing the dispersion is high and the powder fluidity can be significantly increased. Furthermore, carbonate such as magnesium carbonate and inorganic mineral such as a hydrotalcite are preferably added to remove the discharging refined products.

In addition, the electrophotography color toner mixes and uses the carrier, and as a carrier, Fe, glass bead, ferrite power, nickel power and a coating thereof may be used. In addition, a mixture composition of the carrier may be predetermined.

The cleaning unit 27 includes a fiber type member (roll shape) 27a and a cleaning plate 27b.

While the cleaning unit 27 has the fiber type member 27a and the cleaning plate 27b, the cleaning unit may comprise either one of them. As the fiber type member 27a, the roll shape may be other toothbrush type. In addition, the fiber type member 27a may be fixed to the main unit of the cleaning unit, rotatably supported, and supported capable of oscillating in direction of an axis of the photoreceptor. As the fiber type member 27a, there may be used a fabric type made of ultra fine fibers such as polyester, nylon, acryl, and a toresy (manufactured by Toray Industries, Inc.), a brush type hair implanted to a substrate type or a rug type using resin fiber such as nylon, acryl, polyolefin, polyester. When the conductivity is given, a resistance value of a single fiber element is preferably 10² to 10⁹ Ω. In addition, the thickness of the fiber in the fiber type member 27a is preferably 30 d (denier) or less, more preferably, 20 d or less, and a density of the fiber is preferably 20,000 vol./inch² or more, and more preferably, 30,000 vol./inch² or more.

The cleaning unit 27 is allowed to remove attachments (e.g., electric discharge product) from the surface of the photoreceptor, by using the cleaning plate and cleaning brush. To achieve this object for a long time as well as stabilize the function of the cleaning member, the cleaning member is preferably provided with a lubricant (lubricating element) such as metallic soap, high-level alcohol, wax, and silicon oil.

For example, when the fiber type member 27a uses those having a roll type, the lubricant such as metallic soap and wax is contacted, and the lubricating element is preferably provided on the surface of the electrophotographic photoreceptor. As the cleaning plate 27b, a typical rubber plate is used. When the rubber plate is used as the cleaning plate 27b, providing the lubricating element to the surface of the electrophotographic photoreceptor is particularly effective to suppress the grinding and the defect of the plate.

The process cartridge 20 is detachable from the main unit of the image forming apparatus, and the process cartridge along with the main unit of the image forming apparatus constitutes the image forming apparatus.

As the exposure unit 30, the charged electrophotographic photoreceptor 1 may be exposed to form an electrostatic latent image. In addition, as a light source of the exposure unit 30, a surface emissive laser is preferably used in a multi beam method.

As the transfer unit 40, the toner image on the electrophotographic photoreceptor 1 may be copied onto the medium to be transferred (intermediate transfer body 50), and for example, a typically used one in the roll type is used.

As the intermediate transfer body 50, a belt type (intermediate transfer belt) such as a semi conductive polyimide, polyamideimide, polycarbonate, polyarylene, polyester, and rubber is used. In addition, the shape of the intermediate transfer body 50 may be a drum type besides the belt type.

In addition, when the electrophotographic photoreceptor of the present invention is used, paper pieces and talc are generated from print papers, and these are easily attached to the electrophotographic photoreceptor. Further, the electrophotographic photoreceptor of the present invention has a high abrasive resistance, so that it is difficult to remove the paper pieces and talc. Therefore, to prevent the attachment of the paper pieces and talc and obtain the stabilized image, it is desirable to use the intermediate transfer body 50.

In addition, the medium to be transferred referred in the present invention is not particularly limited to the medium on which the toner image formed on the electrophotographic photoreceptor 1 is copied. For example, when transferring is performed directly from the electrophotographic photoreceptor 1 onto a paper, the paper is the medium to be transferred, and when transferring is performed using the intermediate transfer body 50, the intermediate transfer body is the medium to be transferred.

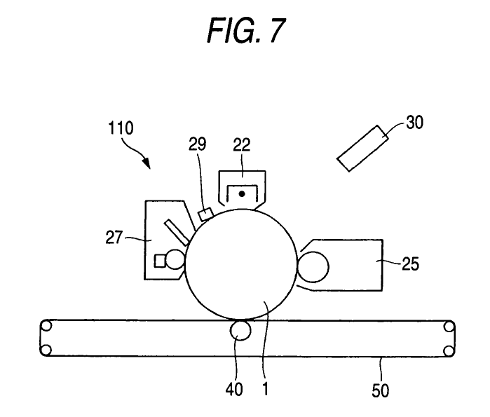

FIG. 7 is a schematic diagram showing an image forming apparatus according to another embodiment of the present invention. In the image forming apparatus 110 shown in FIG. 7, the electrophotographic photoreceptor 1 is fixed to the main unit of the image forming apparatus, and a charging unit 22, a developing unit 25, and a cleaning unit 27 are arranged in cartridges, respectively, and the electrical charging cartridge, the developing cartridge, the cleaning cartridge are respectively and independently arranged. Further, the charging unit 22 comprises a charging unit for charging in a corona discharging method.

For the image forming apparatus 110, the electrophotographic photoreceptor 1 and other devices are separated with each other, and the charging unit 22, the developing unit 25, and the cleaning unit 27 are not fixed to the main unit of the image forming apparatus by screwing, bonding and welding, but are removable through operation such as push and pull.

The electrophotographic photoreceptor of the present invention has an excellent abrasion resistance, so that a cartridge arrangement may not be required. Therefore, the charging unit 22, the developing unit 25, and the cleaning unit 27 are not fixed to the main unit of the image forming apparatus by screwing, bonding and welding, but are removable through operation such as push and pull. Thus, a manufacturing cost per one print can be reduced. In addition, by arranging more than two of these devices in a removable one-body cartridge, the manufacturing cost of the member per one print can be further reduced.

In addition, the image forming apparatus 110 has the same arrangement as the image forming apparatus 100, except that the charging unit 22, the developing unit 25 and the cleaning unit 27 are respectively arranged in the cartridges.

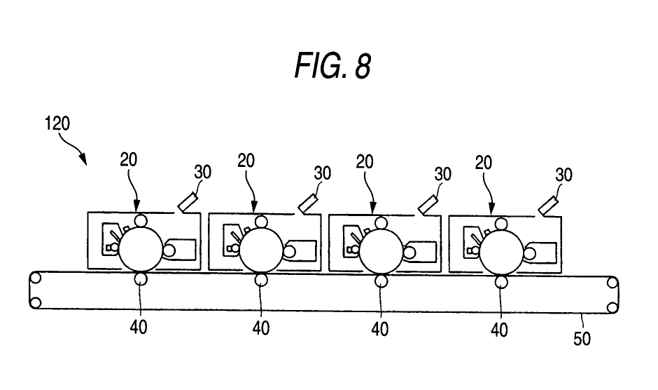

FIG. 8 is a schematic diagram showing an image forming apparatus according another embodiment of the present invention. An image forming apparatus 120 is a full color image forming apparatus in tandem, in which four process cartridges 20 are mounted. In the image forming apparatus 120, four process cartridges 20 are respectively arranged on an intermediate transfer body 50 in parallel, and one electrophotographic photoreceptor is used for one color. In addition, the image forming apparatus 120 has the same arrangement as the image forming apparatus 100, except for the tandem method.

In the tandem type image forming apparatus 120, according to a proportion of the respective color, grinding quantities of the respective electrophotographic photoreceptors are different so that the electrophotographic photoreceptors tend to have different electrical properties. With this, a toner developing characteristic is gradually changed from the initial state to change hue of the print image, and a stabilized image can be obtained. In particular, to have a small image forming apparatus, the electrophotographic photoreceptor having a small diameter is preferably used, and more specifically, in 30 mmΦ or less. Here, the electrophotographic photoreceptor uses a construction of the electrophotographic photoreceptor of the present invention, and with the diameter of 30 mmΦ or less, the surface grinding can be sufficiently prevented. Therefore, the electrophotographic photoreceptor of the present invention is particularly effective for the tandem type image forming apparatus.

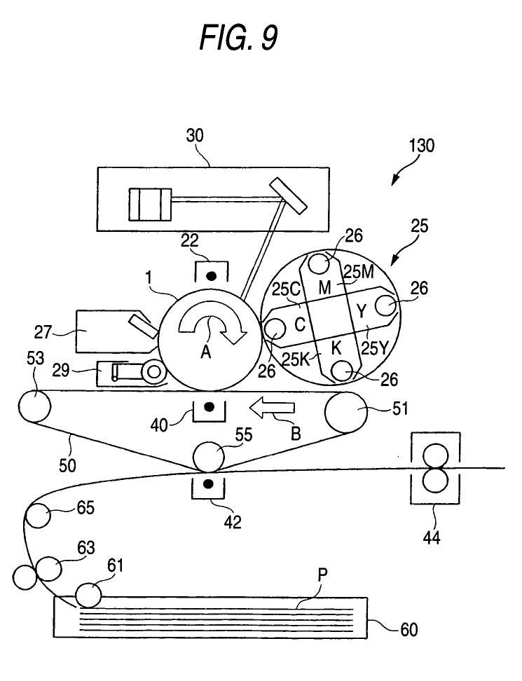

FIG. 9 is a schematic diagram showing an image forming apparatus according to another embodiment of the present invention. An image forming apparatus 130 shown in FIG. 9 provides a toner image having a plurality of colors with one electrophotographic photoreceptor, which is a so-called four cycle type image forming apparatus. The image forming apparatus 130 comprises a photosensitive drum 1 rotated in a direction of arrow A in FIG. 9 at a predetermined rotational speed by a driving device (not shown), and a charging unit 22 that electrically charges an outer circumference of the photosensitive drum 1 is arranged on the photosensitive drum 1.

In addition, the exposure unit 30 is arranged on the charging unit 22 as a surface light source laser array. The exposure unit 30 demodulates a plurality of laser beam emitted from the light source corresponding to the images to be formed, deflects in the main scanning direction, and scans the outer circumference of the photosensitive drum 1 in parallel with the axis line of the photosensitive drum 1. With this, the electrostatic latent image is formed on the outer circumference of the charged photosensitive drum 1.

The developing unit 25 is arranged on the side edge of the photosensitive drum 1. The developing unit 25 comprises a roller type receptor that is rotatably arranged. In the receptor, 4 receptive units are provided and each receptive unit comprises developing tools 25Y, 25M, 25C, and 25K. The developing tools 25Y, 25M, 25C, and 25K comprises the respective rollers 26, and retain the Y, M, C, and K colored toners therein.

Forming full color images with the image forming apparatus 130 is conducted while the photosensitive drum 1 rotates four times. In other words, while the photosensitive drum 1 rotates four times, the charging unit 22 electrically charges the outer circumference of the photosensitive drum 1, and the exposure unit 20 scans laser beams modulated corresponding to any of Y, M, C, and K image data for displaying an image having a color to be formed, on the outer circumference of the photosensitive drum 1 such that image data used for modulating the laser is repeatedly switched each time the photosensitive drum 1 rotates once. Further, with any developing roller 26 of the developing tools 25Y, 25M, 25C, and 25K arranged corresponding to the outer circumference of the photosensitive drum 1, the developing unit 25 operates the developing tool corresponding to the outer circumference to develop the electrostatic latent image formed on the outer circumference of the photosensitive drum 1 in the specific color, and forms the toner image having the specific color on the outer circumference of the photosensitive drum 1 such that the receptor is repeatedly rotated to switch the developing tool used for developing the electrostatic latent image each time the photosensitive drum 1 rotates once. With this, such that the toner images having Y, M, C, and K are sequentially formed overlapped with each other, each time the photosensitive drum 1 rotates once, on the outer circumference of the photosensitive drum 1, and at the time the photosensitive drum 1 rotates four times, the full color toner images are provided on the outer circumference of the photosensitive drum 1.

In addition, an intermediate transfer belt 50 is arranged in the approximately lower direction of the photosensitive drum 1. The intermediate transfer belt 50 may use rollers 51, 53, and 55, such that the outer circumference thereof is arranged to contact with the outer circumference of the photosensitive drum 1. The rollers 51, 53, and 55 transfer a driving force of the motor (not shown) and rotate, and thus, rotate the intermediate transfer belt 50 in the direction of the arrow B of FIG. 1.

The transfer unit (transfer unit) 40 is arranged on the opposite side of the photosensitive drum 1 through the intermediate transfer belt 50, and the toner image formed on the outer circumference of the photosensitive drum 1 is copied onto the image forming surface of the intermediate transfer belt 50 by unit of the transfer unit 40.

In addition, a lubricant supply device 29 and the cleaning unit 27 are arranged on the opposite side of developing unit 25 through the photosensitive drum 1. When the toner image formed on the outer circumference of the photosensitive drum 12 is copied onto the intermediate transfer belt 50, the lubricant is provided to the outer circumference of the photosensitive drum 1 by the lubricant supply device 29, and a region for supporting the transferred toner image in the given outer circumference is purified by the cleaning unit 27.

A tray 60 is arranged on the lower side of the intermediate transfer belt 50, and in the tray 60, many pieces of papers P as a recording medium are stacked and received. The roller 61 inclining to the left of the tray 60 and extracting in the upper direction are arranged, and roller pair 63 and a roller 65 are sequentially arranged on the lower flowing side of the extracting direction of the papers P by the extracting roller 61. In the stacking state, a record paper placed on the top is extracted from the tray 60 such that the extracting roller 61 is rotated, and the record paper is transported through roller pair 63 and the roller 65.

In addition, the transfer unit 42 is arranged on the opposite side of the roller 55 through the intermediate transfer belt 50. The paper P transported by roller pair 63 and the roller 65 is fed between the intermediate transfer belt 50 and the transfer unit 42, and the toner image formed on the image forming surface of the intermediate transfer belt 50 is transferred by the transfer unit 42. A fixing device 44 comprising the fixing roller pair is arranged on the lower flowing side in the transporting direction of the paper P by the transfer unit 42, and the paper P on which the toner image is copied is discharged out of the frame of the image forming apparatus 130 after the copied toner image is melted and fixed with the fixing device 44, and loaded on a discharging tray (not shown).

### EXAMPLES

Based on the Examples and Comparative Examples, the present invention will be described in detail, however the present invention is not limited hereto. In addition, in the following Examples, parts refer to parts by weight.

(Photoreceptor 1-a)

First, 30 mm diameter cylindrical aluminum substrate is prepared. The aluminum substrate is polished with a centerless grinding device, and a surface roughness is Rz=0.6 μm. To cleanse the aluminum substrate performed by the centerless grinding process, a grease removing process, an etching process for one minute in 2 wt % sodium hydroxide solution, a neutralizing process, and a pure water cleansing are sequentially performed. Next, an anode oxidation layer (current density of 1.0 A/dm²) is formed on the aluminum substrate in 10 wt % sulfuric acid solution. After water cleaning, a process of dipping into 1 wt % acetic acid nickel solution at 80° C. for 20 minutes and a sealing process are performed. The pure water cleansing and a drying process are further conducted. Accordingly, an aluminum substrate having 7 μm of anode oxidation layer formed on the surface is obtained.

From an X-ray diffraction spectrum, one part of chlorogallium phthalocyanine having a strong diffraction beam at a Bragg angle (2 θ±0.2°) 7.4°, 16.60, 25.50, and 28.30, one unit of polyvinylbutyral (S-LEC BM-S, manufactured by Sekisui Chemical Co., Ltd.), and 100 parts of n-butyl acetic acid are mixed, and dispersed using a glass bead as well as a paint shaker for one hour, to obtain the coating solution for forming charge generation layer. The coating solution is immersion coated on the obtained aluminum substrate, and is heated and dried for 10 minutes at 100° C. to form the charge generation layer having a thickness of about 0.15 μm.

2.5 parts of benzidine compound shown in the following formula (VIII-1), 3 parts of polymer compound (viscosity average molecular weight 39,000) having a structural unit shown in the following formula (VIII-2), and 20 parts of chlorobenzene are mixed and dissolved to obtain a coating solution for forming charge transport layer.

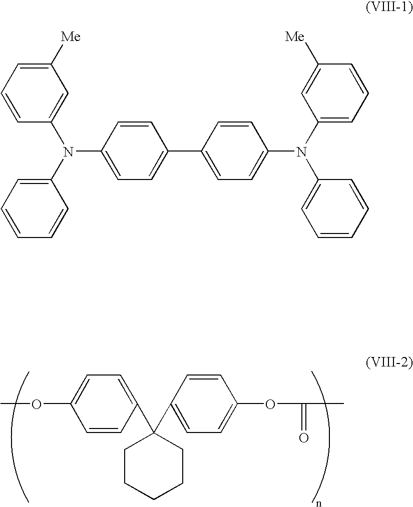

The coating solution is coated on the charge generation layer by a dip coating method, and is heated for 40 minutes at 110° C. to form the charge transport layer having a thickness of 20 μm. Accordingly, the photoreceptor having the charge generation layer and the charge transport layer, formed on the aluminum substrate having the anode oxidization layer is referred to as photoreceptor 1-a.

(Photoreceptor 1-b)

First, honing-processed 84 mm diameter of cylindrical aluminum substrate is prepared. Next, 100 parts of zirconium compound (trade name: Orgatics ZC540 manufactured by Matsumoto Pharmaceutical Co., Ltd.), 10 parts of silane compound (trade name: A1100, manufactured by Nippon Unicar Co., Ltd.), 400 parts of isopropanol, and 200 parts of butanol are mixed to obtain a coating solution for forming subbing layer. The coating solution is immersion coated on the aluminum substrate, and is heated and dried for 10 minutes at 150° C. to form the subbing layer having a thickness of 0.1 μm.

Next, from an X-ray diffraction spectrum, one part of hydroxygallium phthalocyanine having a strong diffraction beam at a Bragg angle (22 θ±0.2°) 7.5°, 9.9°, 12.5°, 16.3°, 18.6°, 25.1°, and 28.3°, one part of polyvinylbutyral (S-LEC BM-S, manufactured by Sekisui Chemical Co., Ltd.), and 100 parts of n-butyl acetate are mixed and dispersed by using a glass bead as well as a paint shaker for one hour, to obtain a coating solution for forming charge generation layer. The coating solution is immersion coated on the subbing layer, and is heated and dried for 10 minutes at 100° C. to form the charge generation layer having a thickness of about 0.15 μm.

Next, 2 units of charge transport material shown in the following formula (VIII-3), 3 parts of polymer compound (viscosity average molecular weight 50,000) having a structural unit shown in the above formula (VIII-2), and 20 parts of chlorobenzene are mixed to obtain a coating solution for forming charge transport layer.

The obtained coating solution for forming charge transport layer is coated on the charge generation layer by a dip coating method, and is heated for 40 minutes at 110° C. to form the charge transport layer having a thickness of 20 μm. Accordingly, the photoreceptor having the subbing layer, the charge generation layer, and the charge transport layer formed on the honing-processed aluminum substrate is referred to as photoreceptor 1-b.

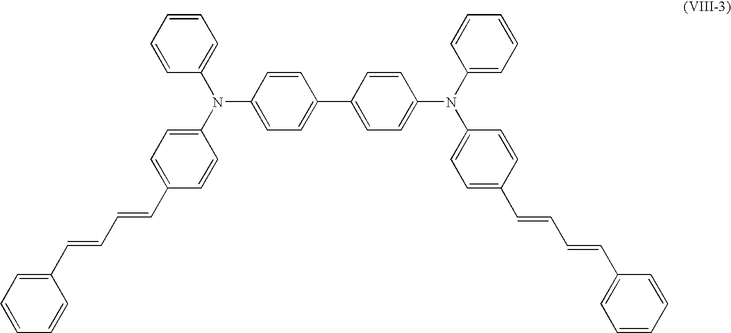

### Example 1-1

5 parts of the compound (I-1), 7 parts of resole type phenol resin (PL-4852, manufactured by Gun Ei Chemical Industry Co., Ltd.), 0.03 part of the dimethyl polysiloxane, 20 parts of isopropanol are mixed and dissolved to obtain a coating solution for forming protective layer. The coating solution is coated on the charge transport layer of the photoreceptor 1-a by using dip coating method, and is dried for 40 minutes at 130° C. to form the protective layer having a thickness of 3 μm. The obtained photoreceptor is referred to as PR-1-1. In addition, according to the present Example, in case the atmosphere at the time of drying is not specified, the process is conducted under the air atmosphere.

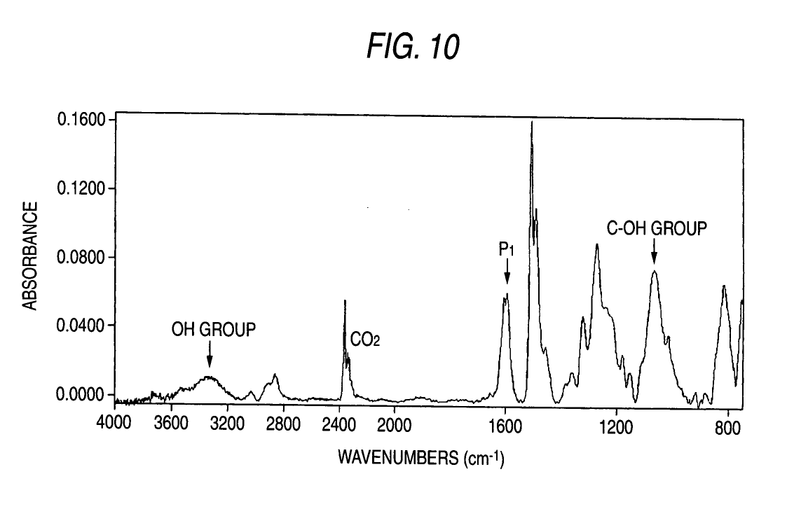

In addition, a portion of the protective layer of the obtained photoreceptor PR-1-1 is lifted off, and an infrared absorption (1R) spectrum is measured with an infrared spectrophotometer FT-730 (manufactured by Horiba, Ltd.), and an absorbance ratio (P₂/P₁) is calculated. The calculation of P₂/P₁ is 0.16. Furthermore, IR spectrum is shown in FIG. 10.

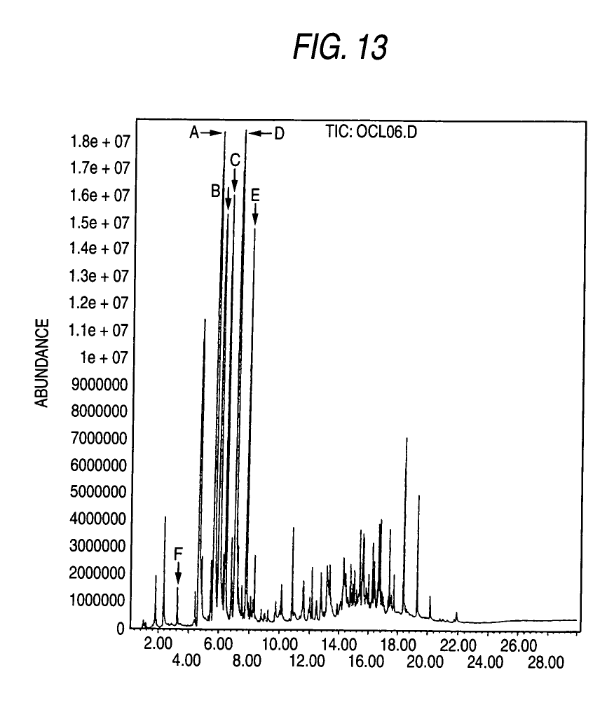

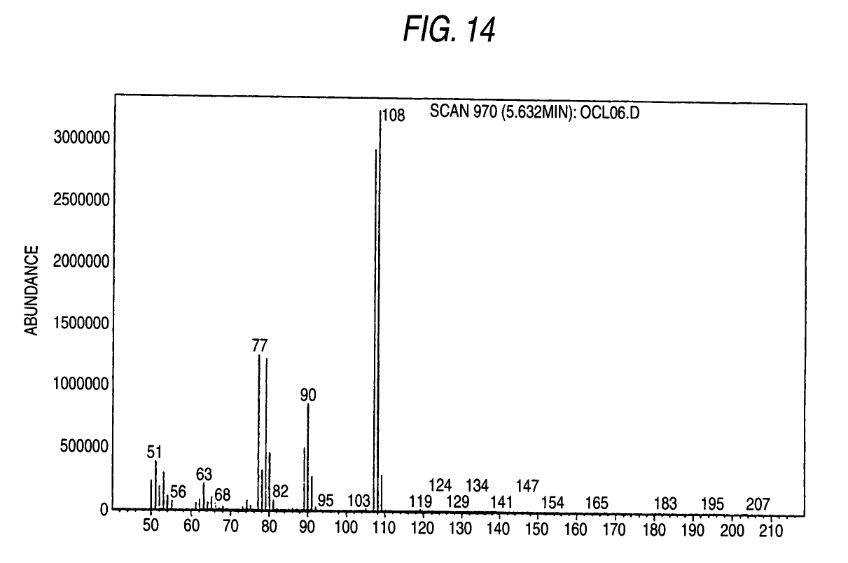

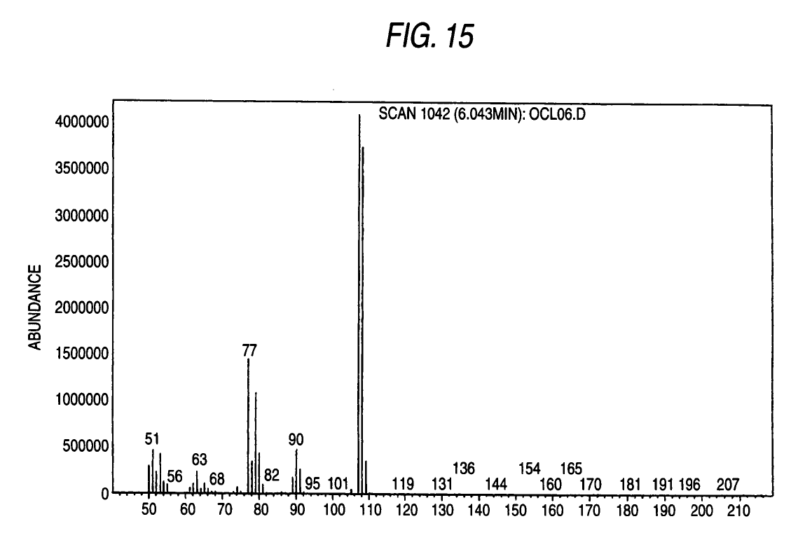

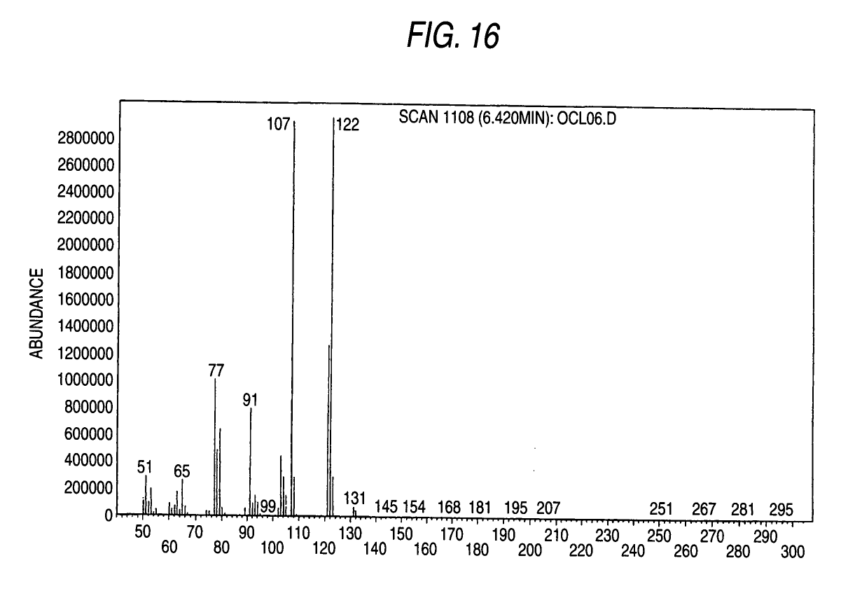

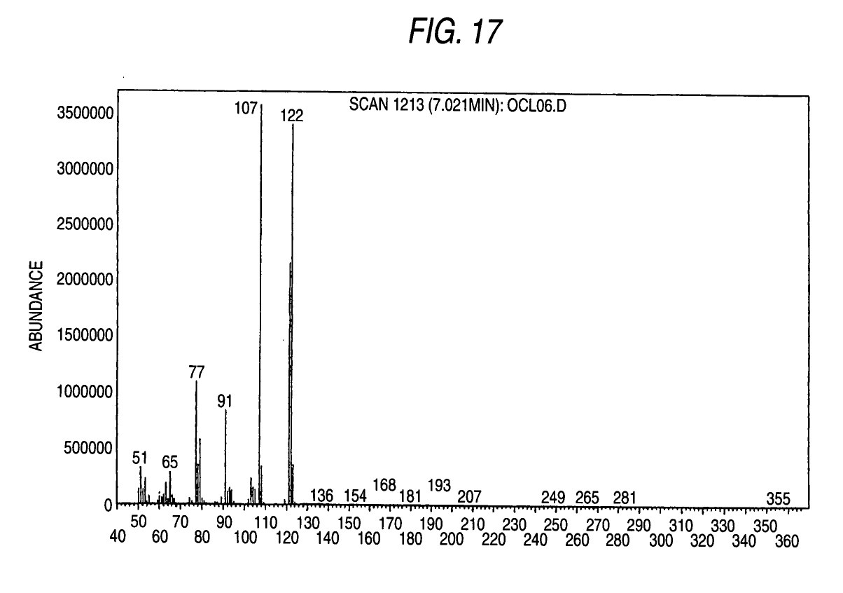

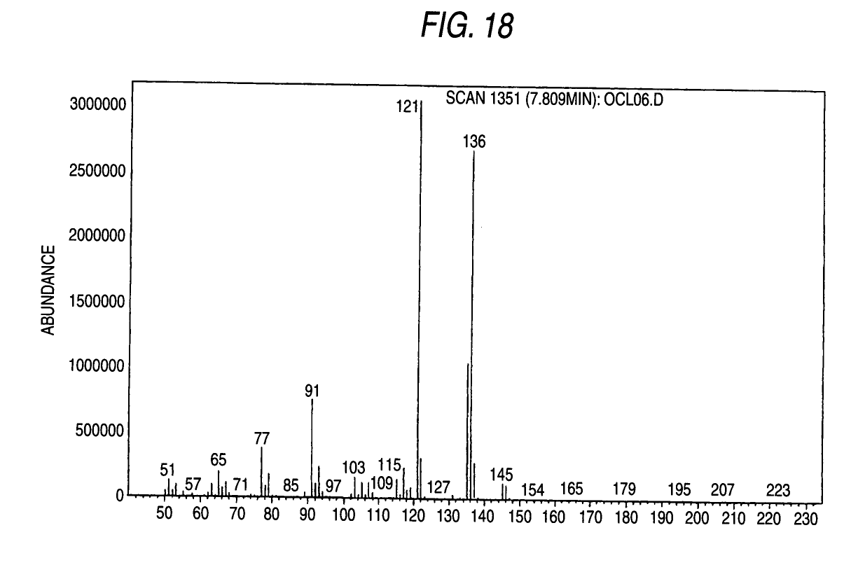

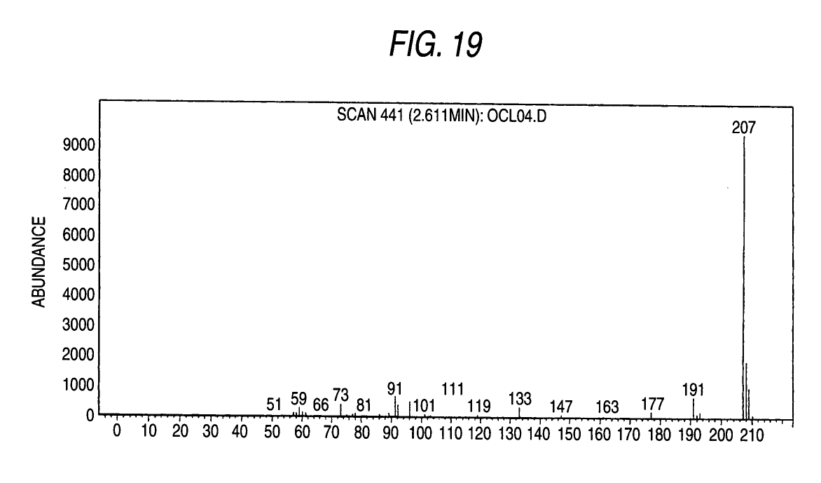

In addition, using a pyrolysis device (PY-2010D manufactured by Frontier Lab.), heat is applied for 1 minute at 600° C. The gas generated by the pyrolysis increased the temperature from 50° C. to 200° C. at the increasing rate of 10° C./min and kept the temperature at 200° C. for 5 minutes, using a gas chromatography/mass spectrometry device (HP6890/HP5973 manufactured by Hewlett Packard Co., Ltd.), a capillary column (HP-5MS: 5%-Diphenyl 95%-Dimethylpolysiloxane copolymer, thickness 0.25 μm, inner diameter 0.25 mm, and length 30 m), a carrier gas (He 1 ml/min). The gas chromatography of the gas generated by the pyrolysis is shown in FIG. 13. In addition, for each peak represented by A to F in FIG. 13, the mass spectrometry specs are shown in FIGS. 14 to 19, respectively.

### Example 1-2

Drying conditions for forming the protective layer of the Example 1-1 are provided in the same manner as in the Example 1-1, except for conditions for 1 hour at 150° C. and under the nitrogen atmosphere. The obtained photoreceptor is referred to as PR-1-2.

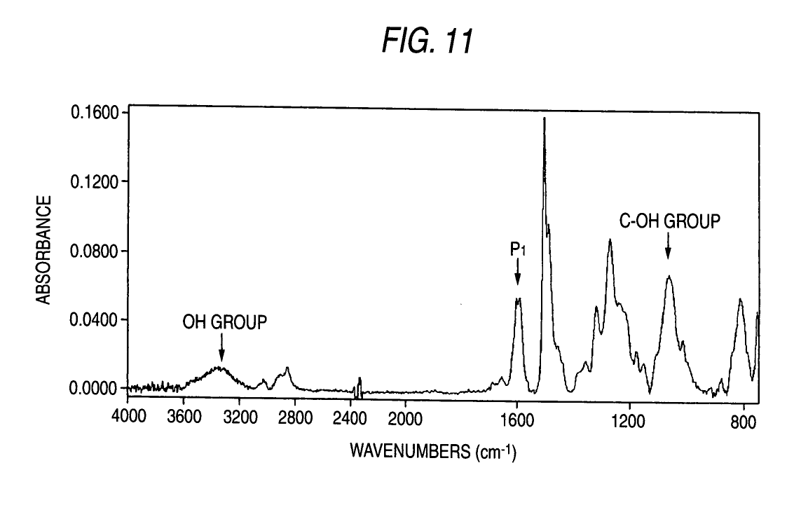

In addition, a portion of the protective layer of the obtained photoreceptor PR-1-2 is lifted off, and an infrared absorption (1R) spectrum is measured with an infrared spectrophotometer FT-730 (manufactured by Horiba, Ltd.), and an absorbance ratio (P₂/P₁) is calculated. The calculation of P₂/P₁ is 0. Further, IR spectrum is shown in FIG. 11.

### Example 1-3

Except for that 0.2 part of catalyst (NACURE 2500×, manufactured by Kusumoto chemicals Ltd.) is added to the coating solution for forming protective layer of the Example 1-1, the protective layer is formed as in the same manner with the Example 1-1. The obtained photoreceptor is referred to as PR-1-3.

### Comparative Example 1-1

Drying conditions for forming the protective layer of the Example 1-1 are provided in the same manner as in the Example 1-1, except for conditions for 2 hour at 130° C. The obtained photoreceptor is referred to as RPR-1-1.

### Comparative Example 1-2

Drying conditions for forming the protective layer of the Example 1-2 are provided in the same manner as in the Example 1-2, except for conditions for air atmosphere. The obtained photoreceptor is referred to as RPR-1-2.

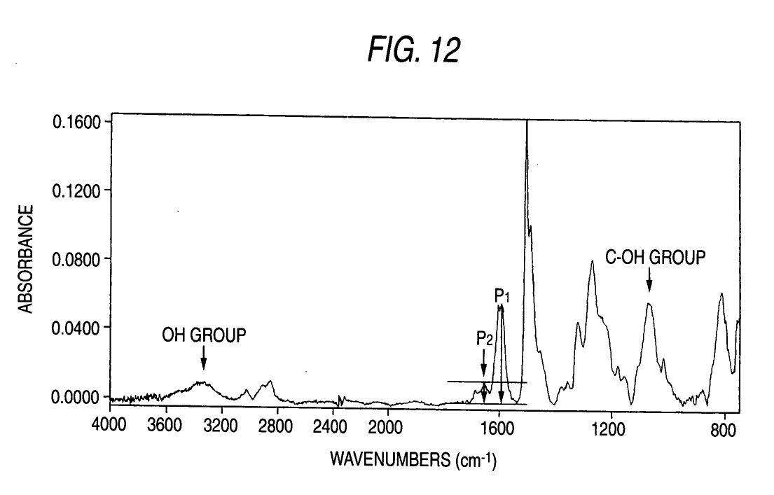

In addition, a portion of the protective layer of the obtained photoreceptor RPR-1-2 is lifted off, and an infrared absorption (1R) spectrum is measured with an infrared spectrophotometer FT-730 (manufactured by Horiba, Ltd.), and an absorbance ratio (P₂/P₁) is calculated. The calculation of P₂/Plis 0.21. Further, IR spectrum is shown in FIG. 12.

### Example 1-4

Conditions for forming protective layer in the Example 1-3 is provided in same manner, except that the compound (1-1) is replaced with compound (1-19) in forming the coating solution for forming protective layer. The obtained photoreceptor is referred to as PR-1-4.

### Example 1-5

Conditions for forming protective layer in the Example 1-3 is provided in same manner, except that the compound (1-1) is replaced with compound (IV-4) in forming the coating solution for forming protective layer. The obtained photoreceptor is referred to as PR-1-5.

### Example 1-6

5 parts of the compound (III-16), 15 parts of isopropyl alcohol, 9 parts of tetrahydrofuran, and 0.9 part of distilled water are mixed, and to the mixture is added 0.5 part of ion-exchange resin (Amberlist 15E: manufactured by Rohm and Hass Co., Ltd.). The mixture is hydrolyzed by stirring for 2 hours at room temperature. To the reactant are added 0.5 part of butyral resin, 5 parts of resole type phenol resin (PL-2211, manufactured by Gun Ei Chemical Industry Co., Ltd.), 0.2 part of light stabilizer (Sanol LS2626, manufactured by Sankyo Lifethec Co., Ltd.), and 0.5 part of catalyst (NACURE 4167, manufactured by Kusumoto chemicals Ltd.) to prepare the coating solution for forming protective layer. The coating solution for forming protective layer is coated on the photoreceptor 1-a by dip coating method, and is dried for 30 minutes at 130° C. to form the protective layer having a thickness of 3 μm. The obtained photoreceptor is referred to as PR-1-6.

### Comparative Example 1-3

Drying conditions for forming the protective layer of the Example 1-6 are provided in the same manner as in the Example 1-6, except for conditions for 1 hour at 170° C. The obtained photoreceptor is referred to as RPR-1-3.

### Example 1-7

To the coating solution for forming protective layer of the Example 1-1 is added 0.2 part of the fluoric corpuscle (Lubron L-2, manufactured by Daikin Industries, Ltd.), 0.2 part of catalyst (NACURE 2500×, manufactured by Kusumoto chemicals Ltd.), and 0.01 part of GF-300 (manufactured by Toagosei Co., Ltd.), 50 g of 1 mm diameter glass beads are further added to the mixture with media, and is dispersed using paint shaker for 1 hour to provide the coating solution for forming protective layer. Using the coating solution, the protective layer is formed as in the same manner with the Example 1-1. The obtained photoreceptor is referred to as PR-1-7.

### Examples (1-8) to (1-14)

The protective layer is formed in the same manner as the Examples (1-1) to (1-7), except that a photoreceptor 1-a is replaced with the photoreceptor 1-b. The obtained photoreceptors are referred to as (PR-1-8) to (PR-1-14).

### Comparative Examples (1-4) to (1 to 6)

The protective layer is formed in the same manner as the Comparative Examples (1-1) to (1-3), except that a photoreceptor 1-a is replaced with the photoreceptor 1-b. The obtained photoreceptors are referred to as (RPR-1-4) to (RPR-1-6).

(Developer (1-1))

First, a toner and a carrier are produced, and then, a developer (1-1) is produced using them. In the following description, the toner and a particle size distribution of the composite particles uses a Multisizer (manufactured by Nikkaki) to measure with an aperture diameter of 100 μm. In addition, an average shape coefficient ML²/A of the toner and the composite particles indicates a value calculated from the following formula, and for sphere, ML²/A is 100.
ML²/A=(maximum length)²×π×100/(area×4)

In addition, the average shape coefficient may be found by taking the toner image from an optical microscope and an image analysis device (LUZEX(III), manufactured by Nireco Co.), measuring a cylindrical diameter, and setting the maximum length and the area for the respective particles into the above formula.

(Toner)

When the toner is produced, resin corpuscle dispersion, the coloring agent and the mold releasing agent dispersion are prepared, and using these, toner mother particles are provided. Next, using these, the toner is produced.

(Resin Corpuscle Dispersion)

370 parts of styrene, 30 parts of n-butyl acrylate, 8 parts of acrylic acid, 24 parts of dodecanethiol, 4 parts of carbon tetrabromide are mixed and dissolved. The solution is added to the frasco containing 6 parts of nonionic surfactant (nonyl pole 400, manufactured by Sanyo Chemical Industries, Ltd.), 10 parts of anionic surfactant (neogen SC, manufactured by Dai-ichi Kogyo Seiyaku Co, Ltd.), and 550 parts of ion exchange water, and emulsion polymerized and gradually mixed for 10 minutes, while 50 parts of the ion exchange water into which 4 parts of ammonium persulfate is dissolved is poured. After performing nitrogen substitution, the frasco described above is stirred and heated in an oil bath until the contents therein becomes 70° C., and kept emulsion polymerization for 5 hours. As a result, the resin corpuscle dispersion could be obtained into which the resin particle with the average diameter of 150 nm, and Tg at 58° C., and weight average molecular weight (Mw) 11,500 is dispersed. The concentration of the solid content of the dispersion is 40% by weight.

(Coloring Agent Dispersion (1))

60 parts of carbon black (MOGAL L, manufactured by Cabot Co.), 6 parts of nonionic surfactant (NONYL POLE 400, manufactured by Sanyo Chemical Industries, Ltd.), and 240 parts of ion exchange water are mixed. The solution is stirred for 10 minutes with a homogenizer (Ultra Turrax T50, manufactured by IKA Co.), and after that, is dispersed with altimiser. Thereby, the coloring agent dispersion (1) into which the coloring agent (carbon black) particle having the average particle diameter of 250 nm, which is dispersed, can be obtained.

(Coloring Agent Dispersion (2))

60 parts of cyan pigment B15:3, 5 parts of nonionic surfactant (NONYL POLE 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (2) into which the coloring agent (cyan pigment) particle having the average particle diameter of 250 nm, which is dispersed, can be obtained.

(Coloring Agent Dispersion (3))

60 parts of magenta pigment R122, 5 parts of nonionic surfactant (NONYL POLE 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (3) into which the coloring agent (magenta pigment) particle having the average particle diameter of 250 nm, which is dispersed, can be obtained.

(Coloring agent dispersion (4))

90 parts of yellow pigment Y180, 5 parts of nonionic surfactant (nonyl pole 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (4) into which the coloring agent (yellow pigment) particle having the average particle diameter of 250 nm, which is dispersed, can be obtained.

(Mold Releasing Agent Dispersion)

100 parts of Paraffin Wax (HNP0190 manufactured by Nippon Seiro Co., Ltd, and having a melting point of 85° C.), 5 parts of cationic surfactant (SANISOL B50, manufactured by Kao Corporation), and 240 parts of ion exchange water are mixed. The solution is stirred for 10 minutes with the homogenizer (Ultra Turrax T50, manufactured by IKA Co.) in a round shape stainless steel frasco, and after that, is dispersed with a press ejection type homogenizer. Therefore, the mold releasing agent dispersion into which the mold releasing agent particle having the average particle diameter of 550 nm, which is dispersed, can be obtained.

(Toner Mother Particle K1)

234 parts of the resin corpuscle dispersion, 30 parts of the coloring agent dispersion (1), 40 parts of the mold releasing agent, 0.5 part of the aluminum polyhydroxide (PAHO2S, Asada Chemical Co., Ltd.), and 600 parts of ion exchange water are mixed. The solution are mixed with the homogenizer (Ultra Turrax T50, manufactured by IKA Co.) in a round shape stainless steel frasco, and are dispersed. After that, the solution in the frasco is stirred in the heating oil bath at 40° C. After remaining at 40° C. for 30 minutes, it is checked whether an agglomerated particle having D 50 of 4.5 μm is produced. In addition, the oil bath is heated to 56° C. and remained for one hour to have D 50 of 5.3 μm. Next, 26 parts by weight of the resin particle dispersion is added to the dispersion containing the agglomerated particle, and then, the oil bath is heated to 50° C. and remains for 30 minutes. 1N sodium hydroxide is added to the dispersion containing the agglomerated particle, and pH of the system is adjusted to be 7.0, and then, the stainless frasco is sealed, and heated to 80° C. while using the magnetic seal to keep agitation, and remained for 4 hours. After cooling, the toner mother particle is washed with an ion exchange water 4 times, and is freeze dried to obtain the toner mother particle K1. For the toner mother particle K1, D50 is 5.9 μm, and the average shape coefficient ML²/A is 132.

(Toner Mother Particle C1)

Except that coloring particle dispersion (2) is used instead of the coloring particle dispersion (1), the toner mother particle C1 is obtained in the same manner as in the toner mother particle K1. For the toner mother particle C1, D50 is 5.8 μm, and the average shape coefficient ML²/A is 131.

(Toner Mother Particle M1)

Except that coloring particle dispersion (3) is used instead of the coloring particle dispersion (1), the toner mother particle M1 is obtained in the same manner as in the toner mother particle K1. For the toner mother particle M1, D50 is 5.5 μm, and the average shape coefficient ML²/A is 135.

(Toner Mother Particle Y1)

Except that coloring particle dispersion (4) is used instead of the coloring particle dispersion (1), the toner mother particle Y1 is obtained in the same manner as in the toner mother particle K1. For the toner mother particle Y1, D50 is 5.9 μm, and the average shape coefficient ML²/A is 130. 100 parts of the respective toner mother particles K1, C1, M1, and Y1 described above, one part of rutile type titanium dioxide (diameter of 2 nm, n-decyltrimethoxysilane processing), 2.0 parts of silica (diameter of 40 nm, silicon oil processing, vapor phase oxidization), 1 part of ceric oxide (average particle diameter 0.7 μm), and jet milling with a weight proportion of 5:1 for higher fatty acid alcohol (higher fatty alcohol having molecular weight of 700) and zinc stearate, and 0.3 part of the average particle diameter of 8.0 μm are mixed. Further, the compound is printed with a peripheral velocity of 30 m/s by the 5L Henschel mixer for 15 minutes. Next, using an eye opening sieve of 45 μm, a particle having a large grain is removed to obtain the toner 1.

(Carrier)

100 parts of ferrite particles (average particle diameter of 50 μm), 14 parts of toluene, 2 parts of a styrene-methacrylate copolymer (component ratio: 90/10), and 0.2 part of carbon black (R330, manufactured by Cabot Co.) are prepared. First, the ferrite particles are removed and the element described above are mixed, and stirred for 10 minutes on a stirrer, and the dispersed coating solution is adjusted. Next, the coating solution and the ferrite particles are put into vacuum degassing type needar, and agitated for 30 minutes at 60° C. Subsequently, by applying heat and reducing pressure to degas, and by drying, the carrier is obtained. The carrier had a volume specific resistance value of 10¹¹ Ωcm when an electric field of 1000 V/cm is applied.

In addition, 100 parts of the carrier and 5 parts of the toner 1 are mixed, and stirred with a V-blender at 40 rpm for 20 minutes, and sieved with a sieve having an eye opening of 212 μm to obtain the developer (1-1).

(Developer (1-2))

(Toner mother particle K2)

234 parts of the resin corpuscle dispersion, 30 parts of the coloring agent dispersion (1), 40 parts of the mold releasing agent, 0.5 part of the aluminum polyhydroxide (Paho2S, Asada Chemical Co., Ltd.), and 600 parts of ion exchange water are mixed. The solution is mixed with the homogenizer (Ultra Turrax T50, manufactured by IKA Co.) in a round shape stainless steel frasco, and is dispersed. After that, the solution in the frasco is stirred in the oil bath at 40° C. After remaining at 40° C. for 30 minutes, it is checked whether an agglomerated particle having D 50 of 4.5 μm is produced. In addition, the oil bath is heated to 56° C. and remains for one hour to have D 50 of 5.3 μm. Next, 26 parts by weight of the resin particle dispersion is added to the dispersion containing the agglomerated particle, and then, the oil bath is heated to 50° C. and remained for 30 minutes. 1N Sodium hydroxide is added to the dispersion containing the agglomerated particle, and pH of the system is adjusted to be 5.0, and then, the stainless frasco is sealed, and heated to 95° C. while using the magnetic seal to keep agitation, and remained for 4 hours. After cooling, the toner mother particle is washed with an ion exchange water 4 times, and is freeze dried to obtain the toner mother particle K2, D50 is 5.8 μm, and the average shape coefficient ML²/A is 109.

(Toner Mother Particle C2)

Except that coloring particle dispersion (2) is used instead of the coloring particle dispersion (1), the toner mother particle C2 is obtained in the same manner as in the toner mother particle K2. For the toner mother particle C2, D50 is 5.7 μm, and the average shape coefficient ML²/A is 110.

(Toner Mother Particle M2)

Except that coloring particle dispersion (3) is used instead of the coloring particle dispersion (1), the toner mother particle M2 is obtained in the same manner as in the toner mother particle K2. For the toner mother particle M2, D50 is 5.6 μm, and the average shape coefficient ML²/A is 114.

(Toner Mother Particle Y2)

Except that coloring particle dispersion (4) is used instead of the coloring particle dispersion (1), the toner mother particle Y2 is obtained in the same manner as in the toner mother particle K2. For the toner mother particle Y2, D50 is 5.8 μm, and the average shape coefficient ML²/A is 108.

Except that K2, C2, M2, and Y2 are used as the toner mother particles and that the aluminum oxide (average particle diameter 0.1 μm) is used instead of one part of ceric oxide (average particle diameter 0.7 μm), the toner 2 can be obtained in the same manner as the toner 1, and using this, the developer (1-2) is able to be obtained in the same manner as the developer (1-1).

(Developer (1-3)

(Toner Mother Particle K3)

100 parts of the polyester resin (as a line type polyester obtained from terephthalic acid—bisphenol A ethylene oxide adduct—cyclohexanedimethanol, Tg: 62° C., Mn 12,000, Mv: 32,000), 4 parts of carbon black, and 5 parts of carnauba wax are mixed, and a compound is kneaded with an exteruder, and grinded with the jet mill. Next, the compounds are classified with a classifier in a wind force method, the average particle diameter is 5.9 μm, and the shape coefficient ML²/A is 145.

(Toner Mother Particle C3)

Except that cyan coloring agent (C. I. pigment blue 15: 3) is used instead of the carbon black, the toner mother particle C3 is obtained in the same manner as in the toner mother particle K3, with the average particle diameter is 5.6 μm, and the shape coefficient ML²/A is 141.

(Toner Mother Particle M3)

Except that magenta coloring agent (R122) is used instead of the carbon black, the toner mother particle M3 is obtained in the same manner as in the toner mother particle K3, with the average particle diameter is 5.9 μm, and the shape coefficient ML²/A is 149.

(Toner Mother Particle Y3)

Except that yellow coloring agent (Y180) is used instead of the carbon black, the toner mother particle Y3 is obtained in the same manner as in the toner mother particle K3, with the average particle diameter is 5.8 μm, and the shape coefficient ML²/A is 0.144.

Except that K3, C3, M3, and Y3 are used as the toner mother particles, the toner-3 can be obtained in the same manner as the toner 1, and using this, the developer (1-3) can be obtained in the same manner as the developer (1-1).

### Examples (1-15) to (1-24) and Comparative Examples (1-7) to (1-9)

Photoreceptors (PR-1-1) to (PR-1-7) and (RPR-1-1) to (RPR-1-3), and the developers (1-1) to (1-3) constitute image forming apparatus (DocuCentre Color 400CP, manufactured by Fuji Xerox Co., Ltd.), as shown in FIG. 39. In table 39, an absorbance ratio (P₂/P₁) for the protective layer of the photoreceptor, an oxygen permeability coefficient at 25° C. (X10¹¹ fm/s·Pa, and a surface potential(VL) are shown.

TABLE 39

| | | | | Oxygen | |
|---|---|---|---|---|---|
| | | De- | Absorbance | permeability | |
| | Photo- | vel- | ratio | coefficient | |
| | receptor | oper | (P₂/P₁) | (×10¹¹ fm/s · Pa) | VL |
| Example | PR-1-1 | 1-1 | 0.16 | 2.7 | −150 |
| 1-15 | | | | | |
| Example | PR-1-1 | 1-2 | 0.16 | 2.7 | −150 |
| 1-16 | | | | | |
| Example | PR-1-2 | 1-1 | 0 | 2.5 | −140 |
| 1-17 | | | | | |
| Example | PR-1-3 | 1-3 | 0.15 | 2.5 | −140 |
| 1-18 | | | | | |
| Example | PR-1-4 | 1-2 | 0.14 | 3.1 | −120 |
| 1-19 | | | | | |
| Example | PR-1-5 | 1-1 | 0.03 | 23 | −125 |
| 1-20 | | | | | |
| Example | PR-1-5 | 1-2 | 0.03 | 23 | −125 |
| 1-21 | | | | | |
| Example | PR-1-5 | 1-3 | 0.03 | 23 | −125 |
| 1-22 | | | | | |
| Example | PR-1-6 | 1-1 | 0.05 | 55 | −145 |
| 1-23 | | | | | |
| Example | PR-1-7 | 1-1 | 0.15 | 3.1 | −150 |
| 1-24 | | | | | |
| Comparative | RPR-1-1 | 1-1 | 0.22 | 2.6 | −210 |
| Example | | | | | |
| 1-7 | | | | | |
| Comparative | RPR-1-2 | 1-1 | 0.21 | 2.5 | −320 |
| Example | | | | | |
| 1-8 | | | | | |
| Comparative | RPR-1-3 | 1-1 | 0.22 | 48 | −140 |
| Example | | | | | |
| 1-9 | | | | | |

In addition, the protective layer of each photoreceptor is lifted off, and an IR spectrum is measured with an infrared spectrophotometer FT-730 (manufactured by Horiba, Ltd.) to find the absorbance ratio from the spectrum. Further, when the oxygen permeability coefficient is measured, the coating solution for forming protective layer used for forming the protective layer of each photoreceptor is coated on an aluminum plate, and dried under the same condition as that for the photoreceptor, to provide a sample having a thickness of 7 μm. Therefore, the oxygen permeability coefficient for the sample lifted from the aluminum plate at 25° C. is measured with a gas transmission ratio measuring device (MC-3 manufactured by Toyo Seiki Co., Ltd.). In addition, the surface potential (VL) is measured such that each photoreceptor is charged at −700 V under the constant temperature and humidity (20° C., 50% RH), flashed exposed with 780 nm and 5 mJ/m², and the surface potential (VL) is monitored after 50 msec.

(Image Forming Test)

By using the image forming apparatus of the Examples (1-15) to (1-24) and the Comparative Examples (1-7) to (1-9), the image forming test is conducted. In other words, first, under the circumstance of a low temperature and a low humidity (10° C., 20% RH), 10,000 pieces of the image forming test are conducted, and then, under the circumstance of a high temperature and a high humidity (28° C., 75% RH), 10,000 pieces of the image forming test are conducted. Next, the attachments on the photoreceptor, cleaning property, abrasive ratio, and image quality are estimated. The acquired results are shown in table 40.

TABLE 40

| | Deposits of | Cleaning | Abrasion rate | Image |
|---|---|---|---|---|
| | photoreceptor | property | (nm/Kcycle) | quality |
| Example 1-15 | A | A | 2.1 | A |
| Example 1-16 | A | A | 2.1 | A |
| Example 1-17 | A | A | 1.5 | A |
| Example 1-18 | A | A | 1.4 | A |
| Example 1-19 | A | A | 1.5 | A |
| Example 1-20 | A | A | 1.2 | A |
| Example 1-21 | A | A | 1.2 | A |
| Example 1-22 | A | A | 1.2 | A |
| Example 1-23 | A | A | 1.1 | A |
| Example 1-24 | A | A | 2.3 | A |
| Comparative | A | A | 1.7 | C1 |
| Example 1-7 | | | | |
| Comparative | A | A | 1.5 | C1 |
| Example 1-8 | | | | |
| Comparative | B | A | 1.5 | C2 |
| Example 1-9 | | | | |

In addition, in terms of the attachment, estimation is determined with a naked eye, as follows: A: no attachment, B: partial attachment (30% or less in total), and C: attached. In addition, in terms of the cleaning property, estimation is determined with a naked eye, as follows: A: good, B: partially image defected (10% or less in total), and C: generally image defected. In addition, in terms of the abrasive ratio, the abrasion amount of the photoreceptor is measured to calculate the abrasive ratio with 1000 rotations. In addition, in terms of the image quality, image quality of the print with a naked eye after printing 20,000 papers in total, the estimation is made as follows: A: good, Cl: slightly low image concentration, and C2: defect.

### Examples (0.1-25) to (1-35) and Comparative Examples (1-10) to (1-12))

Photoreceptors (PR-1-8) to (PR-1-14) and (RPR-1-4) to (RPR-1-6), and the developers (1-1) to (1-3) constitute image forming apparatus (DocuCentre Color 500, manufactured by Fuji Xerox Co., Ltd.), as shown in FIG. 41. As the image forming apparatus described above, a multi beam surface emissive laser having an oscillation wavelength of 780 nm is modified for use in the exposure unit. In table 41, the absorbance ratio (P₂/P₁) for the protective layer of the photoreceptor, an oxygen permeability coefficient at 25° C. (X10¹¹ fm/s·Pa, and a surface potential(VL) are shown.

TABLE 41

| | | | | Oxygen | |
|---|---|---|---|---|---|
| | | De- | Absorbance | permeability | |
| | Photo- | vel- | ratio | coefficient | |
| | receptor | oper | (P₂/P₁) | (×10¹¹ fm/s · Pa) | VL |
| Example | PR-1-8 | 1-1 | 0.16 | 2.7 | −90 |
| 1-25 | | | | | |
| Example | PR-1-9 | 1-1 | 0 | 2.5 | −85 |
| 1-26 | | | | | |
| Example | PR-1-9 | 1-2 | 0 | 2.5 | −85 |
| 1-27 | | | | | |
| Example | PR-1-9 | 1-3 | 0 | 2.5 | −85 |
| 1-28 | | | | | |
| Example | PR-1-10 | 1-2 | 0.15 | 2.5 | −80 |
| 1-29 | | | | | |
| Example | PR-1-11 | 1-1 | 0.14 | 3.1 | −75 |
| 1-30 | | | | | |
| Example | PR-1-11 | 1-2 | 0.14 | 3.1 | −75 |
| 1-31 | | | | | |
| Example | PR-1-12 | 1-2 | 0.03 | 23 | −80 |
| 1-32 | | | | | |
| Example | PR-1-13 | 1-1 | 0.05 | 55 | −90 |
| 1-33 | | | | | |
| Example | PR-1-13 | 1-3 | 0.05 | 55 | −90 |
| 1-34 | | | | | |
| Example | PR-1-14 | 1-2 | 0.15 | 3.1 | −90 |
| 1-35 | | | | | |
| Comparative | RPR-1-4 | 1-1 | 0.22 | 2.6 | −145 |
| Example | | | | | |
| 1-10 | | | | | |
| Comparative | RPR-1-5 | 1-1 | 0.21 | 2.5 | −260 |
| Example | | | | | |
| 1-11 | | | | | |
| Comparative | RPR-1-6 | 1-3 | 0.22 | 48 | −85 |
| Example | | | | | |
| 1-12 | | | | | |

(Image Forming Test)

By using the image forming apparatus of the Example's (1-25) to (1-35) and the Comparative Examples (1-10) to (1-12), the image forming test is conducted. In other words, first, under the circumstance of a low temperature and a low humidity (10° C., 20% RH), 10,000 pieces of the image forming test are conducted, and then, under the circumstance of a high temperature and a high humidity (28° C., 75% RH), 10,000 pieces of the image forming test are conducted. Next, the attachments on the photoreceptor, cleaning property, abrasive ratio, and image quality are estimated. The acquired results are shown in table 42.

TABLE 42

| | Deposits of | Cleaning | Abrasion rate | Image |
|---|---|---|---|---|
| | photoreceptor | property | (nm/Kcycle) | quality |
| Example 1-25 | A | A | 0.9 | A |
| Example 1-26 | A | A | 0.6 | A |
| Example 1-27 | A | A | 0.6 | A |
| Example 1-28 | A | A | 0.6 | A |
| Example 1-29 | A | A | 0.6 | A |
| Example 1-30 | A | A | 0.7 | A |
| Example 1-31 | A | A | 0.7 | A |
| Example 1-32 | A | A | 0.6 | A |
| Example 1-33 | A | A | 0.5 | A |
| Example 1-34 | A | A | 0.5 | A |
| Example 1-35 | A | A | 0.7 | A |
| Comparative | A | A | 0.6 | C1 |
| Example 1-10 | | | | |
| Comparative | A | A | 0.8 | C1 |
| Example 1-11 | | | | |
| Comparative | B | A | 0.7 | C2 |
| Example 1-12 | | | | |

As is understood from the tables 40 and 42, the electrophotographic photoreceptor of the present invention had a long term use and no remaining attachment, so that the high image quality and the long lifetime can be realized. In addition, the image forming apparatus and the process cartridge of the present invention can implement high image quality and the long lifetime products without incurring image defects even when it is used for a long time.

(Photoreceptor 2-a)

First, 30 mm diameter cylindrical aluminum substrate is prepared. The aluminum substrate is polished with a centerless grinding device, and a surface roughness is Rz=0.6 μm. To cleanse the aluminum substrate performed by the centerless grinding process, a grease removing process, an etching process for one minute in 2 wt % sodium hydroxide solution, a neutralizing process, and a pure water cleansing are sequentially performed. Next, an anode oxidation layer (current density of 1.0 A/dm²) is formed on the aluminum substrate in 10 wt % sulfuric acid solution. After water cleaning, a process of dipping into 1 wt % acetic acid nickel solution at 80° C. for 20 minutes and a sealing process are performed. The pure water cleansing and a drying process are further conducted. Accordingly, an aluminum substrate having 7 m of anode oxidation layer formed on the surface is obtained.

From an X-ray diffraction spectrum, one part of chlorogallium phthalocyanine having a strong diffraction beam at a Bragg angle (2 θ±0.2°) 7.4°, 16.6°, 25.50, and 28.3°, one unit of polyvinylbutyral (S-LEC BM-S, manufactured by Sekisui Chemical Co., Ltd.), and 100 units of n-butyl acetate are mixed, and dispersed using a glass bead as well as a paint shaker for one hour, to obtain the coating solution for forming charge generation layer. The coating solution is immersion coated on the obtained aluminum substrate, and is heated and dried for 10 minutes at 100° C. to form the charge generation layer having a thickness of about 0.15 μm.

2.5 parts of benzidine compound shown in the following formula (VIII-4), 3 parts of polymer compound (viscosity average molecular weight 39,000) having a structural unit shown in the following formula (VIII-2), and 20 parts of chlorobenzene are mixed and dissolved to obtain a coating solution for forming charge transport layer.

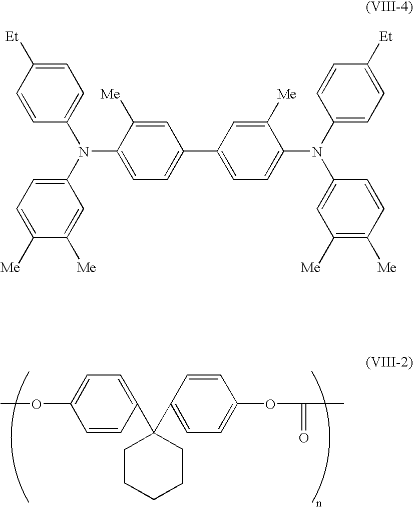

The coating solution is coated on the charge generation layer by a dip coating method, and is heated for 40 minutes at 110° C. to form the charge transport layer having a thickness of 20 μm. Accordingly, the photoreceptor having the charge generation layer and the charge transport layer, formed on the aluminum substrate having the anode oxidization layer is referred to as photoreceptor 2-a.

(Photoreceptor 2-b)

First, honing-processed 84 mmΦ of cylindrical aluminum substrate is prepared. Next, 100 parts of zirconium compound (trade name: Orgatics ZC540 manufactured by Matsumoto Pharmaceutical Co., Ltd.), 10 parts of silane compound (trade name: A1100, manufactured by Nippon Unicar Co., Ltd.), 400 parts of isopropanol, and 200 parts of butanol are mixed to obtain a coating solution for forming subbing layer. The coating solution is immersion coated on the aluminum substrate, and is heated and dried for 10 minutes at 150° C. to form the subbing layer having a thickness of 0.1 μm.

Next, from an X-ray diffraction spectrum, one unit of hydroxygallium phthalocyanine having a strong diffraction beam at a Bragg angle (22 θ±0.2°) 7.5°, 9.9°, 12.5°, 16.3°, 18.6°, 25.1°, and 28.3°, one unit of polyvinylbutyral (S-LEC BM-S, manufactured by Sekisui Chemical Co., Ltd.), and 100 parts of n-butyl acetate are mixed and dispersed by using a glass bead as well as a paint shaker for one hour, to obtain a coating solution for forming charge generation layer. The coating solution is immersion coated on the subbing layer, and is heated and dried for 10 minutes at 100° C. to form the charge generation layer having a thickness of about 0.15 μm.

Next, 3 parts of charge transport material shown in the following formula (VIII-3), 3 parts of polymer compound (viscosity average molecular weight 50,000) having a structural unit shown in the above formula (VIII-5), and 20 parts of chlorobenzene are mixed to obtain a coating solution for forming charge transport layer.

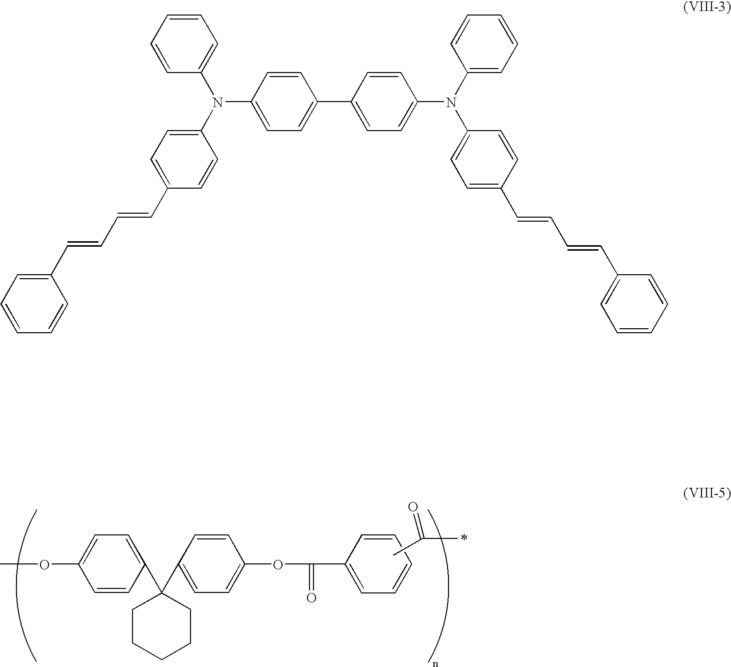

The obtained coating solution for forming charge transport layer is coated on the charge generation layer by a dip coating method, and is heated for 40 minutes at 110° C. to form the charge transport layer having a thickness of 20 μm. Accordingly, the photoreceptor having the subbing layer, the charge generation layer, and the charge transport layer formed on the honing-processed aluminum substrate is referred to as photoreceptor 2-b.

### Example 2-1

5.5 parts of the compound (IV-1), 7 parts of resole type phenol resin (PL-4852, manufactured by Gun Ei Chemical Industry Co., Ltd.), 0.03 part of the methylphenol polysiloxane, 20 parts of isopropanol are mixed and dissolved to obtain a coating solution for forming protective layer. The coating solution is coated on the charge transport layer of the photoreceptor 2-a by using dip coating method, and is dried for 40 minutes at 130° C. to form the protective layer having a thickness of 3 μm. The obtained photoreceptor is referred to as PR-2-1. In addition, according to the present Example, in case the atmosphere at the time of drying is not specified, the process is conducted under the air atmosphere.

### Example 2-2

Drying conditions for forming the protective layer of the Example 2-1 are provided in the same manner as in the Example 2-1, except for conditions for 1 hour at 150° C. and under the nitrogen atmosphere. The obtained photoreceptor is referred to as PR-2-2.

### Example 2-3

Except for that 0.2 part of catalyst (NACURE 2500X, manufactured by Kusumoto chemicals Ltd.) is added to the coating solution for forming protective layer of the Example 2-1, the protective layer is formed as in the same manner with the Example 2-1. The obtained photoreceptor is referred to as PR-2-3.

### Comparative Example 2-1

For coating solution for forming protective layer of the Example 2-1, the protective layer herein is formed in the same manner as in the Example 2-1, except that the following compound (VIII-6) is used instead of a compound (IV-1) as the charge transport material. The obtained photosensitivity member is referred to as RPR-2-1.

### Comparative Example 2-2

For coating solution for forming protective layer of the Example 2-1, the protective layer herein is formed in the same manner as in the Example 2-1, except that the drying condition when the protective layer is formed is under the nitrogen atmosphere at 150° C. for one hour, using the following compound (VIII-6) instead of a compound (IV-1) as the charge transport material. The obtained photosensitivity member is referred to as RPR-2-2.

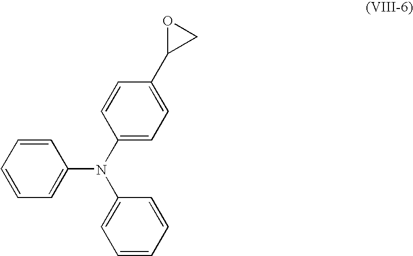

### Example 2-4

Conditions for forming protective layer in the Example 2-3 is provided in same manner, except that the compound (IV-1) is replaced with compound (IV-2) in forming the coating solution for forming protective layer. The obtained photoreceptor is referred to as PR-2-4.

### Example 2-5

Conditions for forming protective layer in the Example 2-3 is provided in same manner, except that the compound (IV-1) is replaced with compound (IV-19) in forming the coating solution for forming protective layer. The obtained photoreceptor is referred to as PR-2-5.

### Example 2-6

6 parts of the compound (IV-23), 7 parts of resole type phenol resin (PL-4852, manufactured by Gun Ei Chemical Industry Co., Ltd.), 0.5 part of butyral resin, 0.5 part of bisglycidyl bisphenol A, 0.5 part of biphenyl tetracarboxylic acid, 0.03 part of methylphenylpolysiloxane, 0.2 part of light stabilizer (Sanol LS2626, manufactured by Sankyo Lifethec Co., Ltd.), and 20 part of isopropanol are mixed and dissolved to obtain the coating solution for forming protective layer. The coating solution for forming protective layer is coated on the photoreceptor 2-a by a dip coating method, and dried for 40 minutes at 130° C. to form the protective layer having a thickness of 3 μm. The obtained photoreceptor is referred to as PR-2-6.

### Example 2-7

To the coating solution for forming protective layer of the Example 2-1 is added 0.2 part of the fluoric corpuscle (Lubron L-2, manufactured by Daikin Industries, Ltd.), and 0.01 part of GF-300 (manufactured by Toagosei Co., Ltd.). 50 g of 1 mmΦ glass beads are further added to the mixture with media, and is dispersed using paint shaker for 1 hour to provide the coating solution for forming protective layer. Using the coating solution, the protective layer is formed as in the same manner with the Example 1. The obtained photoreceptor is referred to as PR-2-7.

### Example 2-8

Except that the compound (IV-1) is replaced with a compound (IV-27), the protective layer herein is formed in the same manner as in the Example 2-3. The obtained photoreceptor is referred to as PR-2-8.

### Example 2-9

Except that the compound (IV-1) is replaced with a compound (IV-27), the protective layer herein is formed in the same manner as in the Example 2-3. The obtained photoreceptor is referred to as PR-2-9.

### Example 2-10

Except that the compound (IV-1) is replaced with a compound (IV-36), the protective layer herein is formed in the same manner as in the Example 2-3. The obtained photoreceptor is referred to as PR-2-10.

### Example 2-11

Except that the compound (IV-1) is replaced with a compound (IV-41), the protective layer herein is formed in the same manner as in the Example 2-3. The obtained photoreceptor is referred to as PR-2-11.

### Example 2-12

Except that 3 parts of the compound (IV-5) and 2.5 parts of the following compound (VIII-7) are used instead of 5.5 parts of the compound (IV-1), the protective layer herein is formed in the same manner as in the Example 2-1. The obtained photoreceptor is referred to as PR-2-23.

### Examples (2-13) to (2-24)

For the Examples (2-1) to (2-12), except that the photoreceptor 2-b is used instead of the photoreceptor 2-a, the protective layer herein is formed in the same manner as in the Examples (2-1) to (2-12). The obtained photosensitivity bodies are referred to (PR-2-13) to (PR-2-24), respectively.

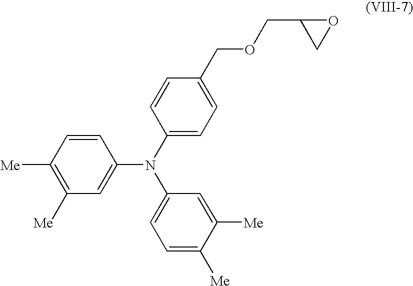

### Comparative Examples (2-3) to (2-4)

For the Comparative Examples (2-1) to (2-2), except that the photoreceptor 2-b is used instead of the photoreceptor 2-a, the protective layer herein is formed in the same manner as in the Comparative Examples (2-1) to (2-2). The obtained photosensitivity members are referred to (RPR-2-3) to (RPR-2-4), respectively.

(Developer (2-1))

First, a toner and a carrier is produced, and then, a developer (2-1) is produced using them. In the following description, the toner and a particle size distribution of the composite particles uses a Multisizer (manufactured by Nikkaki) to measure with an aperture diameter of 100 μm. In addition, an average shape coefficient ML²/A of the toner and the composite particles indicates a value calculated from the following formula, and for sphere, ML²/A is 100.
ML²/A=(maximum length)²×π×100/(area×4)

In addition, the average shape coefficient may be found by taking the toner image from an optical microscope and an image analysis apparatus (LUZEX (III), manufactured by Nireco Co.), measuring a cylindrical diameter, and setting the maximum length and the area for the respective particles into the above equation.

(Toner)

When the toner is produced, resin corpuscle dispersion, the coloring agent and the mold releasing agent dispersion are prepared, and using these, toner mother particles are provided. Next, using these, the toner is produced.

(Resin Corpuscle Dispersion)

370 parts of styrene, 30 parts of n-butyl acrylate, 8 parts of acrylic acid, 24 parts of dodecanethiol, 4 parts of carbon tetrabromide are mixed and dissolved. The solution is added to the frasco containing 6 parts of nonionic surfactant (NONYL POLE 400, manufactured by Sanyo Chemical Industries, Ltd.), 10 parts of anionic surfactant (NEOGEN SC, manufactured by Dai-ichi Kogyo Seiyaku Co, Ltd.), and 550 parts of ion exchange water, and emulsion polymerized and gradually mixed for 10 minutes, while 50 parts of the ion exchange water into which 4 parts of ammonium persulfate is dissolved is poured. After performing nitrogen substitution, the frasco described above is stirred and heated in an oil bath until the contents therein becomes 70° C., and kept emulsion polymerization for 5 hours. As a result, the resin corpuscle dispersion is able to be obtained into which the resin particle with the average diameter of 150 nm, and Tg at 58° C., and weight average molecular weight (Mw) 11,500 is dispersed. The concentration of the solid content of the dispersion is 40% by weight.

(Coloring Agent Dispersion (1))

60 parts of carbon black (MOGAL L, manufactured by Cabot Co.), 6 parts of nonionic surfactant (NONYL POLE 400, manufactured by Sanyo Chemical Industries, Ltd.), and 240 parts of ion exchange water are mixed. The solution is stirred for 10 minutes with a homogenizer (Ultra Turrax T50, manufactured by IKA Co.), and after that, is dispersed with altimiser. Thereby, the coloring agent dispersion (1) into which the coloring agent (carbon black) particle having the average particle diameter of 250 nm, which is dispersed, can be obtained.

(Coloring Agent Dispersion (2))

60 parts of cyan pigment B15:3, 5 parts of nonionic surfactant (nonyl pole 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (2) into which the coloring agent (cyan pigment) particle having the average particle diameter of 250 nm, which is dispersed, can be obtained.

(Coloring Agent Dispersion (3))

60 parts of magenta pigment R122, 5 parts of nonionic surfactant (NONYL POLE 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (3) into which the coloring agent (magenta pigment) particle having the average particle diameter of 250 nm, which is dispersed, can be obtained.

(Coloring Agent Dispersion (4))

90 parts of yellow pigment Y180, 5 parts of nonionic surfactant (nonyl pole 400: Sanyo Chemical Industries, Ltd.), and 240 parts of ion exchange water are mixed. The solution is stirred for 10 minutes with the homogenizer (Ultra Turrax T50, manufactured by IKA Co.), and after that, is dispersed with altimiser. Therefore, the coloring agent dispersion (4) into which the coloring agent (yellow pigment) particle having the average particle diameter of 250 nm, which is dispersed, can be obtained.

(Mold Releasing Agent Dispersion)

100 parts of Paraffin Wax (HNP0190 manufactured by Nippon Seiro Co., Ltd, and having a melting point of 85° C.), 5 parts of cationic surfactant (SANISOL B50, manufactured by Kao Corporation), and 240 parts of ion exchange water are mixed. The solution is stirred for 10 minutes with the homogenizer (Ultra Turrax T50, manufactured by IKA Co.) in a round shape stainless steel frasco, and after that, is dispersed with a press ejection type homogenizer. Therefore, the mold releasing agent dispersion into which the mold releasing agent particle having the average particle diameter of 550 nm, which is dispersed, can be obtained.

(Toner Mother Particle K1)

234 parts of the resin corpuscle dispersion, 30 parts of the coloring agent dispersion (1), 40 parts of the mold releasing agent, 0.5 part of aluminum polyhydroxide (Paho2S, manufactured by Asada Chemical Co., Ltd.), and 600 parts of ion exchange water are mixed. The solution are mixed with the homogenizer (Ultra Turrax T50, manufactured by IKA Co.) in a round shape stainless steel frasco, and are dispersed. After that, the solution in the frasco is stirred in the oil bath at 40° C. After remaining at 40° C. for 30 minutes, it is checked whether an agglomerated particle having D 50 of 4.5 μm is produced. In addition, the oil bath is heated to 56° C. and remained for one hour to have D 50 of 5.3 μm. Next, 26 parts by weight of the resin particle dispersion is added to the dispersion containing the agglomerated particle, and then, the oil bath is heated to 50° C. and remains for 30 minutes. 1N sodium hydroxide is added to the dispersion containing the agglomerated particle, and pH of the system is adjusted to be 7.0, and then, the stainless frasco is sealed, and heated to 80° C. while using the magnetic seal to keep agitation, and remained for 4 hours. After cooling, the toner mother particle is washed with an ion exchange water 4 times, and is freeze dried to obtain the toner mother particle K1. For the toner mother particle K1, D50 is 5.9 μm, and the average shape coefficient ML²/A is 132.

(Toner Mother Particle C1)

Except that coloring particle dispersion (2) is used instead of the coloring particle dispersion (1), the toner mother particle C1 is obtained in the same manner as in the toner mother particle K1. For the toner mother particle C1, D50 is 5.8 μm, and the average shape coefficient ML²/A is 131.

(Toner Mother Particle M1)

Except that coloring particle dispersion (3) is used instead of the coloring particle dispersion (1), the toner mother particle M1 is obtained in the same manner as in the toner mother particle K1. For the toner mother particle M1, D50 is 5.5 μm, and the average shape coefficient ML²/A is 135.

(Toner Mother Particle Y1)

Except that coloring particle dispersion (4) is used instead of the coloring particle dispersion (1), the toner mother particle Y1 is obtained in the same manner as in the toner mother particle K1. For the toner mother particle Y1, D50 is 5.9 μm, and the average shape coefficient ML²/A is 130. 100 parts of the respective toner mother particles K1, C1, M1, and Y1 described above, one part of rutile type titanium dioxide (diameter of 2 nm, n-decyltrimethoxysilane processing), 2.0 parts of silica (diameter of 40 nm, silicon oil processing, vapor phase oxidization), 1 part of ceric oxide (average particle diameter 0.7 μm), and jet milling with a weight proportion of 5:1 for higher fatty acid alcohol (higher fatty alcohol having molecular weight of 700) and zinc stearate, and 0.3 part of the average particle diameter of 8.0 μm are mixed. Further, the compound is printed with a peripheral velocity of 30 m/s by the 5L Henschel mixer for 15 minutes. Next, using an eye opening sieve of 45 am, a particle having a large grain is removed to obtain the toner 1.

(Carrier)

100 parts of ferrite particles (average particle diameter of 50 μm), 14 parts of toluene, 2 parts of a styrene-methacrylate copolymer (component ratio: 90/10), and 0.2 part of carbon black (R330, manufactured by Cabot Co.) are prepared. First, the ferrite particles are removed and the element described above are mixed, and stirred for 10 minutes on a stirrer, and the dispersed coating solution is adjusted. Next, the coating solution and the ferrite particles are put into vacuum degassing type needar, and agitated for 30 minutes at 60° C. Subsequently, by applying heat and reducing pressure to degas, and by drying, the carrier is obtained. The carrier had a volume specific resistance value of 1011 Ωcm when an electric field of 1000 V/cm is applied.

In addition, 100 parts of the carrier and 5 parts of the toner 1 are mixed, and stirred with a V-blender at 40 rpm for 20 minutes, and sieved with a sieve having an eye opening of 212 μm to obtain the developer (2-1).

(Developer (2-2))

(Toner mother particle K2)

234 parts of the resin corpuscle dispersion, 30 parts of the coloring agent dispersion (1), 40 parts of the mold releasing agent, 0.5 part of the aluminum polyhydroxide (Paho2S, Asada Chemical Co., Ltd.), and 600 parts of ion exchange water are mixed. The solution is mixed with the homogenizer (Ultra Turrax T50, manufactured by IKA Co.) in a round shape stainless steel frasco, and are dispersed. After that, the solution in the frasco is stirred in the heating oil bath at 40° C. After remaining at 40° C. for 30 minutes, it is checked whether an agglomerated particle having D 50 of 4;5 μm is produced. In addition, the oil bath is heated to 56° C. and remains for one hour to have D 50 of 5.3 μm. Next, 26 parts by weight of the resin particle dispersion is added to the dispersion containing the agglomerated particle, and then, the oil bath is heated to 50° C. and remained for 30 minutes. 1N sodium hydroxide is added to the dispersion containing the agglomerated particle, and pH of the system is adjusted to be 5.0, and then, the stainless frasco is sealed, and heated to 95° C. while using the magnetic seal to keep agitation, and remained for 4 hours. After cooling, the toner mother particle is ished with an ion exchange water 4 times, and is freeze dried to obtain the toner mother particle K2, D50 is 5.8 μm, and the average shape coefficient ML²/A is 109.

(Toner Mother Particle C2)

Except that coloring particle dispersion (2) is used instead of the coloring particle dispersion (1), the toner mother particle C2 is obtained in the same manner as in the toner mother particle K2. For the toner mother particle C2, D50 is 5.7 μm, and the average shape coefficient ML²/A is 110.

(Toner Mother Particle M2)

Except that coloring particle dispersion (3) is used instead of the coloring particle dispersion (1), the toner mother particle M2 is obtained in the same manner as in the toner mother particle K2. For the toner mother particle M2, D50 is 5.6 μm, and the average shape coefficient ML²/A is 114.

(Toner Mother Particle Y2)

Except that coloring particle dispersion (4) is used instead of the coloring particle dispersion (1), the toner mother particle Y2 is obtained in the same manner as in the toner mother particle K2. For the toner mother particle Y2, D50 is 5.8 μm, and the average shape coefficient ML²/A is 108.

Except that K2, C2, M2, and Y2 are used as the toner mother particles and that the aluminum oxide (average particle diameter 0.1 μm) is used instead of one part of ceric oxide (average particle diameter 0.7 μm), the toner 2 can be obtained in the same manner as the toner 1, and using this, the developer (1-2) is able to be obtained in the same manner as the developer (2-1).

(Developer (2-3)

(Toner Mother Particle K3)

100 parts of the polyester resin (as a line type polyester obtained from terephthalic acid—bis phenol A ethylene oxide additive—cyclo hexane dimethanol, Tg: 62° C., Mn 12,000, Mv: 32,000), 4 parts of carbon black, and 5 parts of carnauba wax are mixed, and a compound is kneaded with an exteruder, and grinded with the jet mill. Next, the compounds are classified with a classifier in a wind force method, the average particle diameter is 5.9 μm, and the shape coefficient ML²/A is 145.

(Toner Mother Particle C3)

Except that cyan coloring agent (C. I. pigment blue 15: 3) is used instead of the carbon black, the toner mother particle C3 is obtained in the same manner as in the toner mother particle K3, with the average particle diameter is 5.6 μm, and the shape coefficient ML²/A is 141.

(Toner Mother Particle M3)

Except that magenta coloring agent (R122) is used instead of the carbon black, the toner mother particle M3 is obtained in the same manner as in the toner mother particle K3, with the average particle diameter is 5.9 μm, and the shape coefficient ML²/A is 149.

(Toner Mother Particle Y3)

Except that yellow coloring agent (Y180) is used instead of the carbon black, the toner mother particle Y3 is obtained in the same manner as in the toner mother particle K3, with the average particle diameter is 5.8 μm, and the shape coefficient ML²/A is 144.

Except that K3, C3, M3, and Y3 are used as the toner mother particles, the toner-3 can be obtained in the same manner as the toner 1, and using this, the developer (1-3) can be obtained in the same manner as the developer (2-1).

### Examples (2-25) to (2-36) and Comparative Examples (2-5) to (2-9)

Photoreceptors (PR-2-1) to (PR-2-12) and (RPR-2-1) to (RPR-2-2), and the developers (2-1) to (2-3) constitute image forming apparatus (DocuCentre Color 400CP, manufactured by Fuji Xerox Co., Ltd.), as shown in table 43. In table 43, an absorbance ratio (P₂/P₁) for the protective layer of the photoreceptor, an oxygen permeability coefficient at 25° C. (X10¹¹ fm/s·Pa, and a surface potential(VL) are shown.

In addition, the protective layer of each photoreceptor is lifted off, and an IR spectrum is measured with an infrared spectrophotometer FT-730 (manufactured by Horiba, Ltd.) to find the absorbance ratio from the spectrum. Further, when the oxygen permeability coefficient is measured, the coating solution for forming protective layer used for forming the protective layer of each photoreceptor is coated on an aluminum plate, and dried under the same condition as that for the photoreceptor, to provide a sample having a thickness of 7 μm. Therefore, the oxygen permeability coefficient for the sample lifted from the aluminum plate at 25° C. is measured with a gas transmission ratio measuring device (MC-3 manufactured by Toyo Seiki Co., Ltd.). In addition, the surface potential (VL) is measured such that each photoreceptor is charged at −700 V under the constant temperature and humidity (20° C., 50% RH), flashed exposed with 780 nm and 5 mJ/m², and the surface potential (VL) is monitored after 50 msec.

TABLE 43

| | | | | Oxygen | |
|---|---|---|---|---|---|
| | | De- | Absorbance | permeability | |
| | Photo- | vel- | ratio | coefficient | |
| Example | receptor | oper | (P₂/P₁) | (×10¹¹ fm/s · Pa) | VL |
| Example | PR-2-1 | 2-1 | 0.05 | 31 | −120 |
| 2-25 | | | | | |
| Example | PR-2-2 | 2-1 | 0.1 | 26 | −125 |
| 2-26 | | | | | |
| Example | PR-2-3 | 2-1 | 0.06 | 23 | −110 |
| 2-27 | | | | | |
| Example | PR-2-4 | 2-1 | 0.05 | 11 | −115 |
| 2-28 | | | | | |
| Example | PR-2-5 | 2-1 | 0.05 | 12 | −120 |
| 2-29 | | | | | |
| Example | PR-2-6 | 2-1 | 0.04 | 18 | −125 |
| 2-30 | | | | | |
| Example | PR-2-7 | 2-2 | 0.06 | 20 | −125 |
| 2-31 | | | | | |
| Example | PR-2-8 | 2-3 | 0.05 | 10 | −125 |
| 2-32 | | | | | |
| Example | PR-2-9 | 2-1 | 0.06 | 13 | −145 |
| 2-33 | | | | | |
| Example | PR-2-10 | 2-2 | 0.04 | 12 | −120 |
| 2-34 | | | | | |
| Example | PR-2-11 | 2-3 | 0.05 | 14 | −135 |
| 2-35 | | | | | |
| Example | PR-2-12 | 2-1 | 0.07 | 39 | −105 |
| 2-36 | | | | | |

(Image Forming Test)

By using the image forming apparatus of the Examples (2-25) to (2-36) and the Comparative Examples (2-5) to (2-9), the image forming test is conducted. In other words, first, under the circumstance of a low temperature and a low humidity (10° C., 20% RH), 10,000 pieces of the image forming test are conducted, and then, under the circumstance of a high temperature and a high humidity (28° C., 75% RH), 10,000 pieces of the image forming test are conducted. Next, the attachments on the photoreceptor, cleaning property, abrasive ratio, and image quality are estimated. The acquired results are shown in table 44.

TABLE 44

| | Deposits of | Cleaning | Abrasion rate | Image |
|---|---|---|---|---|
| Example | photoreceptor | property | (nm/Kcycle) | quality |
| Example 2-25 | A | A | 2.3 | A |
| Example 2-26 | A | A | 1.5 | A |
| Example 2-27 | A | A | 2 | A |
| Example 2-28 | A | A | 2.1 | A |
| Example 2-29 | A | A | 2.2 | A |
| Example 2-30 | A | A | 2.4 | A |
| Example 2-31 | A | A | 1.9 | A |
| Example 2-32 | A | A | 2.1 | A |
| Example 2-33 | A | A | 2.1 | A |
| Example 2-34 | A | A | 1.9 | A |
| Example 2-35 | A | A | 2.1 | A |
| Example 2-36 | A | A | 2.9 | A |

In addition, in terms of the attachment, estimation is determined with a naked eye, as follows: A: no attachment, B: partial attachment (30% or less in total), and C: attached. In addition, in terms of the cleaning property, estimation is determined with a naked eye, as follows: A: good, B: partially image defected (10% or less in total), and C: generally image defected. In addition, in terms of the abrasive ratio, the abrasion amount of the photoreceptor is measured to calculate the abrasive ratio with 1000 rotations. In addition, in terms of the image quality, image quality of the print with a naked eye after printing 20,000 papers in total, the estimation is made as follows: A: good, C1: slightly low image concentration, and C2: defect.

### Examples (2-37) to (2-50) and Comparative Examples (2-10) to (2-13)

Photoreceptors (PR-2-13) to (PR-2-24) and (RPR-2-3) to (RPR-2-4), and the developers (2-1) to (2-3) constitute image forming apparatus (DocuCentre Color 500, manufactured by Fuji Xerox Co., Ltd.), as shown in Table. 45. As the image forming apparatus described above, a multi beam surface emissive laser having an oscillation wavelength of 780 nm is modified for use in the exposure unit. In table 45, the absorbance ratio (P₂/P₁) for the protective layer of the photoreceptor, an oxygen permeability coefficient at 25° C. (X10¹¹ fm/s·Pa, and a surface potential(VL) are shown. According to the image forming apparatus of the Examples (2-48) to (2-49), at a back unit of the print cleaning unit, a member of attaching a toresy in a sponge type having a width of 3 mm is pressed with a pressure of 1 g/mm.

TABLE 45

| | | | | Oxygen | |
|---|---|---|---|---|---|
| | | De- | Absorbance | permeability | |
| | Photo- | vel- | ratio | coefficient | |
| Example | receptor | oper | (P₂/P₁) | (×10¹¹ fm/s · Pa) | VL |
| Example | PR-2-13 | 2-1 | 0.05 | 31 | −90 |
| 2-37 | | | | | |
| Example | PR-2-14 | 2-1 | 0.1 | 26 | −85 |
| 2-38 | | | | | |
| Example | PR-2-15 | 2-1 | 0.06 | 23 | −80 |
| 2-39 | | | | | |
| Example | PR-2-16 | 2-1 | 0.05 | 11 | −85 |
| 2-40 | | | | | |
| Example | PR-2-17 | 2-1 | 0.05 | 12 | −80 |
| 2-41 | | | | | |
| Example | PR-2-18 | 2-1 | 0.04 | 18 | −75 |
| 2-42 | | | | | |
| Example | PR-2-19 | 2-2 | 0.06 | 20 | −75 |
| 2-43 | | | | | |
| Example | PR-2-20 | 2-3 | 0.05 | 10 | −85 |
| 2-44 | | | | | |
| Example | PR-2-21 | 2-1 | 0.06 | 13 | −85 |
| 2-45 | | | | | |
| Example | PR-2-22 | 2-3 | 0.04 | 12 | −90 |
| 2-46 | | | | | |
| Example | PR-2-23 | 2-2 | 0.05 | 14 | −100 |
| 2-47 | | | | | |
| Example | PR-2-13 | 2-3 | 0.05 | 31 | −90 |
| 2-48 | | | | | |
| Example | PR-2-13 | 2-1 | 0.05 | 31 | −90 |
| 2-49 | | | | | |
| Example | PR-2-14 | 2-1 | 0.07 | 39 | −80 |
| 2-50 | | | | | |

(Image Forming Test)

By using the image forming apparatus of the Examples (2-37) to (2-50) and the Comparative Examples (2-10) to (2-13), the image forming test is conducted. In other words, first, under the circumstance of a low temperature and a low humidity (10° C., 20% RH), 10,000 pieces of the image forming test are conducted, and then, under the circumstance of a high temperature and a high humidity (28° C., 75% RH), 10,000 pieces of the image forming test are conducted. Next, the attachments on the photoreceptor, cleaning property, abrasive ratio, and image quality are estimated. The acquired results are shown in table 46.

TABLE 46

| | Deposits of | Cleaning | Abrasion rate | Image |
|---|---|---|---|---|
| | photoreceptor | property | (nm/Kcycle) | quality |
| Example 2-37 | B | A | 0.9 | A |
| Example 2-38 | A | A | 0.6 | A |
| Example 2-39 | A | A | 0.9 | A |
| Example 2-40 | A | A | 0.8 | A |
| Example 2-41 | B | A | 0.9 | A |
| Example 2-42 | A | A | 0.8 | A |
| Example 2-43 | A | A | 1 | A |
| Example 2-44 | A | A | 0.9 | A |
| Example 2-45 | A | A | 0.8 | A |
| Example 2-46 | B | A | 0.8 | A |
| Example 2-47 | A | A | 0.9 | A |
| Example 2-48 | A | A | 0.9 | A |
| Example 2-49 | A | A | 1 | A |
| Example 2-50 | B | A | 1.2 | A |

As is understood from the tables 44 and 46, the electrophotographic photoreceptor of the present invention has a long term use and a no remaining attachment, so that the high image quality and the long lifetime can be realized. In addition, the image forming apparatus and the process cartridge of the present invention can implement high image quality and the long lifetime products without incurring image defects even when it is used for a long time.

What is claimed is:

1. An electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative having a methylol group and a charge transport material having at least one selected from the group consisting of a hydroxyl group, a carboxyl group, an alkoxysilyl group, an epoxy group, a thiol group and an amino group, and
wherein an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm^{-1.}

2. The electrophotographic photoreceptor according to claim 1, wherein the charge transport material is at least one compound selected from the group consisting of following formulae (I), (II), and (III):
F—[(X¹)ₘ₁—(R¹)ₘ₂—Y]ₘ₃ (I)
F—[(X²)ₙ₁—(R²)ₙ₂—(Z)ₙ₃G]ₙ₄ (II)
F—[D —Si (R³)₍₃₋ₐ₎Qₐ]_{b} (III)
wherein F represents an organic group derived from a compound having a hole transportability; X¹ and X² each independently represents an oxygen atom or a sulfur atom; R¹ and R² each independently represents an alkylene group; Y represents an hydroxyl group, a carboxyl group, a thiol group or an amino group; Z represents an oxygen atom, a sulfur atom, NH or COO; G represents an epoxy group; D represents a flexible divalent group; R³ represents a hydrogen atom, a substituted or unsubstituted alkyl group, or a substituted or unsubstituted aryl group; Q represents a hydrolyzable group; m1 and m2 each independently represents 0 or 1; and m3 represents an integer of 1 to 4; n1, n2 and n3 each independently represents 0 or 1; n4 represents an integer of 1 to 4; a represents an integer of 1 to 3; and b represents an integer of 1 to 4.

3. The electrophotographic photoreceptor according to claim 1, wherein F is represented by formula (VI): 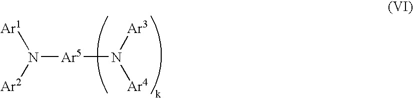
wherein Ar¹, Ar², Ar³ and Ar⁴ each independently represents a substituted or unsubstituted aryl group; Ar⁵ represents a substituted or unsubstituted aryl, or a substituted or unsubstituted arylene group, and one to four groups selected from the group consisting of Ar¹ to Ar⁵ are bonded to a moiety represented by —[(X¹)ₘ₁—(R¹)ₘ₂—Y], —[(X²⁾ₙ₁—(R²)ₙ₂—(Z)ₙ₃G] or -[D-Si(R³)₍₃₋ₐ₎Qₐ] in the compounds of the formulae (I) to (IV), respectively.

4. An electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative having a methylol group and a charge transport material having a plurality of epoxy groups.

5. The electrophotographic photoreceptor according to claim 4, wherein an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm^{-1.}

6. The electrophotographic photoreceptor according to claim 4, wherein the charge transport material is represented by following formula (IV):
F—[(X²)ₙ₁—(R²)ₙ₂—(Z)ₙ₃ G]ₙ₄ (IV)
wherein F represents an organic group derived from a compound having a hole transportability; X² represents an oxygen atom or a sulfur atom; R² represents an alkylene group; Z represents an oxygen atom, a sulfur atom, NH or COO; G represents an epoxy group; n1, n2 and n3 each independently represents 0 or 1; n4 represents an integer of 2 to 4.

7. The electrophotographic photoreceptor according to claim 6, wherein F is represented by formula (VI): 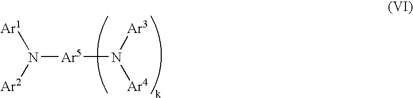
wherein Ar¹, Ar², Ar³ and Ar⁴ each independently represents a substituted or unsubstituted aryl group; Ar⁵ represents a substituted or unsubstituted aryl, or a substituted or unsubstituted arylene group, and one to four groups of Ar¹ to Ar⁵ have bonds to a moiety represented by —[(X²)ₙ₁—(R²)ₙ₂—(Z)ₙ₃G] in the compounds of the formula (IV).

8. An electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative which has a fragment pattern belonging to a compound represented by following formula (A): 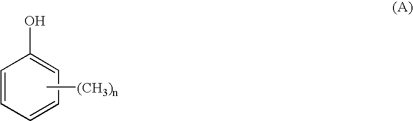
in pyrolysis-gas chromatography/mass spectrometry,
wherein n represents an integer of 1 to 3, and an infrared absorption spectrum of the phenol derivative-containing layer satisfies the conditions represented by following formula (1):
(P2/P1)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm⁻¹.

9. An image forming apparatus comprising:
an electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative having a methylol group and a charge transport material having at least one selected from the group consisting of a hydroxyl group, a carboxyl group, an alkoxysilyl group, an epoxy group, a thiol group and an amino group, and
an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm⁻¹;
a charging unit which charges the electrophotographic photoreceptor;
an exposure unit which exposes the charged electrophotographic photoreceptor to form an electrostatic latent image;
a developing unit which develops the electrostatic latent image to form a toner image; and
a transfer unit which transfers the toner image to a recording medium.

10. The image forming apparatus according to claim 9, wherein the charge transport material is at least one compound selected from the group consisting of following formulae (I), (II), and (III):
F—[(X¹)ₘ₁—(R¹)ₘ₂—Y]ₘ₃ (I)
F—[(X²)ₙ₁—(R²)ₙ₂—(Z)ₙ₃ G]ₙ₄ (II)
F—[D—Si(R³)₍₃₋ₐ₎Qₐ]_{b} (III)
wherein F represents an organic group derived from a compound having a hole transportability; X¹ and X² each independently represents an oxygen atom or a sulfur atom; R¹ and R² each independently represents an alkylene group; Y represents an hydroxyl group, a carboxyl group, a thiol group or an amino group; Z represents an oxygen atom, a sulfur atom, NH or COO; G represents an epoxy group; D represents a flexible divalent group; R³ represents a hydrogen atom, a substituted or unsubstituted alkyl group or a substituted or unsubstituted aryl group; Q represents a hydrolyzable group; m1 and m2 each independently represents 0 or 1; and m3 represents an integer of 1 to 4; n1, n2 and n3 each independently represents 0 or 1; n4 represents an integer of 1 to 4; a represents an integer of 1 to 3; and b represents an integer of 1 to 4.

11. The image forming apparatus according to claim 10, wherein F is represented by formula (VI): 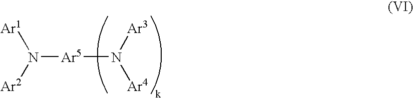
wherein Ar¹, Ar², Ar³ and Ar⁴ each independently represents a substituted or unsubstituted aryl group; Ar⁵ represents a substituted or unsubstituted aryl, or a substituted or unsubstituted arylene group, and one to four groups selected from the group consisting of Ar¹ to Ar⁵ are bonded to a moiety represented by —[(X¹)ₘ₁—(R¹)ₘ₂—Y], —[(X²)ₙ₁—(R²)ₙ₂—(Z)ₙ₃G] or —[D —Si(R³)₍₃₋ₐ₎Qₐ] in the compounds of the formulae (I) to (IV), respectively.

12. An image forming apparatus comprising:
an electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative which has a fragment pattern belonging to a compound represented by following formula (A): 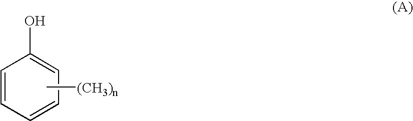
in pyrolysis-gas chromatography/mass spectrometry,
wherein n represents an integer of 1 to 3, and an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm^{-1;}
a charging unit which charges the electrophographic photoreceptor;
an exposure unit which exposes the charged electrophographic photoreceptor to form an electrostatic latent image;
a developing unit which develops the electrostatic latent image to form a toner image; and
a transfer unit which transfers the toner image to a recording medium.

13. A process cartrige comprising:
an electrophotographic photoreceptor comprising:
a conductive support; and
a photosensitive layer disposed on the conductive support,
wherein the photosensitive layer on the farthest side from the conductive support, includes a phenol derivative-containing layer containing a phenol derivative having a methylol group and a charge transport material having at least one selected from the group consisting of a hydroxyl group, a carboxyl group, an alkoxysilyl group, an epoxy group, a thiol group and an amino group, and
an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm⁻¹;
at lest one unit selected from the group consisting of a charging unit which ch arges the electrophotographic photoreceptor, an exposure unit which exposes the charged electrophotographic photoreceptor to form an electrostatic latent image, and a cleaning unit which cleans the electrophotographic photo receptor.

14. The process cartridge according to claim 13, wherein the charge transport material is at least one compound selected from the group consisting of following formulae (I), (II), and (III):
F—[(X¹)ₘ₁—(R¹)ₘ₂—Y]ₘ₃ (I)
F—[(X²)ₙ₁—(R²)ₙ₂—(Z)ₙ₃G]ₙ₄ (II)
F—[D —Si(R³)₍₃₋ₐ₎Qₐ]_{b} (II)
wherein F represents an organic group derived from a compound having a hole transportability; X¹ and X² each independently represents an oxygen atom or a sulfur atom; R¹ and R² each independently represents an alkylene group; Y represents an hydroxyl group, a carboxyl group, a thiol group or an amino group; Z represents an oxygen atom, a sulfur atom, NH or COO; G represents an epoxy group; D represents a flexible divalent group; R³ represents a hydrogen atom, a substituted or unsubstituted alkyl group or a substituted or unsubstituted aryl group; Q represents a hydrolyzable group; m1 and m2 each independently represents 0 or 1; and m3 represents an integer of 1 to 4; n1, n2 and n3 each independently represents 0 or 1; n4 represents an integer of 1 to 4; a represents an integer of 1 to 3; and b represents an integer of 1 to 4.

15. The process cartridge according to claim 14, wherein F is represented by formula (VI): 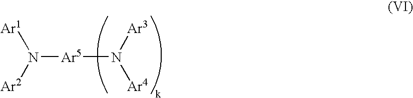
wherein Ar¹, Ar², Ar³ and Ar⁴ each independently represents a substituted or unsubstituted aryl group; Ar⁵ represents a substituted or unsubstituted aryl, or a substituted or unsubstituted arylene group, and one to four groups selected from the group consisting of Ar¹ to Ar⁵ are bonded to a moietyrepresented by —[(X¹)ₘ₁—(R¹)ₘ₂—Y], —[(X²)ₙ₁—(R²)ₙ₂—(Z)ₙ₃G] or —[D —Si (R³)₍₃₋ₐ₎Qₐ] in the compounds of the formulae (I) to (IV).

16. A process cartrige comprising:
an electrophotographic photoreceptor comprising:
a conductive support; and
a photosensitive layer formed on the conductive support,
wherein the photosensitive layer on the farthest side from the conductive support, includes a phenol derivative-containing layer containing a phenol derivative which has a fragment pattern belonging to a compound represented by following formula (A): 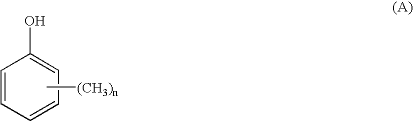
in pyrolysis-gas chromatography/mass spectrometry,
wherein n represents an integer of 1 to 3, and an infrared absorption spectrum of the phenol derivative-containing layer satisfies the conditions represented by following formula (1):
(P₂/P₁)≦0.2 (1)
where
P₁ is an absorbance of a maximum absorption peak of the phenol derivative-containing layer in a range of 1560 cm⁻¹ to 1640 cm⁻¹ and;
P₂ is an absorbance of a maximum absorption peak of the phenol derivative-containing layer in a range of 1645 cm⁻¹ to 1700 cm¹;
at lest one unit selected from the group consisting of a charging unit which charges the electrophotographic photoreceptor, an exposure unit which exposes the charged electrophotographic photoreceptor to form an electrostatic latent image, and a cleaning unit which cleans the electrophotographic photo receptor.
